(19) United States
(12) Patent Application Publication
(10) Pub. No.: US 2025/0286973 A1
(43) Pub. Date: Sep. 11, 2025

(54) SYSTEM AND IMAGE FORMING DEVICE

(71) Applicant: BROTHER KOGYO KABUSHIKI KAISHA, Nagoya (JP)

(72) Inventors: Yoshihiro ITOGAWA, Mizuho (JP); Yutaka URAKAWA, Nagoya (JP); Yuki YADA, Kuwana (JP); Asahi MIZUKOSHI, Nagoya (JP); Isamu FUJII, Tsu (JP); Thanh NGUYENVAN, Nagoya (JP)

(73) Assignee: BROTHER KOGYO KABUSHIKI KAISHA, Nagoya (JP)

(21) Appl. No.: 19/073,829

(22) Filed: Mar. 7, 2025

(30) Foreign Application Priority Data
Mar. 11, 2024 (JP) 2024-037135
Mar. 11, 2024 (JP) 2024-037137
Mar. 11, 2024 (JP) 2024-037138
Mar. 11, 2024 (JP) 2024-037140
Mar. 11, 2024 (JP) 2024-037141

(51) Int. Cl. H04N 1/00

(52) U.S. Cl. CPC H04N 1/00973; H04N 1/00209; H04N 1/00384; H04N 1/00464; H04N 2201/0094

(57) ABSTRACT

A system includes an image forming device and an information processing device. The image forming device and the information processing device are configured to be connected to the Internet. The information processing device is configured to install a browser. The browser is configured to cause the information processing device to acquire a remote operation program configured to operate in the browser. The image forming device is configured to execute an image upload process of uploading image data indicating a remote operation screen including a plurality of operators to a cloud storage connected to the Internet. The remote operation program includes an instruction that causes the information processing device to execute a screen display process of downloading the image data from the cloud storage and of displaying the remote operation screen including the plurality of operators indicated by the image data on a user interface of the information processing device.

### REFERENCE TO RELATED APPLICATIONS

This application claims priority from Japanese Patent Application No. 2024-037137 filed on Mar. 11, 2024, Japanese Patent Application No. 2024-037135 filed on Mar. 11, 2024, Japanese Patent Application No. 2024-037138 filed on Mar. 11, 2024, Japanese Patent Application No. 2024-037140 filed on Mar. 11, 2024, and Japanese Patent Application No. 2024-037141 filed on Mar. 11, 2024. The entire content of the priority application is incorporated herein by reference.

### BACKGROUND ART

There is a technique for an image forming device capable of performing image formation such as printing and scanning, in which various input operations are received via an operation panel. For example, JP2021-73543A discloses a function execution device including a printing unit, an image reading unit, and an operation panel, in which the operation panel includes a hardware key and a touch panel, and an input operation to a hardware key or an input operation to an icon or button displayed on a touch panel is received.

In recent years, there has been an increasing demand for so-called remote operation of an image forming device, which enables an information processing device to perform an input operation on an operation panel of the image forming device without touching the operation panel. JP2021-73543A does not disclose a technique for controlling an image forming device by a remote operation, and there is room for improvement.

### SUMMARY

A system includes an image forming device and an information processing device. The image forming device and the information processing device are configured to be connected to the Internet. The information processing device is configured to install a browser. The browser is configured to cause the information processing device to acquire a remote operation program configured to operate in the browser. The image forming device is configured to execute an image upload process of uploading image data indicating a remote operation screen including a plurality of operators to a cloud storage connected to the Internet. The remote operation program includes instructions that cause the information processing device to execute a screen display process of downloading the image data from the cloud storage and of displaying, using the browser, the remote operation screen including the plurality of operators indicated by the image data on a user interface of the information processing device. Upon receiving an operation on one of the plurality of operators included in the remote operation screen via the user interface, the instructions included in the remote operation program further cause the information processing device to execute an operation upload process of uploading operation data for specifying the operated operator to the cloud storage. In a case where the operation data is uploaded to the cloud storage, the image forming device downloads the operation data from the cloud storage, executes a process based on the operator specified by the operation data, and executes an image forming process as a process corresponding to the operator in a case where the operator specified by the operation data is an operator related to image formation. In a case where an event that changes the content of the remote operation screen displayed on the information processing device according to the remote operation program occurs, the image forming device executes the image upload process to upload the image data indicating the content of the remote operation screen after a change caused by the event to the cloud storage. In a case where the image data indicating the content of the remote operation screen after the change is uploaded to the cloud storage, the instructions included in the remote operation program cause the information processing device to execute the screen display process, and in the screen display process, the information processing device downloads the image data indicating the content of the remote operation screen after the change from the cloud storage and displays the content of the remote operation screen after the change on the user interface using the browser.

An image forming device is configured to be connected to the Internet and configured to execute an image upload processing of uploading image data indicating a remote operation screen including a plurality of operators to a cloud storage connected to the Internet, the image data is downloaded to an information processing device connected to the Internet by a remote operation program configured to operate in a browser, the remote operation screen including the plurality of operators indicated in the image data is displayed on a user interface of the information processing device using the browser. In a case where operation data is uploaded to the cloud storage, the image forming device downloads the operation data from the cloud storage and executes a process based on the operator specified by the operation data. In a case where the operator specified by the operation data is an operator related to image formation, the image forming device executes an image forming process as a process corresponding to the operator, and the operation data is data for specifying an operated operator among the plurality of operators included in the remote operation screen, and upon receiving an operation on one of the plurality of operators included in the remote operation screen, the information processing device uploads the operation data to the cloud storage according to the remote operation program. In a case where an event that changes the content of the remote operation screen displayed on the information processing device occurs, the image forming device executes the image upload process to upload the image data indicating the changed remote operation screen to the cloud storage. In a case where the image data indicating the changed remote operation screen is uploaded to the cloud storage, the image data indicating the changed remote operation screen is downloaded from the cloud storage to the information processing device according to the remote operation program, and the changed remote operation screen is displayed on the user interface using the browser.

A system comprising an image forming device, a first information processing device, and a second information processing device. The first information processing device, the second information processing device, and the image forming device are connected to the Internet. The first information processing device and the second information processing device are configured to install a browser. Upon receiving a start instruction of a first remote operation from the first information processing device via a cloud storage connected to the Internet, the image forming device executes a program upload process of uploading a first remote operation program configured to operate in the browser to the cloud storage, and in a case where the first remote operation program is uploaded to the cloud storage, the browser installed on the first information processing device causes the first information processing device to download the first remote operation program from the cloud storage. The image forming device is further configured to execute an image upload process of uploading first image data indicating a first remote operation screen to the cloud storage, after receiving the start instruction of the first remote operation. The instructions included in the first remote operation program cause the first information processing device to execute a screen display process of downloading the first image data from the cloud storage and of displaying the first remote operation screen indicated in the first image data on the user interface of the first information processing device using the browser. In a case where an operation on the first remote operation screen is received via the user interface of the first information processing device, the instructions included in the first remote operation program cause the first information processing device to execute an operation upload process of uploading first operation data indicating an operation content to the cloud storage. In a case where the first operation data is uploaded to the cloud storage, the image forming device downloads the first operation data from the cloud storage and executes a process corresponding to an operation indicated by the first operation data, and in a case where the operation indicated by the downloaded first operation data is an operation related to image formation, the image forming device executes an image forming process as a process corresponding to the operation. Upon receiving a start instruction of a second remote operation from the second information processing device through local communication, not via the cloud storage, the image forming device executes a program reply process of returning a second remote operation program configured to operate in the browser to the second information processing device, not via the cloud storage, and the browser installed on the second information processing device acquires the second remote operation program returned from the image forming device. The image forming device is further configured to execute an image transmission process of transmitting second image data indicating a second remote operation screen to the second information processing device, not via the cloud storage, after receiving the start instruction of the second remote operation. In a case where the second information processing device receives the second image data, the instructions included in the second remote operation program cause the second information processing device to execute a local screen display process of displaying the second remote operation screen indicated by the received second image data on the user interface of the second information processing device using the browser. In a case where an operation on the second remote operation screen is received via the user interface of the second information processing device, the instructions included in the second remote operation program further cause the second information processing device to execute an operation transmission process of transmitting second operation data indicating an operation content to the image forming device, not via the cloud storage. Upon receiving the second operation data from the second information processing device, the image forming device executes a process corresponding to an operation indicated by the received second operation data, and in a case where the operation indicated by the received second operation data is an operation related to image formation, the image forming device executes an image forming process as a process corresponding to the operation. In a case where the image forming device starts providing the first remote operation by executing the program upload process after receiving the start instruction of the first remote operation, the image forming device enters a first remote operation providing state until an ending condition of the first remote operation is satisfied. In a case where the image forming device starts providing the second remote operation by executing the program reply process after receiving the start instruction of the second remote operation, the image forming device enters a second remote operation providing state until an ending condition of the second remote operation is satisfied. The image forming device is configured to start providing the second remote operation in a case where the image forming device receives the start instruction of the second remote operation from the second information processing device in the first remote operation providing state. The image forming device is configured to start providing the first remote operation in a case where the image forming device receives the start instruction of the first remote operation from the first information processing device in the second remote operation providing state.

The image forming device is configured to be connected to the Internet. Upon receiving a start instruction of a first remote operation from a first information processing device via a cloud storage connected to the Internet, the image forming device executes a program upload process of uploading a first remote operation program configured to operate in a browser to the cloud storage, and in a case where the first remote operation program is uploaded to the cloud storage, the browser installed on the first information processing device causes the first information processing device to download the first remote operation program from the cloud storage. The image forming device is further configured to execute an image upload process of uploading first image data indicating a first remote operation screen to the cloud storage after receiving the start instruction of the first remote operation, the first image data is downloaded to the first information processing device according to the first remote operation program, and the first remote operation screen indicated by the first image data is displayed on a user interface of the first information processing device using the browser. In a case where the first operation data is uploaded to the cloud storage, the image forming device further downloads the first operation data from the cloud storage and executes a process corresponding to an operation indicated by the first operation data. In a case where the operation indicated by the first operation data is an operation related to image formation, the image forming device executes an image forming process as a process corresponding to the operation, the first operation data is data indicating an operation content on the first remote operation screen, and in a case where the first information processing device receives an operation on the first remote operation screen, the first operation data is uploaded to the cloud storage according to the first remote operation program. Upon receiving a start instruction of a second remote operation from a second information processing device through local communication not via the cloud storage, the image forming device executes a program reply process of returning a second remote operation program configured to operate in the browser to the second information processing device not via the cloud storage, the browser being installed on the second information processing device acquires the second remote operation program returned from the image forming device. The image forming device is further configured to execute an image transmission process of transmitting second image data indicating a second remote operation screen to the second information processing device not via the cloud storage after receiving the start instruction of the second remote operation, the second image data is downloaded to the second information processing device according to the second remote operation program, and the second remote operation screen indicated in the second image data is displayed on the user interface of the second information processing device using the browser. Upon receiving second operation data from the second information processing device, the image forming device further executes a process corresponding to an operation indicated by the received second operation data, and in a case where the operation indicated by the received second operation data is an operation related to image formation, the image forming device executes an image forming process as a process corresponding to the operation, the second operation data is data indicating an operation content to the second remote operation screen, and in a case where the second information processing device receives an operation on the second remote operation screen, the operation is transmitted to the image forming device according to the second remote operation program. In a case where the image forming device starts providing the first remote operation by executing the program upload process after receiving the start instruction of the first remote operation, the image forming device enters a first remote operation providing state until an ending condition of the first remote operation is satisfied. In a case where the image forming device starts providing the second remote operation by executing the program reply process after receiving the start instruction of the second remote operation, the image forming device enters a second remote operation providing state until an ending condition of the second remote operation is satisfied. The image forming device is configured to start providing the second remote operation in a case where the image forming device receives the start instruction of the second remote operation from the second information processing device in the first remote operation providing state. The image forming device is configured to start providing the first remote operation in a case where the image forming device receives the start instruction of the first remote operation from the first information processing device in the second remote operation providing state.

### BRIEF DESCRIPTION OF DRAWINGS

FIG. 1 is a diagram illustrating an outline of a remote operation system according to the present embodiment.

FIG. 2 is a diagram illustrating an outline of the remote operation system according to the present embodiment.

FIG. 3 is a diagram illustrating a PC locally connectable to an MFP.

FIGS. 4A and 4B are sequence diagrams illustrating an example of a start instruction procedure.

FIGS. 5A to 5D are diagrams illustrating an example of a data structure.

FIGS. 6A and 6B are flowcharts illustrating an example of a procedure of a start determination process.

FIG. 7 is a diagram illustrating an example of a use permission confirmation screen.

FIGS. 8A and 8B are sequence diagrams illustrating an example of a screen preparation procedure.

FIG. 9 is a diagram illustrating an example of an execution file.

FIG. 10 is a flowchart illustrating an example of a procedure of an image storage process.

FIGS. 11A and 11B are diagrams illustrating an example of information stored in a structured storage.

FIG. 12 is a diagram illustrating an example of a state where a screen is synchronized.

FIGS. 13A and 13B are sequence diagrams illustrating an example of a remote operation procedure.

FIG. 14 is a flowchart illustrating an example of a procedure of a browser image changing process.

FIG. 15 is a flowchart illustrating an example of a procedure of a device image changing process.

FIG. 16 is a flowchart illustrating an example of a procedure of an operation information process.

FIG. 17 is a sequence diagram illustrating an example of an operation ending procedure.

FIG. 18 is a sequence diagram illustrating an example of a local operation procedure.

FIG. 19 is a diagram illustrating an example of an HTML file.

FIG. 20 is a flowchart illustrating a modification of a procedure of a start determination process.

### DESCRIPTION

Hereinafter, an embodiment embodying a remote operation system will be described in detail with reference to the accompanying drawings. The present specification discloses a remote operation system for performing remote operation on a multi function peripheral (hereinafter referred to as “MFP”) having a printing function via the Internet.

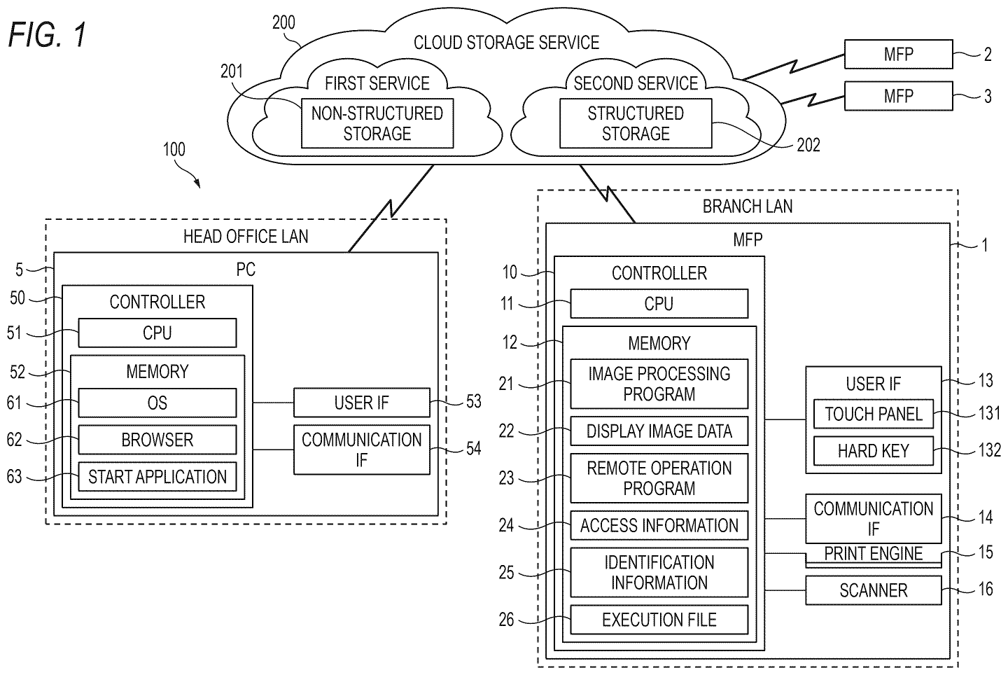

As illustrated in FIG. 1, a remote operation system 100 according to the present embodiment is a system that includes, for example, one or more MFPs 1, 2, and 3 to be operated, and a personal computer (hereinafter referred to as a “PC”) 5 used by a user who performs a remote operation, and enables each MFP to be operated by the remote PC 5 via a cloud storage service 200. The MFPs 1, 2, 3 are examples of an image forming device. The remote operation system 100 is an example of a system. The cloud storage service 200 is a service that has a communication function via an Internet line and is capable of storing various kinds of information.

The PC 5 is disposed, for example, in a head office, a system management company, or a management organization that manages an operational organization, and each of the MFPs 1 to 3 is disposed, for example, in a branch office, a client company, an operational organization that operates the MFP 1, and the like. The plurality of MFPs 1 to 3 may be the same model or may be different models. The user who performs a remote operation using the PC 5 specifies and operates the MFP to be operated. In the following, the procedure of the remote operation for the MFP 1 will be described. The same procedure is applied to other MFPs.

As illustrated in FIG. 1, the MFP 1 to be operated by the remote operation system 100 includes a controller 10 including a CPU 11 and a memory 12, for example. The MFP 1 includes a user interface (hereinafter, referred to as a “user IF”) 13, a communication interface (hereinafter, referred to as a “communication IF”) 14, a print engine 15, and a scanner 16 that are electrically connected to the controller 10.

The CPU 11 of the MFP 1 executes various types of processes, in accordance with a program read from the memory 12 and based on a user operation. The memory 12 of the MFP 1 is configured to store various programs and data including an image processing program 21, display image data 22, a remote operation program 23, access information 24, identification information 25, and an execution file 26. The memory 12 is used as a work area in a case where various types of processes are executed. A buffer provided in the CPU 11 is also an example of the memory 12.

The image processing program 21 is a program for causing the MFP 1 to execute various types of image processes. The display image data 22 is a data group indicating images used as components of various screens displayed on the user IF 13 of the MFP 1. The remote operation program 23 is a program for receiving a remote operation. The access information 24 is information for accessing the cloud storage service 200. The identification information 25 is unique information for identifying the MFP 1. The execution file 26 is a data file including a program for causing a PC or the like to execute a remote operation. The program and data will be described later in detail.

The access information 24 is not stored in the memory 12 at the time of factory shipment of the MFP 1. The remote operation program 23 and the execution file 26 may not be stored in the memory 12 at the time of factory shipment of the MFP 1.

An example of the memory 12 is not limited to a ROM, a RAM, an HDD, and the like incorporated into the MFP 1, and may be a storage medium configured to be read and written by the CPU 11. The computer-readable storage medium is a non-transitory medium. The non-transitory medium also includes a recording medium such as a CD-ROM or a DVD-ROM, in addition to the above-described examples. The non-transitory medium is also a tangible medium. On the other hand, an electric signal conveying a program downloaded from a server or the like on the internet is a computer-readable signal medium, which is a kind of computer-readable medium, but is not included in the non-transitory computer-readable storage medium.

The user IF 13 includes hardware configured to display a screen for notifying a user of information, and hardware configured to receive an operation from the user. The user IF 13 of the MFP 1 includes a touch panel 131 having a screen display function and an operation receiving function, and a plurality of hardware keys (hereinafter referred to as “hard keys”) 132. The user IF 13 is an example of an operation panel, and the touch panel 131 is also an example of a display.

The communication IF 14 includes hardware for communicating with an external device. The communication IF 14 has functions compatible with communication standards such as Wi-Fi (registered trademark), Ethernet (registered trademark), and USB. The communication IF 14 is configured to communicate with a server on the Internet using an HTTPS protocol.

The print engine 15 has a configuration configured to print an image based on image data on a print medium such as a sheet. A printing method of the print engine 15 is, for example, an electrophotographic method or an ink-jet method. The scanner 16 includes a configuration configured to read an image of a document and acquire image data.

The PC 5 includes a controller 50 including a CPU 51 and a memory 52 as illustrated in FIG. 1. The PC 5 includes a user IF 53 and a communication IF 54 that are electrically connected to the controller 50. The user IF 53 includes hardware configured to display a screen for notifying a user of information, and hardware configured to receive an operation from the user. The user IF 53 may or may not have a touch panel. The communication IF 54 has a function of being connectable to the Internet using an HTTPS protocol.

The memory 52 of the PC 5 is configured to store various programs and data including an operating system (hereinafter referred to as an “OS”) 61, a browser 62, and an application program (hereinafter referred to as a “start application”) 63 for supporting the start of a remote operation. The program and data will be described later in detail.

The cloud storage service 200 is, for example, a service that is operated by a company using the MFP 1 or a third party other than a vendor of the MFP 1, and includes a storage group accessible via the Internet. The cloud storage service 200 includes a first service having a not-structured storage area in which various data such as files including binary data can be placed, and a second service having an area in which structured text data can be stored. The cloud storage service 200 is, for example, an Azure (registered trademark) storage service provided by Microsoft (registered trademark).

The cloud storage service 200 also has a Web server function in addition to a storage function in which data is placed. For example, the first service and the second service of the cloud storage service 200 behave as a Web server when an HTTPS access is received, and can return a response that can be displayed by a browser.

For example, the cloud storage service 200 is not limited to Microsoft Azure, and may be Google (registered trademark) Cloud or Amazon (registered trademark) AWS (registered trademark). The cloud storage service 200 may be, for example, a service operated by a vendor of the image forming device. For example, the first service may be a BLOB storage service, and the second service may be a Table storage service.

For example, a system administrator of a company or the like that uses the remote operation system 100 according to the present embodiment prepares for using a remote operation via the cloud storage service 200. Specifically, the system administrator makes a contract with a company that operates the cloud storage service 200, and acquires an account name for using the cloud storage service 200.

Further, the system administrator provides a storage area corresponding to an account indicated by the acquired account name in the cloud storage service 200 for each of the first service and the second service, and acquires a token for each service. Hereinafter, in the cloud storage service 200, a storage area corresponding to an account used in the remote operation system 100 and provided for the first service is referred to as a non-structured storage 201, and a storage area provided for the second service is referred to as a structured storage 202. The non-structured storage 201 and the structured storage 202 are examples of cloud storage.

The system administrator sets anonymous access prohibition to at least the non-structured storage 201. The area set to be anonymous access prohibition is configured to receive only an access request based on a URL to which a correct token is added as a query, and configured not to receive an access in a case where the query is not added or the added query is not correct. In addition, even in a case where link information to another file is included in the file written in the area set to the anonymous access prohibition, the link access using the link information is prohibited. Each token is, for example, a shared access signature (SAS) token.

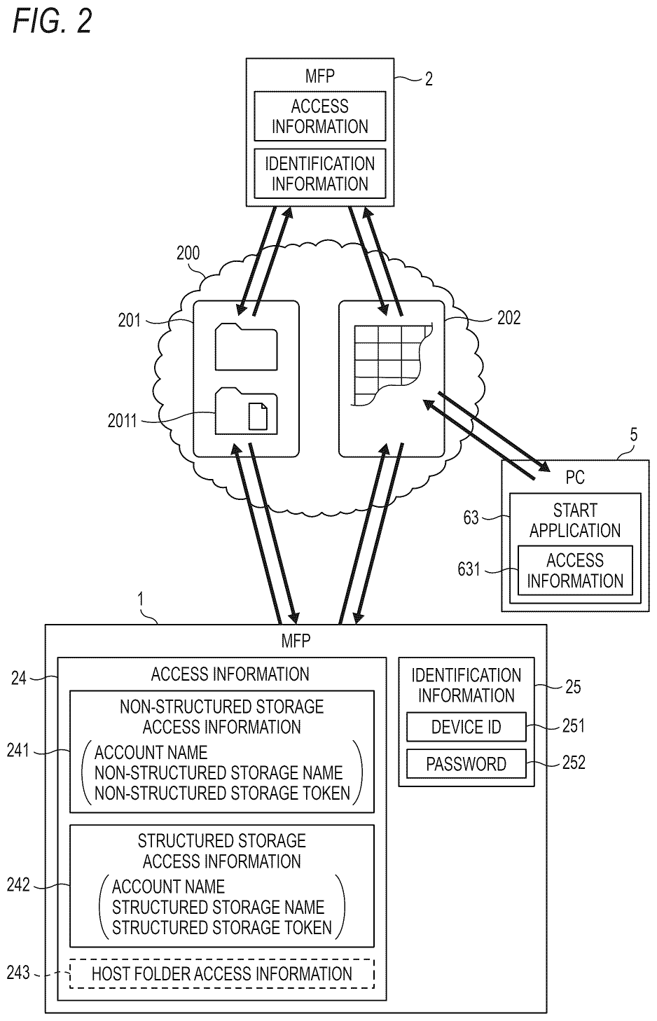

Further, as illustrated in FIG. 2, the system administrator causes each MFP to be operated by the remote operation system 100 to store the access information 24 including non-structured storage access information 241, which is access information for accessing the non-structured storage 201, and structured storage access information 242, which is access information for accessing the structured storage 202. The system administrator causes a non-volatile area of the memory of each MFP to store the access information 24.

For example, as illustrated in FIG. 2, the non-structured storage access information 241 includes an account name which is a text indicating an account acquired by the system administrator, a non-structured storage name which is a text indicating the non-structured storage 201, and a non-structured storage token which is an SAS token for accessing the non-structured storage 201. That is, the URL for accessing the non-structured storage 201 includes a text in which each piece of information illustrated in FIG. 2 is combined according to a predetermined rule. The non-structured storage access information 241 may be information described in the format of a URL, or may be information including each piece of information and its combination rule.

For example, the structured storage access information 242 includes an account name which is a text indicating an account acquired by the system administrator, a structured storage name which is a text indicating the structured storage 202, and a structured storage token which is an SAS token for accessing the structured storage 202. The URL for accessing the structured storage 202 includes a text in which each piece of information illustrated in FIG. 2 is combined according to a predetermined rule. The structured storage access information 242 may be information described in the format of a URL, or may be information including each piece of information and its combination rule.

Each MFP may acquire the token. For example, the system administrator may store the account name in each MFP, and the MFP may access the cloud storage service 200 using the account name to acquire each token. Each MFP includes the acquired token in the access information 24 and stores the token in the non-volatile area of the memory.

In each MFP, for example, as illustrated in FIG. 2, identification information 25 including a device ID 251 and a password 252 is stored. The configuration and stored information of each storage will be described later.

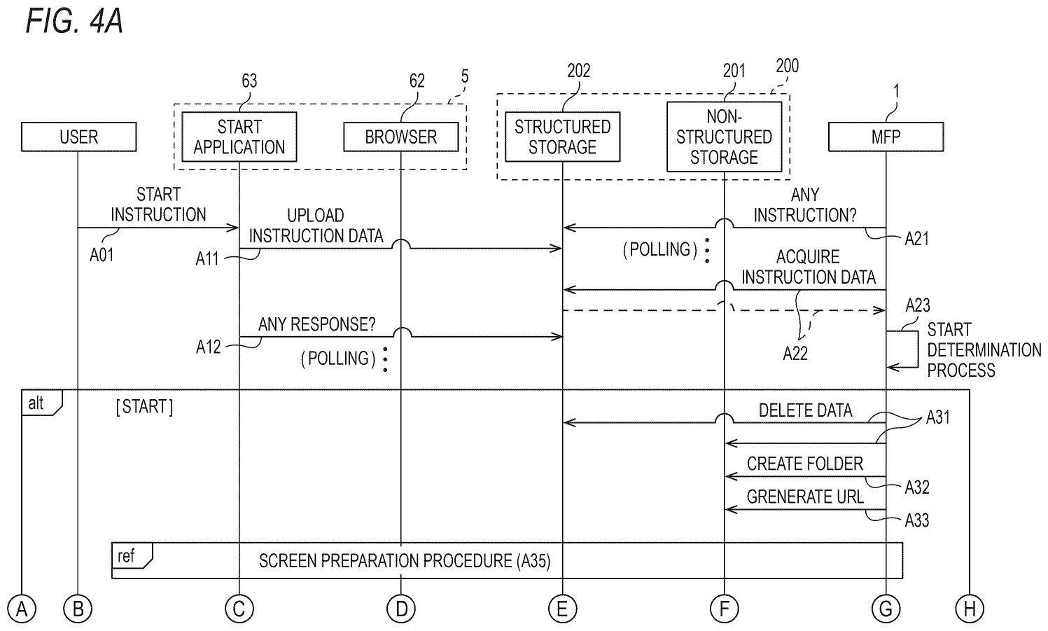

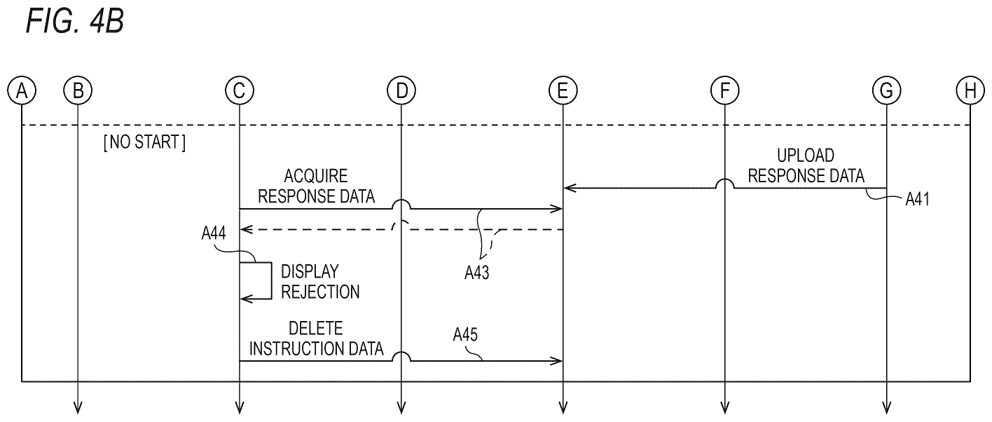

Although details will be described later, each MFP is configured to create, for example, a folder whose folder name includes its own device ID in the non-structured storage 201 when using the remote operation system 100. For example, the MFP 1 creates a folder 2011 in A32 of FIG. 4A to be described later. Further, the MFP 1 is configured to combine the non-structured storage access information 241 stored in the memory with its own device ID 251 to create access information for non-anonymous access to a folder 2011 created in the non-structured storage 201 (for example, A33 in FIG. 4A). This access information is referred to as host folder access information 243 for convenience. The system administrator may create a folder for each MFP in the non-structured storage 201 in advance and store access information for accessing the folder in each MFP.

The MFP 1 can create the non-structured storage access information 241 and the structured storage access information 242, based on the stored information. For example, the system administrator may store the account name in each MFP, and each MFP may combine the account name and the token to create the non-structured storage access information 241 and the structured storage access information 242. In this case, the token may be acquired by each MFP or may be stored in each MFP by the system administrator. For example, the MFP 1 is configured to create the non-structured storage access information 241 and the structured storage access information 242 using the stored account name.

By creating a data storage area for each MFP such as a folder whose folder name includes a device ID, even if HTTPS requests that specify different MFPs are simultaneously generated from different browsers, the non-structured storage 201 can return appropriate responses based on data stored in the folder for the MFPs corresponding to requests. That is, as will be described in detail later, different MFPs can be remotely operated from different PCs using the cloud storage service 200.

The system administrator also stores access information 631 for accessing the structured storage 202 in the start application 63 installed in the PC or the like. The access information 631 is information used for the start application 63 to access an area accessible by the MFP 1 using the structured storage access information 242 in the structured storage 202. The access information 631 may be the same as or partially different from the structured storage access information 242 used by the MFP 1. Specifically, the access information 631 is in the form of a URI.

For the access information 631, instead of storing the URL in the start application 63, an account name, a token, or the like may be stored, and the start application 63 may create the URL. The start application 63 may acquire the token using the account name stored in the PC and create the access information 631 using the acquired token.

The account name may be common to all companies, or may be different for each country, each region, each business department, or the like. However, the start application 63 of the PC that executes a remote operation is configured to execute a remote operation for only each MFP that uses the structured storage 202 accessible by the PC.

With the above configuration, the MFP 1 of the remote operation system 100 according to the present embodiment is configured to receive a remote operation from the PC 5 or the like connectable to the Internet via the cloud storage service 200, as described later. The MFP 1 also has a function configured to receive a remote operation not via the cloud storage service 200 by local communication from a locally connected PC, smartphone, or the like. Hereinafter, a remote operation via the cloud storage service 200 is referred to as a “cloud remote operation”. In addition, a remote operation according to the local communication not via the cloud storage service 200 is referred to as a “local remote operation”. The cloud remote operation is an example of a first remote operation, and the local remote operation is an example of a second remote operation.

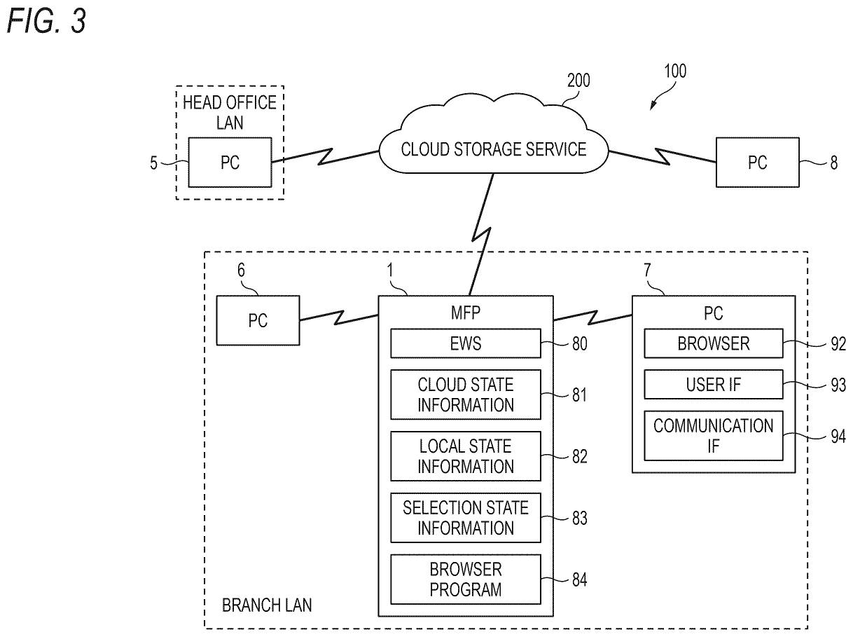

As a configuration for receiving the local remote operation, the MFP 1 further includes, for example, a program and data (hereinafter, referred to as “EWS”) 80 for realizing an embedded web server function, as illustrated in FIG. 3. The MFP 1 is configured to receive access to the EWS 80 through local communication. The local communication includes, for example, wired communication such as local wireless communication, local LAN communication, and USB communication.

The local wireless communication may be, for example, communication in a form in which the MFP 1 and a PC or the like perform wireless communication directly or may be communication in a form in which the MFP 1 and a PC or the like perform wireless connection without using the Internet. The form in which the MFP 1 and the PC or the like perform wireless connection without using the Internet may be, for example, a form in which the MFP 1 and the PC or the like are wirelessly connected to one access point and communicate via the access point, for example, a form in which the MFP 1 and the PC communicate using a protocol of a wireless LAN. In addition, the local LAN communication may be communication, for example, wired LAN communication in a form in which the MFP 1 is connected to a PC or the like via a LAN cable or a LAN cable and a hub, without using the Internet. The USB communication may be communication in a form in which the MFP 1 is connected to a PC or the like via a USB cable or via a USB cable and a hub.

For example, as illustrated in FIG. 3, the MFP 1 is further configured to store cloud state information 81, local state information 82, selection state information 83, a browser program 84, and a CSS 85 in the memory 12. Each of the cloud state information 81, the local state information 82, and the selection state information 83 is information indicating the state of the MFP 1, and is information indicating which of a plurality of states is. The information will be described later in detail. The browser program 84 is a program for remote operation of the MFP 1 using local communication. The CSS 85 is data used in remote operation using local communication. The browser program 84 is an example of a second remote operation program.

The remote operation system 100 according to the present embodiment further includes a plurality of other PCs 6, 7, and 8 in addition to the PC 5 described above. The PC 5 and the PC 8 may be connected to the Internet and have a configuration in which the cloud storage service 200 can be used. The PC 5 and the PC 8 are devices that may use a cloud remote operation by the MFP 1. The PC 5 and the PC 8 are examples of a first information processing device. The PC 5 and the PC 8 may or may not perform local communication with the MFP 1.

On the other hand, the PC 6 and the PC 7 may perform local communication with the MFP 1, and may access the MFP 1 using the EWS 80. For example, the PC 7 includes a user IF 93 and a communication IF 94, and a browser 92 is installed in the PC 7. The PC 6 and the PC 7 are devices that may use a local remote operation by the MFP 1. The PC 6 and the PC 7 are examples of a second information processing device. The PC 6 and the PC 7 may be connectable or unconnectable to the Internet.

Next, a procedure for using the remote operation of the MFP 1 will be described. The following processes basically represent processes of the CPU according to commands written in programs. That is, the processes such as “judgment”, “extraction”, “selection”, “calculation”, “determination”, “specification”, “acquisition”, “reception”, and “control” to be described below represent the processes of the CPU. The processes by the CPU also include hardware control using API of the OS. In the present specification, the description of the OS is omitted, and an operation of each program is described. That is, in the following description, the description that “a program B controls hardware C” may refer to “the program B controls the hardware C, using the API of the OS”. In addition, the processes of the CPU according to the commands written in the programs may be described in omitted words. For example, the processes of the CPU may be described as “the CPU performs”. In addition, the processes of the CPU according to the commands written in the programs may be described in words in which the CPU is omitted, such as “the program A performs”.

The term “acquisition” is used as a concept indicating that a request is not essential. That is, a process of receiving data without a request from the CPU is also included in a concept indicating that “the CPU acquires data”. In addition, the term “data” in the present specification is represented by a computer-readable bit string. Furthermore, data having substantially the same meaning and different formats are treated as the same data. The same applies to “information” in the present specification. In addition, the term “request” or “instruct” is a concept indicating that information indicating that a request is being made or information indicating that an instruction is being given is output to a partner. In addition, the information indicating that a request is being made or the information indicating that an instruction is being given is simply referred to as a “request” or “instruction”.

According to the CPU, a process of determining whether information A indicates that it is a matter B may be conceptually described as “determining whether it is the matter B, based on the information A”. According to the CPU, a process of determining whether the information A indicates that it is the matter B or a matter C may be conceptually described as “determining whether it is the matter B or the matter C, based on the information A”.

A start instruction procedure for starting a cloud remote operation of the MFP 1 by the remote operation system 100 using the PC 5 will be described with reference to sequence diagrams of FIGS. 4A and 4B. A user who wants to perform a cloud remote operation, for example, a system administrator activates the start application 63 in the PC 5, specifies the MFP 1 which is a device to be operated, and performs an operation of instructing the start of the cloud remote operation (A01). In the start application 63, each device ID of each MFP that may be subjected to the cloud remote operation is registered in advance. At A01, the start application 63 is configured to specify the device ID of the device to be operated, based on the user operation.

The start of the cloud remote operation requires a password included in identification information of the device to be operated. The user also executes an operation of inputting a password of the MFP 1 in A01. By executing the authentication using the password, it is possible to improve the safety of the cloud remote operation.

The start application 63 uploads instruction data, which is information indicating the input start instruction, to the structured storage 202 (A11). As described above, the start application 63 includes the access information 631 for accessing the structured storage 202, and can execute the upload by accessing the structured storage 202 using the access information 631. Thereafter, even if there is no particular description, the start application 63 accesses the structured storage 202 using the access information 631.

An example of second access information is information necessary for the PC 5 or the MFP 1 to access the same area of the structured storage 202, and the second access information may be a URL or information for creating a URL. The second access information used in the PC 5 may be the same as or partially different from the second access information used in the MFP 1. Similarly, an example of first access information to be described later is information necessary for the PC 5 or the MFP 1 to access the same area (folder 2011 created in the MFP 1) of the non-structured storage 201, and the first access information may be a URL or information for creating a URL.

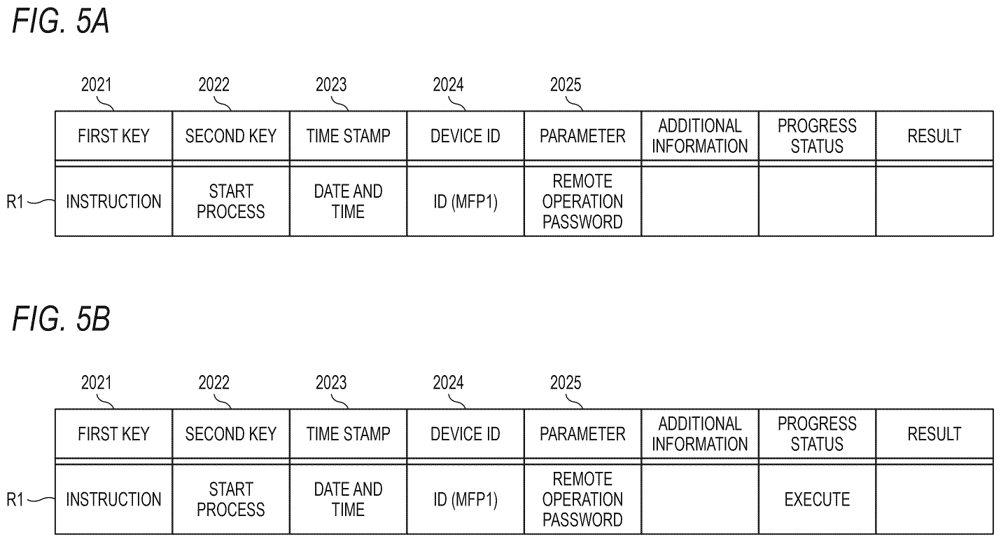

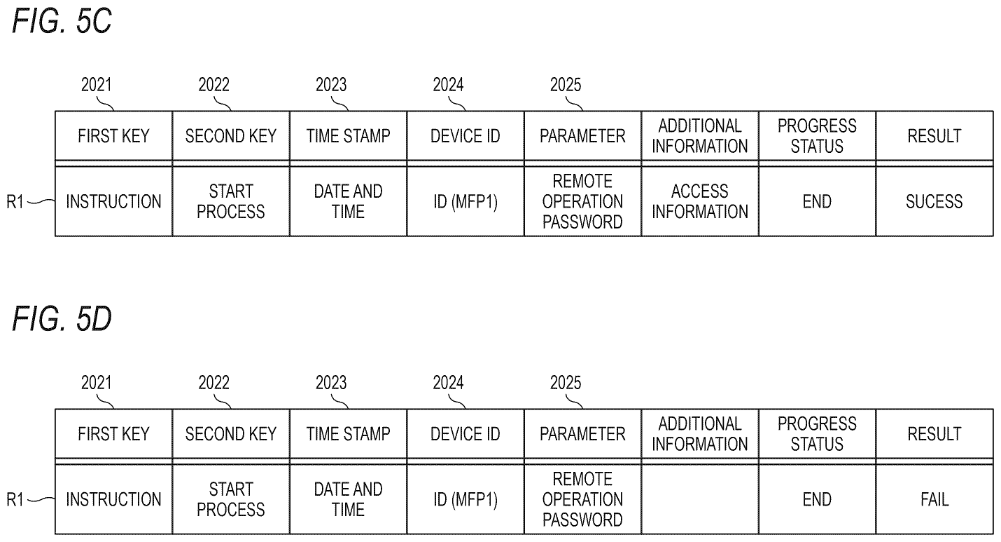

The structured storage 202 stores a structured database having a structure including a plurality of records. Each record includes, for example, as illustrated in FIG. 5A, a first key 2021, a second key 2022, a time stamp 2023, a device ID 2024, and a parameter 2025. The system administrator registers information indicating a structure of the structured database including a structure of each record in the structured storage 202, and the structured storage 202 is configured to store the structured database. The start application 63 may register information indicating the structure of the structured database in the structured storage 202.

The first key 2021 and the second key 2022 are information indicating the type of the content of the record. For example, in A11, as illustrated in FIG. 5A, the start application 63 uploads each piece of information to the structured storage 202 so that each piece of information is stored in a record R1. Uploading information may be referred to as uploading data. In addition, uploading information such that each record stores information may be described as uploading a record, for convenience. Uploading information may be referred to as uploading data.

Each device such as the PC 5 or the MFP 1 uploads each piece of information by specifying the first key 2021 and the second key 2022, and the structured storage 202 stores the uploaded information in the record in which the information specified in both the first key 2021 and the second key 2022 is stored. In a case where each device specifies the first key 2021 and the second key 2022 and requests the download of the information stored in the corresponding record, the structured storage 202 transmits, to a request source, information stored in the record in which both the first key 2021 and the second key 2022 specified by the request are stored. That is, the first key 2021 and the second key 2022 are also information for specifying a record.

That is, in A11, the start application 63 uploads the information to the structured storage 202 to become the record R1 illustrated in FIG. 5A. As a result, the first key 2021 of the record R1 stores information indicating that the record is a record storing information categorized as an instruction, and the second key 2022 stores information indicating an instruction of a start process among the information categorized as an instruction. The device ID 2024 of the record R1 stores the device ID indicating the MFP 1. Accordingly, the record R1 is a record indicating instruction data addressed to the MFP 1.

The time stamp 2023 is information indicating a date and time when data is stored in the record. The device ID 2024 is information for specifying a device which is a target of the data stored in the record, and the device ID of the device to be subjected to the cloud remote operation is stored in the record R1. The parameter 2025 includes various kinds of information necessary for cloud remote operation. Each record included in the data structure further includes additional information, as necessary. For example, in the instruction data uploaded in A11, as illustrated in FIG. 5A, information indicating that the process to be started is a cloud remote operation and a password input in A01 are stored in the parameter 2025.

On the other hand, each MFP that may be subjected to the cloud remote operation periodically accesses the structured storage 202 using the structured storage access information stored in each memory, and monitors a record in which its own device ID 251 (see FIG. 2) is stored in the device ID 2024, thereby confirming whether there is an instruction to be processed by the MFP itself (A21). For example, the MFP 1 periodically accesses the structured storage 202 using the structured storage access information 242 (see FIG. 2). Thereafter, even if there is no particular description, the MFP 1 accesses the structured storage 202 using the structured storage access information 242.

In a case where the record R1 illustrated in FIG. 5A is uploaded in A11, the MFP 1 can download the stored data from the record R1 of the structured storage 202 (A22). In a case where the MFP 1 acquires instruction data indicating an instruction to the MFP 1 from the record R1, the MFP 1 starts a process based on the received instruction. As illustrated in FIG. 5B, the MFP 1 uploads information indicating the progress status of “executing” to the structured storage 202 such that the information is stored in the information in the record R1. Further, since an instruction according to the record R1 is a start instruction of the cloud remote operation, the MFP 1 executes a start determination process of determining whether to permit the start of the cloud remote operation (A23).

On the other hand, after executing the upload of the instruction data indicating the start instruction of the cloud remote operation in A11, the start application 63 of the PC 5 periodically accesses the record R1 of the structured storage 202 and monitors whether the information indicating the response is stored in the record R1 (A12). For example, the start application 63 may stop the cloud remote operation in a case where information indicating “executing” or “ending” is not stored even in a case where a predetermined time elapses after the upload of the record R1. The “ending” is uploaded by the MFP 1 to be stored in the record R1 when the process based on the instruction received by the MFP 1 is ended.

The MFP 1 is configured to receive a start request for the cloud remote operation by periodically monitoring the structured storage 202, and is configured to receive a start request for the local remote operation from the PC 7 or the like capable of local communication, via the communication IF 14. For example, in a case where the MFP 1 receives an access to the EWS 27 by specifying access information indicating a start request for the local remote operation, the MFP 1 determines that the start request for the local remote operation is received. For example, the user of the PC 7 is configured to activate the browser 92 on the PC 7 and specify access information indicating the local remote operation of the MFP 1 to cause the PC 7 to access the EWS 27 of the MFP 1 and transmit the start request for the local remote operation. The user of the PC 7 may transmit the start request for the local remote operation to the PC 7 via a Web page based on Web page data returned from the EWS 27. That is, the MFP 1 can receive both the start request for the cloud remote operation and the start request for the local remote operation.

In a case where the MFP 1 receives a start request for the cloud remote operation or a start request for the local remote operation, the MFP 1 uses the cloud state information 81, the local state information 82, and the selection state information 83 stored in the memory 12 to determine whether to respond to the start request. For example, in a case where the start request for the cloud remote operation is received, as described above, the MFP 1 executes the start determination process of determining whether to respond to the request (A23). The start determination process in a case where the start request for the local remote operation is received will be described later.

The cloud state information 81 is information indicating whether the MFP 1 receives a start request for the cloud remote operation via the cloud storage service 200. The local state information 82 is information indicating whether the MFP 1 receives the start request for the local remote operation via local communication. The cloud state information 81 and the local state information 82 are information indicating any one of “in use”, “in confirmation”, and “unused”.

Here, “in use” is information indicating that a cloud remote operation or a local remote operation is being provided. A state where the cloud state information 81 is “in use” is an example of a first remote operation providing state. A state where the local state information 82 is “in use” is an example of a second remote operation providing state. Here, “in confirmation” is information indicating a state where the start request for the cloud remote operation or the local remote operation is received and it is in confirmation by the user whether to respond to the request. In a case where the MFP 1 receives a start request for the cloud remote operation or the local remote operation, the MFP 1 can receive selection by the user as to whether to approve provision of the remote operation as described later. Here, “unused” is information indicating a state where the start request for the cloud remote operation or the local remote operation is not received, and thus each operation is not provided.

The selection state information 83 is information indicating a selection result by the user of the MFP 1 regarding whether the start request for the cloud remote operation or the local remote operation is received and the provision is approved. The selection state information 83 is information indicating either “approved” or “rejected”. The “approved” is information indicating that provision of the cloud remote operation or the local remote operation is approved. The “approved” is also information indicating that the remote operation is permitted by the user of the MFP 1. The “rejected” is information indicating that the provision of the cloud remote operation or the local remote operation is rejected by the user of the MFP 1. The selection state information 83 indicating “rejected” is an example of the rejection information.

In a case where the MFP 1 receives the rejection selection by the user and sets the selection state information 83 to information indicating “rejected”, the MFP 1 automatically changes the selection state information 83 to information indicating “approved” for a predetermined period, for example, one minute later. As a result, information indicating “rejected” is deleted from the memory 12. Accordingly, after that, the selection of the user of whether to approve the remote operation is received again. The MFP 1 may receive an instruction to change the selection state information 83 from “rejected” to “approved” according to the user operation.

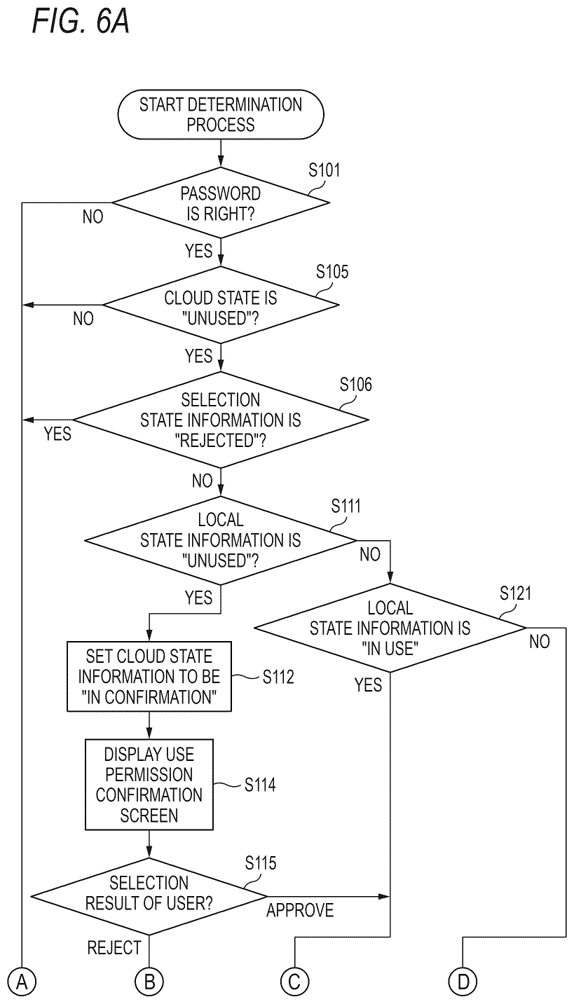

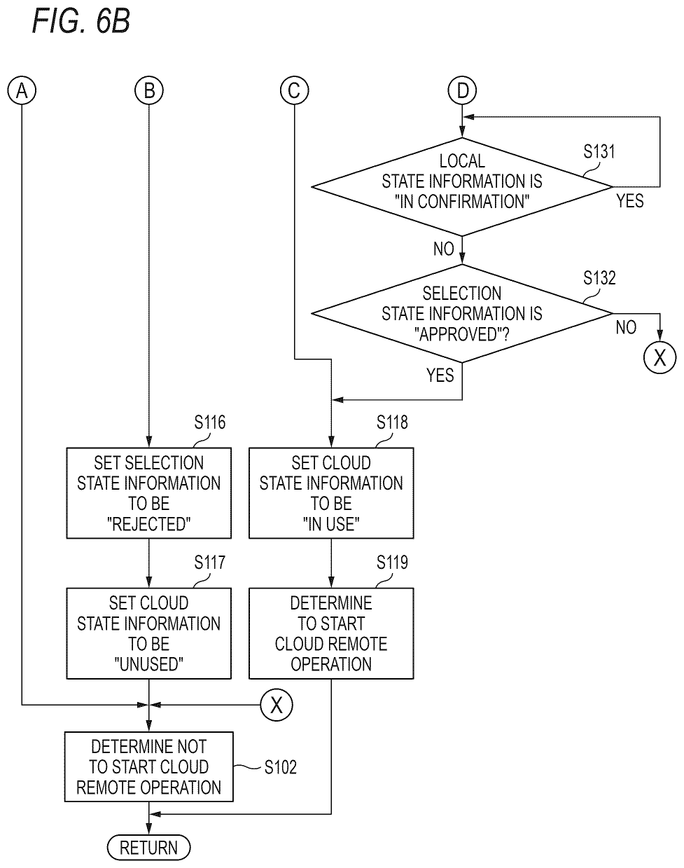

The procedure of the start determination process executed in A23 will be described with reference to the flowchart of FIGS. 6A and 6B. This start determination process is executed by the CPU 11 of the MFP 1 in a case where the information indicating the start instruction of the cloud remote operation is acquired.

In the start determination process, the CPU 11 determines whether the password is correct (S101). The CPU 11 collates a password stored in the downloaded record R1 with the password 252 of the identification information 25 stored in the memory 12, and determines whether the password is correct, for example, whether two passwords correspond to each other. The expression “two passwords correspond to each other” may specifically mean that the two passwords match. If it is determined that the password is not correct (S101: NO), the CPU 11 determines not to start the cloud remote operation with respect to the start instruction of the current cloud remote operation (S102), and ends the start determination process.

The password 252 may be a password necessary for local operation of the MFP 1. For example, in a case where the user of the branch office needs to log in to the MFP 1 in order to operate the MFP 1, the password 252 may be a password that needs to be input via the user IF 13 in order to log in to the MFP 1. The password 252 may be a password for starting the cloud remote operation and may be different from the password used when the MFP 1 is used.

With respect to the password necessary for local operation of the MFP 1, the MFP 1 may enter an account-locked state when the local log-in authentication involving the password input fails a predetermined number of times or more. In a case where the MFP 1 enters an account-locked state, the CPU 11 may determine NO in S101 without collating the password stored in the record R1 with the password 252. In a case where the determination in S101 that the password is not correct is repeated a predetermined number of times or more, the CPU 11 may set the MFP 1 in the account-locked state. The MFP 1 may automatically cancel the account-locked state with a predetermined trigger after a predetermined time elapses or the like.

As described above, in the remote operation system 100, the password 252 for providing the cloud remote operation is stored in the MFP 1, and the MFP 1 performs authentication using the password 252. Therefore, the safety of the cloud remote operation is high.

If it is determined that the password is correct (S101: YES), the CPU 11 determines whether the current cloud state information 81 is “unused” (S105). When the MFP 1 is activated, both the cloud state information 81 and the local state information 82 are “unused”. If it is determined that the cloud state information 81 is not “unused”, that is, “in use” or “in confirmation” (S105: NO), the CPU 11 determines not to respond to the current start request, that is, not to start the requested cloud remote operation (S102), and ends the start determination process.

A cloud remote operation from two or more PCs and the like is assumed to be an operation performed by, for example, a person in the same position. When the MFP 1 according to the present embodiment receives a start request for the cloud remote operation from another PC, the MFP 1 determines not to respond to the newly received start request. For example, when a cloud remote operation is provided to the PC 8, the MFP 1 does not respond to the start request for the cloud remote operation from the PC 5. Accordingly, the MFP 1 is not in a state of simultaneously providing the cloud remote operation to two or more PCs or the like, and confusion of the operation is avoided.

If it is determined that the cloud state information 81 is “unused” (S105: YES), the CPU 11 determines whether the selection state information 83 is “rejected” (S106). If it is determined that the selection state information 83 is “rejected” (S106: YES), the CPU 11 determines not to start the requested cloud remote operation (S102), and ends the start determination process.

On the other hand, in a case where the selection result of the user is “rejected” in response to the previously received start request for the local remote operation or the cloud remote operation, the selection state information 83 is information indicating “rejected”. For example, in a case where the user rejects the start request for the local remote operation, the CPU 11 determines that the start of the cloud remote operation is also rejected. Accordingly, it is possible to reduce the time and effort of the user operation for approval or rejection. The determination in S105 and the determination in S106 may be reversed.

If it is determined that the selection state information 83 is not “rejected” but “approved” (S106: NO), the CPU 11 determines whether the current local state information 82 is “unused” (S111). If it is determined that the local state information 82 is “unused” (S111: YES), the CPU 11 changes the cloud state information 81 to be “in confirmation” (S112). Accordingly, even if the start request for the cloud remote operation is received thereafter, the CPU 11 determines NO in S105 and does not respond to the start request.

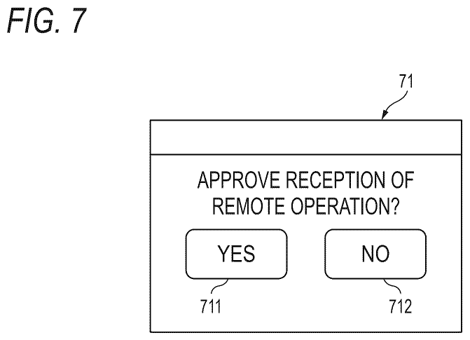

The CPU 11 displays a use permission confirmation screen on the touch panel 131 of the user IF 13 (S114). For example, as illustrated in FIG. 7, the CPU 11 causes the touch panel 131 to display the use permission confirmation screen 71 including a message inquiring whether to approve the reception of the remote operation, a “Yes” button 711 indicating that the remote operation is approved, and a “No” button 712 indicating the rejection of the remote operation, and receives an input indicating a selection operation of the user.

The CPU 11 waits until a user input is received, and in a case where the user input is received, the CPU 11 determines whether the received button is the “Yes” button 711 or the “No” button 712 (S115). In a case where it is determined that the selection result of the user is rejected (S115: rejected), the CPU 11 sets the selection state information 83 to be “rejected” (S116). Further, the CPU 11 returns the display of the touch panel 131 to a state before the use permission confirmation screen 71 is displayed in S121, sets the cloud state information 81 to be “unused” (S117), determines not to start providing the cloud remote operation (S102), and ends the start determination process. Thereafter, even if the start request for the cloud remote operation or the start request for the local remote operation is received, the MFP 1 does not respond to the request while the selection state information 83 is “rejected”.

During execution of the cloud remote operation, the user of the PC 5 virtually browses the display on the touch panel 131, and the MFP 1 is operated. By displaying the use permission confirmation screen 71, a user who is using the MFP 1 can wait for the start of the cloud remote operation by operating the “No” button 712, for example, when a screen that is not desired to be viewed is displayed.

On the other hand, in a case where it is determined that the selection result of the user is approved (S115: approved), the CPU 11 changes the cloud state information 81 to be “in use” (S118), and returns the display of the touch panel 131 to a state before the use permission confirmation screen 71 is displayed in S121. Further, the CPU 11 determines to start the requested cloud remote operation (S119), and ends the start determination process. In this case, the selection state information 83 remains “approved”.

The cloud remote operation in a state where there is no user in front of the MFP 1 may reduce the safety. The MFP 1 according to the present embodiment starts the cloud remote operation when an operation on the “Yes” button 711 of the use permission confirmation screen 71 is received, and thus the safety of the cloud remote operation is high. When the user input is not received even after a predetermined time has elapsed after the use permission confirmation screen 71 is displayed, the MFP 1 may not start the cloud remote operation. For example, the MFP 1 may be configured to omit reception of an operation on the use permission confirmation screen 71. When the setting to omit is received, the approval may be normally selected. The MFP 1 may be configured to start the cloud remote operation when the user input is not received even after the predetermined time has elapsed.

If it is determined that the local state information 82 is not “unused” (S111: NO), the CPU 11 determines whether the local state information 82 is “in use” (S121). If it is determined that the local state information 82 is “in use” (S121: YES), the CPU 11 changes the cloud state information 81 to be “in use” (S118), determines to start the cloud remote operation (S119), and ends the start determination process.

When the local state information 82 is “in use”, it means that selection by the user has been received at the start of the local remote operation and is not rejected by the user. In addition, the MFP 1 according to the present embodiment can be in a state where a cloud remote operation from one PC and a local remote operation from another PC are simultaneously received. When a start request for the cloud remote operation is received in a state where a local remote operation is received, the CPU 11 determines to start the cloud remote operation without receiving the selection by the user. When the provision of the local remote operation is approved, it is troublesome for the user to confirm again whether the start of the cloud remote operation is approved. If one is approved, the other is also approved, thereby avoiding complications of the operation.

If it is determined that the local state information 82 is not “in use” or “unused” (S121: NO), that is, when the local state information 82 is “in confirmation” (S131: YES), the CPU 11 waits until the local state information 82 is not “in confirmation”. In this case, the MFP 1 is in a state where the MFP 1 executes the start determination process (this process is similar to the start determination process of FIGS. 6A and 6B, and is referred to as a local start determination process for convenience) in response to the reception of the start request for the local remote operation in parallel with the start determination process in response to the start request for the cloud remote operation this time, and already displays the above-described use permission confirmation screen 71 (S114 of the local start determination process) in a local start determination process in response to the start request for the local remote operation and waits for the selection by the user. If the local state information 82 is not “in confirmation” (S131: NO), the CPU 11 determines whether the selection state information 83 is “approved” (S132).

If it is determined that the selection state information 83 is “approved” (S132: YES), that is, when the MFP 1 receives an operation on the “Yes” button 711 of the currently displayed use permission confirmation screen 71, changes the local state information 82 to be “in use” in the local start determination process (S118 of the local start determination process), and determines to start providing the local remote operation (S119 of the local start determination process), the CPU 11 changes the cloud state information 81 to be “in use” (S118), determines to start the cloud remote operation (S119), and ends the start determination process. In this case, it is determined to start providing the local remote operation in response to the previously received start request for the local remote operation from another PC, and the MFP 1 starts the local remote operation and also starts the cloud remote operation from the PC 5.

If it is determined that the selection state information 83 is not “approved” but “rejected” (S132: NO), that is, when the MFP 1 receives an operation on the “No” button 712 of the currently displayed use permission confirmation screen 71, changes the selection state information 83 to be “rejected” in the local start determination process (S116 of the local start determination process), changes the local state information 82 to be “unused” (S117 of the local start determination process), and determines not to start providing the local remote operation (S102 of the local start determination process), the CPU 11 proceeds to S102, determines not to start the cloud remote operation (S102), and ends the start determination process. In this case, MFP 1 decides not to start providing local remote operation in response to the previously received start request for the local remote operation from another PC, and does not start the local remote operation and does not start the cloud remote operation from the PC 5.

It takes time and effort for the user to inquire about the use permission many times. When the start request for the local remote operation from the other PC is approved, the MFP 1 determines that the start request for the cloud remote operation from the PC 5 is also approved. When the start request for the local remote operation from the other PC is rejected, the MFP 1 determines that the start request for the cloud remote operation from the PC 5 is also rejected, so that operations can be prevented from being complicated.

In a case where the MFP 1 receives the start request for the local remote operation, the MFP 1 executes the same process as the start determination process illustrated in FIGS. 6A and 6B, for example, the local start determination process, and determines whether to start the local remote operation for which the start request is received. Specifically, in a case where the start request for the local remote operation is received, the CPU 11 executes a process in which the cloud state information 81 in the start determination process in FIGS. 6A and 6B is read as the local state information 82 and the local state information 82 is read as the cloud state information 81. An operation on the displayed use permission confirmation screen 71 in the start determination process executed when the start request for the local remote operation is received is an example of a second operation.

Since the MFP 1 receives the access using access information to the EWS 80 of the MFP 1 in the start request for the local remote operation, the MFP 1 may not request a password. In this case, the CPU 11 skips S101 of the start determination process. A procedure after the MFP 1 determines to respond to the start request for the local remote operation will be described later.

Here, regarding the procedure of the start determination process, an embodiment different from the example illustrated in FIGS. 6A and 6B will be described. In this example, the cloud state information 81 and the local state information 82 are information indicating either “unused” or “not unused”. Here, “unused” is information indicating a state where each remote operation is not provided and a start request is not received. In addition, “not unused” is information indicating a state other than “unused”. In this example, the selection state information 83 is information indicating any one of “approved”, “in confirmation”, or “rejected”. The “rejected” is information indicating a state where the remote operation is rejected by the user of the MFP 1 through the use permission confirmation screen 71, as in the above-described example. Here, “in confirmation” is information indicating a state where the use permission confirmation screen 71 is displayed and the user input is waiting. Similarly to the above-described example, the “approved” is information indicating a state where the remote operation is approved by the user of the MFP 1 through the use permission confirmation screen 71. When none of the states is satisfied, the selection state information 83 does not indicate any one of “approved”, “in confirmation”, or “rejected”. In this case, for example, the selection state information 83 may indicate “before confirmation”. For example, the selection state information 83 may indicate “initial”.

In this example, firstly, the CPU 11 also determines whether the password is correct (S101). If it is determined that the password is correct (S101: YES), the CPU 11 proceeds to S105, and confirms whether the cloud state information 81 is “unused”. In a case where the cloud state information 81 is “unused” (S105: YES), the CPU 11 confirms the selection state information 83 (S106). If the cloud state information 81 is “not unused” (S105: NO), or if the selection state information 83 is “rejected” (S106: YES), the CPU 11 determines not to start providing the cloud remote operation (S102), and ends the start determination process.

On the other hand, when the cloud state information 81 is “unused” and the selection state information 83 is not “rejected” (S106: NO), the CPU 11 changes the cloud state information 81 to be “not unused”. By changing the cloud state information 81 to be “not unused”, even when a start request for the cloud remote operation is received thereafter, the CPU 11 determines NO in S105 and does not respond to the start request.

In a case where the selection state information 83 is “approved”, the CPU 11 determines to start providing the cloud remote operation (S119), and ends the start determination process. On the other hand, in a case where the selection state information 83 does not indicate any of “approved”, “in confirmation”, and “rejected”, the CPU 11 changes the selection state information 83 to “in confirmation”, displays the use permission confirmation screen 71 on the touch panel 131 of the user IF 13 (S114), and determines the selection result of the user through the use permission confirmation screen 71 (S115).

In a case where the CPU 11 determines that the selection result of the user is rejected through the use permission confirmation screen 71 (S115: rejected), as described above, the CPU 11 changes the selection state information 83 to be “rejected” (S116), changes the cloud state information 81 to be “unused” (S117), determines not to start providing the cloud remote operation (S102), and ends the start determination process. In a case where the CPU 11 determines that the selection result of the user is approved through the use permission confirmation screen 71 (S115: approved), the CPU 11 changes the selection state information 83 to be “approved”, determines to start providing the cloud remote operation (S119), and ends the start determination process.

On the other hand, in S106, in a case where the selection state information 83 is “in confirmation”, the process waits until the selection state information 83 is not “in confirmation”. In a case where the selection state information 83 is not “in confirmation”, that is, when the selection of the user is received, the CPU 11 determines whether the selection state information 83 is “approved” (S132). In a case where the selection state information 83 is “approved”, the CPU 11 determines to start providing the cloud remote operation (S119), and ends the start determination process.

If it is determined in S101 that the password is not correct, or if the selection state information 83 is “rejected” in S132, the CPU 11 changes the cloud state information 81 to be “unused” (S117), determines not to start providing the cloud remote operation (S102), and ends the start determination process. Thus, it is possible to appropriately determine whether to start the cloud remote operation.

As described above, when it is determined to start providing the cloud remote operation, the selection state information 83 is “approved”. When the provision of the started cloud remote operation is ended, if the local state information 82 is “unused”, the CPU 11 changes the selection state information 83 to indicate none of “approved”, “in confirmation”, and “rejected”.

Returning to the description of the start instruction procedure in FIGS. 4A and 4B. In a case where it is determined to start the cloud remote operation in S131 of FIG. 6B (alt; “started”), the MFP 1 requests the non-structured storage 201 or the structured storage 202 to delete data related to the cloud remote operation (A31). For example, when data uploaded by the previous cloud remote operation remains, there is a possibility of confusion with an instruction related to the current cloud remote operation. When the cloud remote operation is started, the MFP 1 deletes the data remaining in the non-structured storage 201 or the structured storage 202, thereby avoiding an influence of the previous cloud remote operation.

Thereafter, the MFP 1 creates, in the non-structured storage 201, the folder 2011 (see FIG. 2) for a host device to be used in the current cloud remote cloud remote operation (A32). For example, the MFP 1 creates the folder 2011 whose folder name includes its own device ID 251 (see FIG. 2). If the folder 2011 has been created, the MFP 1 may delete all the data in the folder in A31 and skip A32. Furthermore, as described above, the MFP 1 creates the host folder access information 243 for accessing the folder 2011 created in A32 in the non-structured storage 201 (A33). The host folder access information 243 is in the form of a URL. The MFP 1 may store the created host folder access information 243 in the memory 12. Thereafter, even if there is no particular description, the MFP 1 accesses the folder 2011 created in the non-structured storage 201 using the host folder access information 243.

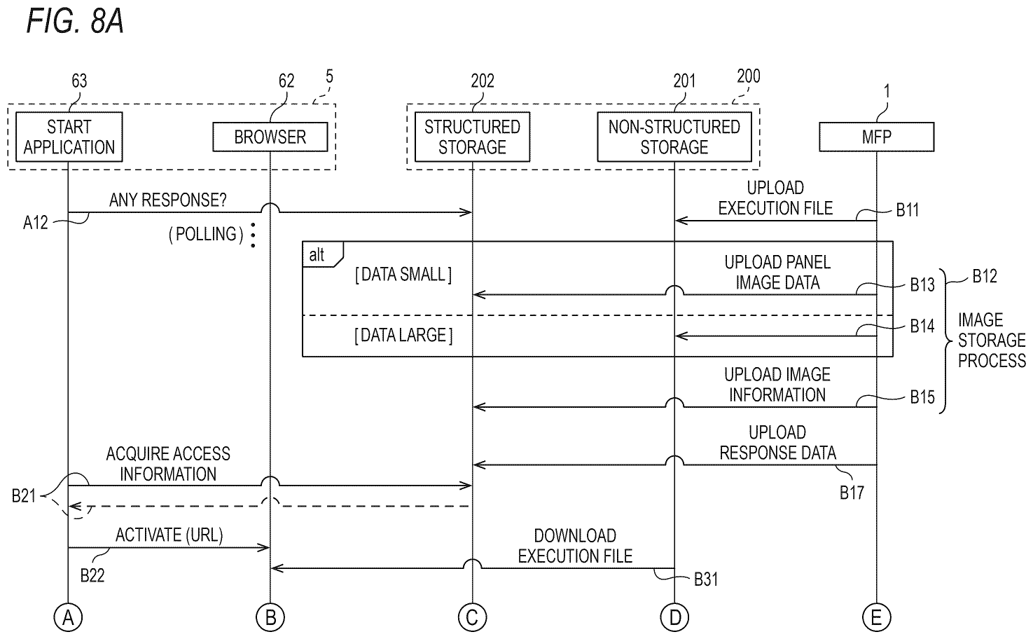

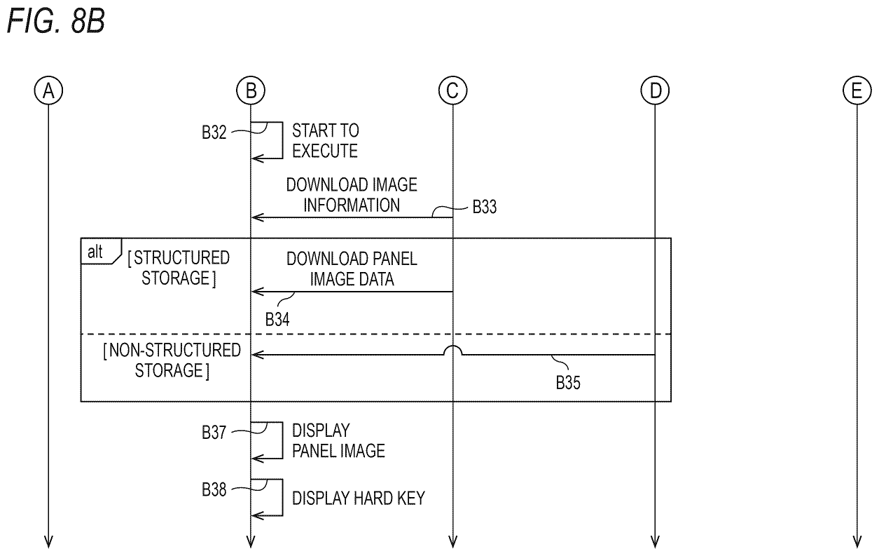

The MFP 1 and the PC 5 execute a screen preparation procedure, which is a procedure for causing the user IF 53 of the PC 5 to display a screen for virtually reproducing the user IF 13 of the MFP 1 that receives the cloud remote operation (A35). The screen preparation procedure will be described with reference to a sequence diagram of FIGS. 8A and 8B.

The MFP 1 uploads the execution file 26 (see FIG. 1) to the folder 2011 created in the non-structured storage 201 in A32 in FIG. 4A, using the host folder access information 243 created in A33 (B11). That is, the execution file 26 is disposed in the folder 2011.

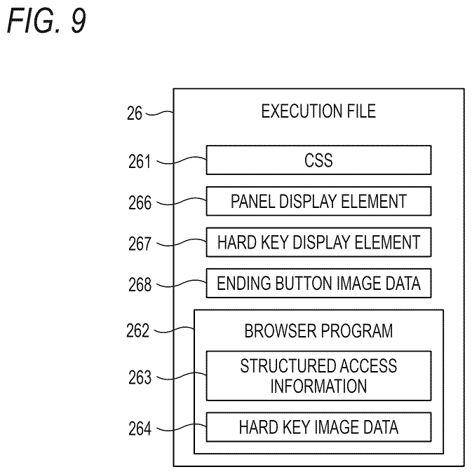

For example, as illustrated in FIG. 9, the execution file 26 includes a CSS 261 and a browser program (hereinafter referred to as “browser P”) 262, and is one html file described in HTML. The CSS 261 is information for setting a layout such as a color, a size, a background, and an arrangement of characters of a Web page to be displayed, in order to display an image for virtually reproducing the user IF 13 of the MFP 1 on the browser 62 of the PC 5. A browser P262 is, for example, a program described in JavaScript (registered trademark), is operable by the browser 62, and causes the browser 62 to execute a process for a cloud remote operation. The browser P262 is an example of a first remote operation program. B11 is an example of a program upload process.

Further, structured access information 263 and hard key image data 264 are embedded in the browser P262 of the execution file 26. The structured access information 263 is information used for the browser P262 to access an area available for the MFP 1 in the structured storage 202, and is in the form of a URL. The structured access information 263 embedded in the execution file 26 may be the same as or partially different from the structured storage access information 242 stored in the MFP 1. The structured access information 263 may be information generated by the CPU 11 of the MFP 1 based on an account name, a token, and the like included in the structured storage access information 242.

The hard key image data 264 is a plurality of pieces of image data corresponding to hard keys 132 included in the user IF 13, and is described in a gif format, for example. The hard key image data 264 includes, for example, icon images indicating the hard keys 132.

By uploading the execution file 26 including the structured access information 263 for accessing the structured storage 202, the PC 5 that downloads the execution file 26 in a later procedure can acquire the browser P262 and the structured access information 263. Therefore, the PC 5 can access the structured storage 202 using the structured access information 263, based on the process by the browser P262.

Further, the execution file 26 includes, for example, a panel display element 266, a hard key display element 267, and ending button image data 268 as illustrated in FIG. 9. The panel display element 266 is an image embedding element for causing the browser P262 to display a panel image for virtually reproducing an image displayed on the touch panel 131 of the MFP 1. The hard key display element 267 is an image embedding element for displaying, on the browser P262, key images for virtually reproducing the hard keys 132 of the MFP 1. The ending button image data 268 is image data for displaying an ending button 533 to be described later on the browser P262.

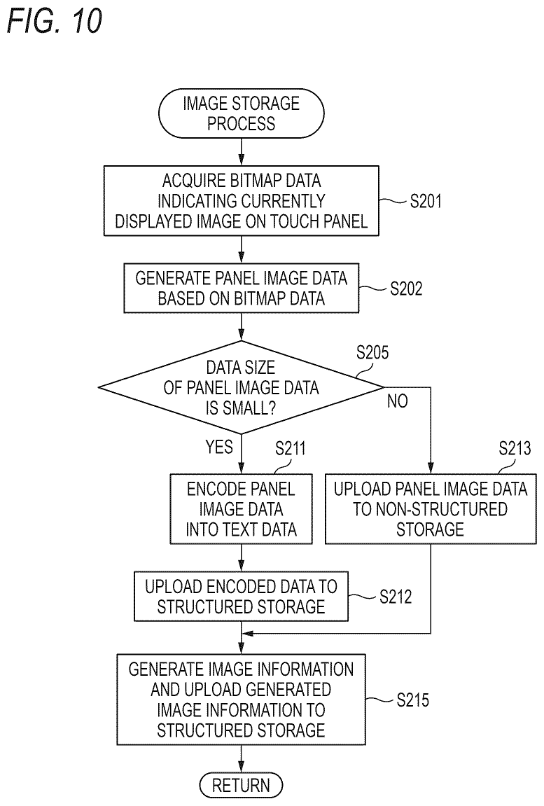

Further, the MFP 1 executes an image storage process (B12). A procedure of the image storage process will be described with reference to a flowchart of FIG. 10. The image storage process is a process of uploading panel image data indicating a currently displayed panel image to the cloud storage service 200, in order to display, on the user IF 53 of the PC 5, a panel image for virtually reproducing a currently displayed screen on the touch panel 131 of the user IF 13 of the MFP 1. The image storage process is executed by the CPU 11 of the MFP 1, in a case where it is necessary to upload the panel image data. The currently displayed screen on the touch panel 131 is an example of a main body operation screen and an example of a main body panel screen.

The MFP 1 is configured to display, for example, a screen including a plurality of icons on the touch panel 131, and is configured to receive an instruction to execute a process indicated by the icon in response to an operation on an area where the icon is displayed. For example, in a case where an operation on a copy icon included in a currently displayed standby screen on the touch panel 131 is received, the MFP 1 displays a setting screen including an icon for instructing a setting change of a copy process, an input field of a setting value to be changed, an icon for instructing execution of the copy process, and the like. The MFP 1 changes the setting of the copy process when receiving an instruction operation related to the setting change. In a case where the MFP 1 receives an operation on an icon for instructing execution of the copy process, the MFP 1 starts execution of the copy process. The icon displayed on the touch panel 131 is an example of an operator. The operation on the copy icon, the operation on the icon for instructing the setting change, an input of a setting value to an input field, the operation on the icon for instructing the execution of the copy process, and the like are examples of the operation related to the image formation, and the copy process is an example of an image forming process.

Upon receiving an operation on the hard key 132 included in the user IF 13, the MFP 1 can execute a process based on the received hard keys 132. For example, upon receiving an operation to the return key, the MFP 1 can stop a process of the previously received operation and return to a state before the reception. For example, upon receiving the operation to the return key in a state where a setting screen of the copy process is displayed, the CPU 11 causes the touch panel 131 to display a previous screen, for example, a standby screen.

First, the CPU 11 acquires bitmap data indicating a currently displayed screen on the touch panel 131 at that time (S201). Here, the bitmap data will be supplementarily described. When displaying various screens on the touch panel 131, the MFP 1 generates bitmap data indicating a screen for display. The MFP 1 stores image data serving as a component of each screen in the memory 12 as, for example, the display image data 22 (see FIG. 1). The MFP 1 reads, from the display image data 22, image data to be a component of a screen to be displayed, such as image data indicating a background image of each screen and image data indicating an icon, and generates image data indicating a screen and bitmap data using the read image data.

Different screen IDs are provided on different screens such as a standby screen and a copy setting screen. The MFP 1 can identify what screen a currently displayed screen based on the screen ID is. For example, during the display of the standby screen, the MFP 1 temporarily stores, in the memory 12, the screen ID of the standby screen as the screen ID of the currently displayed screen. When the display is switched to the copy setting screen, the MFP 1 generates the bitmap data indicating the copy setting screen, and temporarily stores a screen ID indicating the copy setting screen in the memory 12 as the screen ID of the currently displayed screen.

When an input of a setting value to an input field is received during the display of a copy screen, the MFP 1 generates bitmap data indicating a copy setting screen in which the content of the input field is changed to indicate the input setting value without changing the screen ID of the currently displayed screen. As described above, in a case where the content of the screen is changed during the display of several screens, for example, in a case where a mode of an icon is changed and how many text displays are changed, the MFP 1 generates bitmap data indicating a screen whose content is changed without changing the screen ID of the currently displayed screen. In many cases, a screen having a significantly different role, that is, a screen having a different screen ID often has a significantly different layout. For example, even when the screen IDs are different, such as a copy setting screen and a scan setting screen, the entire layout is similar.

The CPU 11 generates panel image data, which is image data to be displayed on the user IF 53 of the PC 5 in a later procedure, based on the bitmap data acquired in S201 (S202). For example, the CPU 11 compresses the obtained bitmap data to generate PNG data.

The data indicating the currently displayed screen on the touch panel 131 is not limited to bitmap data, and may be PNG data or JPEG data, for example. The panel image data is not limited to data indicating a screen such as bitmap data, and may be data indicating a screen. Instead of creating the panel image data from the data indicating the screen, the CPU 11 may acquire image data serving as a component included in the currently displayed screen on the touch panel 131 and create the panel image data using the obtained image data.

When a moving image or an animation is included in the currently displayed screen, the CPU 11 may generate panel image data not including the moving image or the animation, or may generate the panel image data to which one scene of the moving image or the animation is added as a still image. In the moving image whose amount of data tends to be large, a communication load is high, and a timing at which the contents displayed on a PC 5 side and an MFP 1 side are different is likely to occur due to a communication delay. Since the MFP 1 according to the present embodiment generates panel image data that does not include a moving image, an image that does not include a moving image is displayed on the user IF 53 of the PC 5, and a display shift is unlikely to occur.

The CPU 11 determines whether a data size of the generated panel image data is smaller than a predetermined size (S205). The panel image data to be uploaded has, for example, different compression effectiveness for each type of screen, and a data size after compression may or may not be large. For example, a screen including only an icon and a menu such as a standby screen tends to be reduced in size by compression, whereas a screen including a print preview image and a scan result image tends to have a large data size. The data size of data that can be stored in each record of the structured storage 202 is limited by the cloud storage service 200.

If it is determined that the size is smaller than the predetermined size (S205: YES), the CPU 11 encodes the panel image data in a text data format according to a predetermined rule (S211). In the structured storage 202, since the text data format is suitable as the format of data stored in each record, the CPU 11 encodes the panel image data into the text data format. However, if the data format suitable for storing in the structured storage 202 is defined in the cloud storage service 200 in addition to the text data format, the CPU 11 may encode the panel image data in the data format. If the format of the panel image data is a data format suitable for storing in the structured storage 202, the CPU 11 may not encode the panel image data.

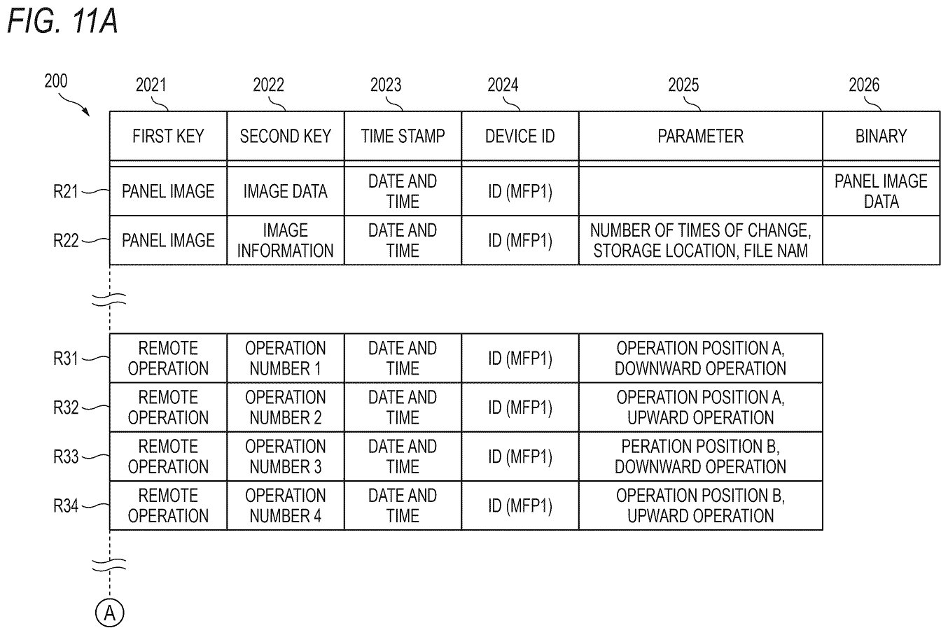

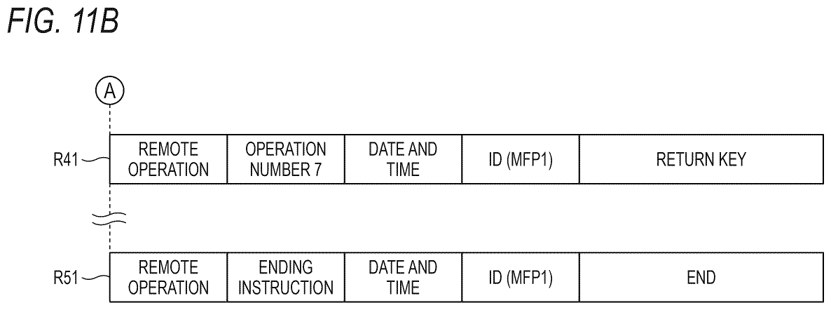

The CPU 11 uploads the encoded panel image data to the structured storage 202 (S212, B13 in FIG. 8A). Specifically, the MFP 1 uploads each piece of information to the structured storage 202, for example, as a record R21 illustrated in FIG. 11A. That is, the MFP 1 uploads each piece of information to the structured storage 202 such that the device ID of the MFP 1 is stored in the device ID 2024 of a record in which information indicating a panel image is stored in the first key 2021 and information indicating image data is stored in the second key 2022, and the panel image data encoded in the text data format is stored in the binary 2026. S212 and B13 in FIG. 8A are examples of an image upload process. The panel image data uploaded in S212 and B13 in FIG. 8A is an example of first image data.

On the other hand, if it is determined that the data size of the panel image data is not smaller than the predetermined size, that is, if it is determined that the panel image data cannot be stored in the record of the structured storage 202 (S205: NO), the CPU 11 accesses the folder 2011 of the non-structured storage 201 using the above-described host folder access information 243 (see FIG. 2) and uploads the panel image data to the non-structured storage 201 (S213, B14 in FIG. 8A). S213 and B14 in FIG. 8A are examples of the image upload process. The panel image data uploaded in S213 and B14 in FIG. 8A is an example of the first image data.

That is, the MFP 1 creates a file including the panel image data and uploads the file to the folder 2011 generated in A32 of FIG. 4A. The folder 2011 is a folder whose folder name includes the device ID of the MFP 1. In this case, the MFP 1 does not upload the panel image data to the structured storage 202. That is, the panel image data is not stored in the record R21.

The panel image data uploaded to the structured storage 202 or the non-structured storage 201 is read by the browser 62 of the PC 5 in a procedure to be described later. The panel image data includes image data indicating a screen for virtually reproducing a screen displayed on the user IF 13 of the MFP 1 on the user IF 53 of the PC 5. By using the cloud storage service 200, an upload destination is selectively used according to the size of the image data. Therefore, even when the panel image data has a large data size, the panel image data can be passed to the browser 62 via the cloud storage service 200.

Further, the CPU 11 generates image information which is information related to the uploaded panel image data and uploads the image information to the structured storage 202 (S215, B15 in FIG. 8A). For example, the MFP 1 uploads the image information to the structured storage 202 as a record R22 illustrated in FIG. 11A. The MFP 1 uploads each piece of information to the structured storage 202 such that the device ID of the MFP 1 is stored in the device ID 2024 of a record in which the information indicating the panel image is stored in the first key 2021 and the information indicating the image information is stored in the second key 2022, and information indicating the number of times of change in the panel image data, information indicating a storage location of the panel image data, and information indicating a file name of the panel image data are stored in the parameter 2025. The information indicating the storage location of the panel image data includes information indicating whether the panel image data is stored in the record R21 or the panel image data is uploaded to the folder 2011 of the non-structured storage 201. Hereinafter, for convenience, information stored in the parameter 2025 of the record R22, that is, the information indicating the number of times of change in the panel image data, the information indicating the storage location of the panel image data, and the information indicating the file name of the panel image data will be described as image information.

Since the panel image data uploaded in B13 or B14 in FIG. 8A is the first panel image data of the current cloud remote operation, the MFP 1 sets the number of times of change included in the image information uploaded in B15 to “1”. Although details will be described later, the MFP 1 may upload the panel image data again in the following procedure, and stores the number of times of change obtained by adding one by one in the record of the image information each time the panel image data is uploaded.

The record R21 for storing the panel image data and the record R22 for storing the image information are paired records for uploading one piece of panel image data. Although not illustrated, another pair of record pairs are prepared in the structured storage 202 in the same manner as the record pair of the record R21 and the record R22. When uploading the information related to the panel image data in the subsequent times, the MFP 1 uploads the information related to the panel image data to the record of the record pair having the smaller number of times of change stored among the two pairs of record pairs. That is, the MFP 1 alternately uploads the two record pairs. The MFP 1 may upload the information related to the panel image data to the record pair whose stored time stamp is older.

There may be three or more pairs of record pairs for storing information related to the panel image data. In this case, the MFP 1 uploads the information related to the panel image data to the record of the record pair having the smallest number of times of change stored therein. Alternatively, the MFP 1 may upload the information related to the panel image data to the record pair whose stored time stamp is oldest.

After S215, the CPU 11 enters a state where the cloud remote operation is in a providing state, ends the image storage process, and returns to the screen preparation procedure in FIGS. 8A and 8B.

When the MFP 1 determines that the panel image data has a size that cannot be stored in the record of the structured storage 202, the MFP 1 may divide the panel image data into a plurality of pieces of data and upload the divided data into a plurality of records of the structured storage 202, instead of uploading the data to the non-structured storage 201. For example, the MFP 1 may divide the panel image data into data indicating an upper half of the screen and data indicating a lower half of the screen, and upload the divided data to store the divided data in the two records. The MFP 1 may determine the number of divisions according to the data size of the panel image data. In this case, the MFP 1 may encode each of the plurality of piece of divided panel image data into a text data format, store the encoded data in a plurality of records, and store information indicating the number of divisions and information indicating the order of each record as image information. Even in this case, by uploading the divided data according to the data size of the panel image data, image data having a large size can be passed to the browser 62 via the cloud storage service 200.

Returning to the description of the screen preparation procedure in FIGS. 8A and 8B. In FIGS. 8A and 8B, a procedure for uploading the panel image data to the structured storage 202 (S212 in FIG. 10) in the image storage process of B12 is indicated by B13, and a procedure for uploading the panel image data to the non-structured storage 201 (S213 in FIG. 10) is indicated by B14. A procedure for uploading the image information to the structured storage 202 (S215 in FIG. 10) is indicated by B15. After uploading the execution file 26 in B11 and uploading the panel image data and the image information in B12, the MFP 1 uploads response data indicating that the process is completed to the structured storage 202 in response to the instruction data acquired in A22 of FIG. 4A (B17). After uploading the response data, the MFP 1 may execute the image storage process in B12.

For example, the MFP 1 uploads the response data such that the response data is stored in the record R1 (see FIG. 5A) including the instruction data. Specifically, for example, as illustrated in FIG. 5C, the MFP 1 uploads each piece of information such that information indicating “ending” is stored in the record R1 as a progress status, information indicating “success” is stored as a result, and access information for downloading the execution file 26 uploaded in B11 is stored as additional information 2027.

The access information stored in the additional information 2027 of the record R1 is information for accessing the folder 2011 whose folder name includes the device ID of the MFP 1, which is created in the non-structured storage 201. The access information stored in the additional information 2027 is in the form of a URL. The access information stored in the additional information 2027 may be the same as or partially different from the host folder access information 243 created in A33. The MFP 1 may store the host folder access information 243 in the additional information 2027 as it is. For example, the MFP 1 may combine the non-structured storage access information 241 and the device ID 251 stored in the memory 12 to create access information stored in the additional information 2027.

On the other hand, as described above, after uploading the record R1 including the instruction data in A11, the start application 63 of the PC 5 periodically accesses the structured storage 202 and monitors the presence or absence of a response to the instruction according to the record R1 (A12). When the information on the progress status included in the record R1 changes from “executing” to “ending”, if the information indicating “success” is stored as a result, the start application 63 can start the cloud remote operation.

The start application 63 acquires access information from the additional information 2027 of the record R1 in which the information indicating “success” is stored (B21). The start application 63 further activates the browser 62 and passes the access information acquired from the additional information 2027 to the activated browser 62 (B22).

The browser 62 downloads the execution file 26 from the folder 2011 of the non-structured storage 201 by non-anonymous access using the access information passed from the start application 63 (B31). As described above, the execution file 26 includes the CSS 261, and the browser 62 sets a display configuration of a Web page based on the CSS 261 of the acquired execution file 26. Since the execution file 26 includes the browser P262, the browser 62 starts executing a process based on the browser P262 (B32).

Further, since the structured access information 263 is included in the execution file 26, the browser 62 accesses the structured storage 202 using the structured access information 263 and downloads the image information (B33). The image information is information uploaded by the MFP 1 in B15. The browser 62 downloads the image information from the record in which image information having number of times of change of “1” is stored in B33. As described above, the MFP 1 uploads the record R22 such that the image information having the number of times of change of “1” is stored in B15 of FIG. 8A. The browser 62 downloads the image information stored in the record R22.

That is, by downloading the execution file 26, the browser 62 can acquire the structured access information 263 and access the structured storage 202 using the structured access information 263. Accordingly, preparing the structured access information 263 in the start application 63 is unnecessary. The start application 63 may be configured to generate the structured access information 263 and pass the information to the browser 62.

The browser 62 downloads the panel image data from the structured storage 202 or the non-structured storage 201, based on the information stored in the parameter 2025 of the record R22 of the image information (B34 or B35). If the storage location of the panel image data is the structured storage 202 (alt: [structured storage]), the browser 62 downloads the panel image data stored in the record R21 of the structured storage 202 (B34). If the storage location of the panel image data is the non-structured storage 201 (alt: “non-structured storage”), the browser 62 downloads the panel image data stored in the folder 2011 of the non-structured storage 201 (B35).

As described above, when the data size of the panel image data is large, the MFP 1 may divide the panel image data and upload the panel image data to the structured storage 202, instead of uploading the panel image data to the non-structured storage 201. In this case, the browser 62 can acquire panel image data by downloading a plurality of pieces of panel image data divided from the structured storage 202 based on the image information and integrating the plurality of pieces of panel image data based on the image information.

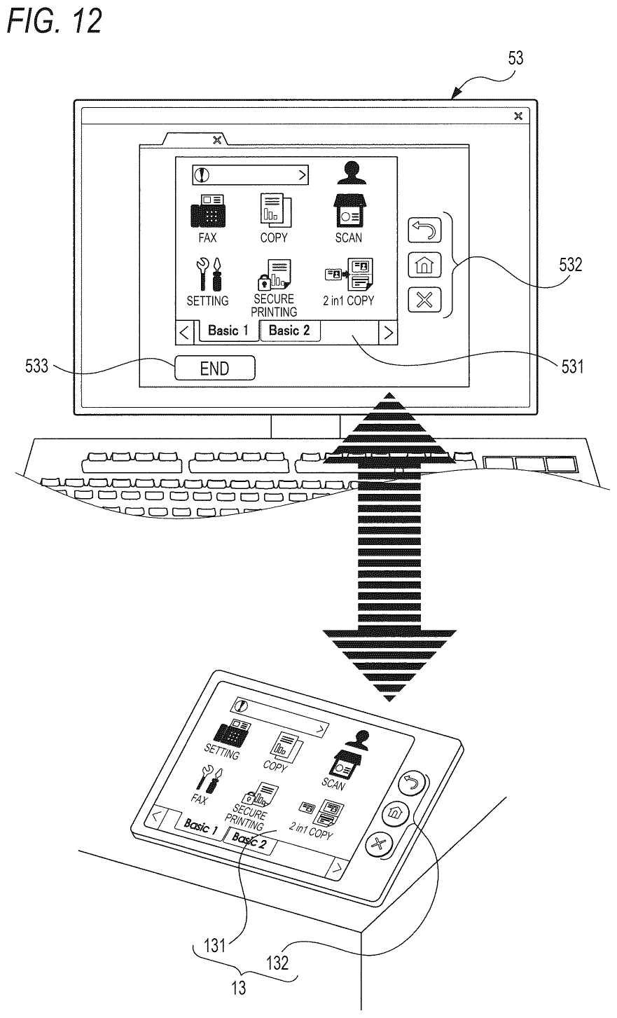

For example, as illustrated in FIG. 12, the browser 62 displays a panel image 531 at a position of the user IF 53 corresponding to the panel display element 266 based on the downloaded panel image data (B37). The panel image 531 is an example of a first remote operation screen, and B37 is an example of a screen display process. The panel image 531 displayed on the user IF 53 of the PC 5 is an image for virtually reproducing a currently displayed screen on the touch panel 131 of the user IF 13 of the MFP 1 at that time.

Further, for example, as illustrated in FIG. 12, the browser 62 displays key images 532 at positions of the user IF 53 corresponding to the hard key display element 267 based on the hard key image data 264 (B38). The three key images 532 displayed on the user IF 53 of the PC 5 are images corresponding to the respective three hard keys 132 included in the user IF 13 of the MFP 1. Thus, an image for virtually reproducing the user IF 13 of the MFP 1 including the touch panel 131 and the hard keys 132 is displayed on the user IF 53 of the PC 5.

Although FIG. 12 illustrates an example in which the standby screen is displayed, a screen displayed in B37 is a screen for virtually reproducing a screen displayed on the touch panel 131 of the MFP 1 at that time, and is not limited to the standby screen. For example, when an error occurs in the MFP 1 and an error screen is displayed on the touch panel 131, an error screen is also displayed on the user IF 53 of the PC 5. As described above, when a copy setting screen is displayed on the touch panel 131, the copy setting screen is also displayed on the user IF 53 of the PC 5.

The screen displayed on the user IF 53 by the browser 62 includes the panel image 531 for virtually reproducing the screen displayed on the touch panel 131 of the MFP 1 and the key images 532 for virtually reproducing the hard keys 132. That is, since an image for virtually reproducing the user IF 13 of the MFP 1 is displayed on the user IF 53 of the PC 5, the user of the PC 5 can execute the same operation as an operation on the MFP 1 by the user IF 53 in the following procedure, and can easily execute a cloud remote operation. The arrangement and the shapes of the key images 532 displayed on the user IF 53 are preferably the same as those on the user IF 13 of the MFP 1, and may be the same as those on the user IF 13 of the MFP 1.

The ending button 533 is further displayed on the user IF 53 of the PC 5. The ending button 533 is a button that is not included in the user IF 13 of the MFP 1, and is operated when the user who is executing the cloud remote operation on the PC 5 instructs to end the cloud remote operation.

Returning to the description of the start instruction procedure in FIGS. 4A and 4B when the screen preparation procedure in FIGS. 8A and 8B is completed. Next, a procedure when the cloud remote operation is determined not to be started in the start determination process in A23 of FIG. 4A will be described. A continuation of the procedure when it is determined to start the cloud remote operation in A23 of FIG. 4A will be described later.

For example, as illustrated in FIGS. 6A and 6B, if the MFP 1 determines that the password included in the instruction data is not correct (NO in S101), if the MFP 1 has already received a cloud remote operation by another PC or the like (NO in S105), or if an operation to the “No” button 712 is received on the use permission confirmation screen 71 (see FIG. 7) (rejected in S115), the MFP 1 determines not to start the cloud remote operation (S102).

When it is determined in the start determination process in A23 that the cloud remote operation is not started (alt: “not started”), the MFP 1 does not upload the execution file 26 and uploads information indicating that the cloud remote operation is not started to the structured storage 202 (A41). As illustrated in FIG. 5D, the MFP 1 uploads each piece of information such that information indicating “ending” indicating completion of the process as the progress status and information indicating “failure” as the result are stored in the record R1. The MFP 1 may further store, in the record R14, information indicating the reason why the cloud remote operation is not started.

The start application 63 of the PC 5 monitors the presence or absence of the response data to the instruction of the record R1 (A12), and downloads the response data when the progress status of the record R1 changes from “executing” to “ending” (A43). If the information indicating “failure” is stored as the response data, the start application 63 causes the user IF 53 to display a message indicating that the cloud remote operation is rejected (A44). Further, the start application 63 deletes the instruction data uploaded in A11 from the structured storage 202 (A45). In this case, the cloud remote operation is not started. A user who wants to execute the cloud remote operation inputs a start instruction of the cloud remote operation to the start application 63 again by executing, for example, an operation of inputting a password again.

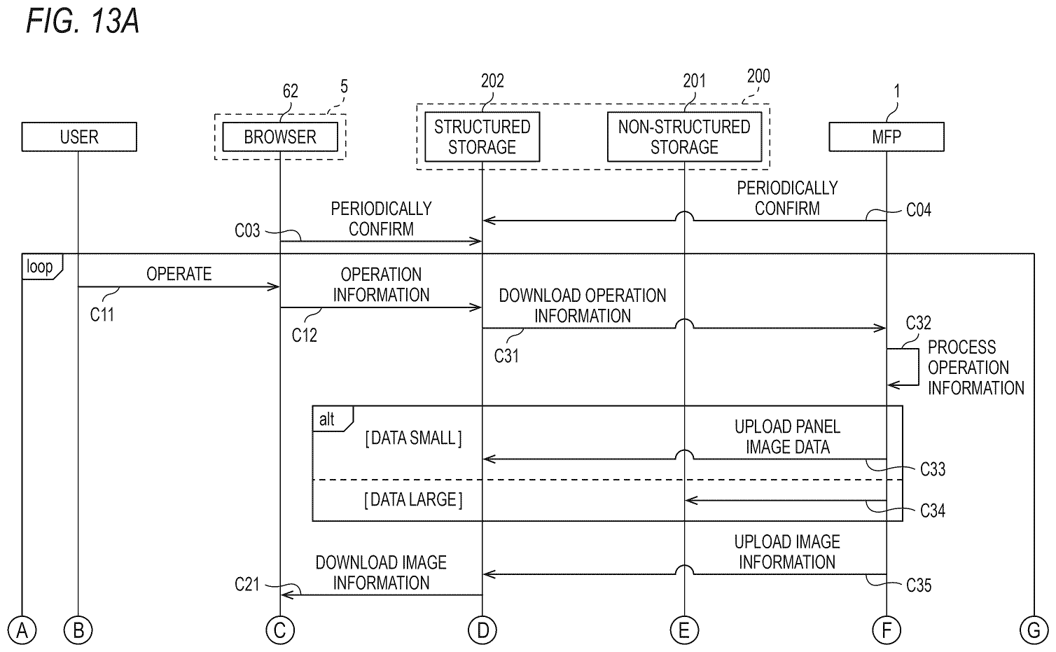

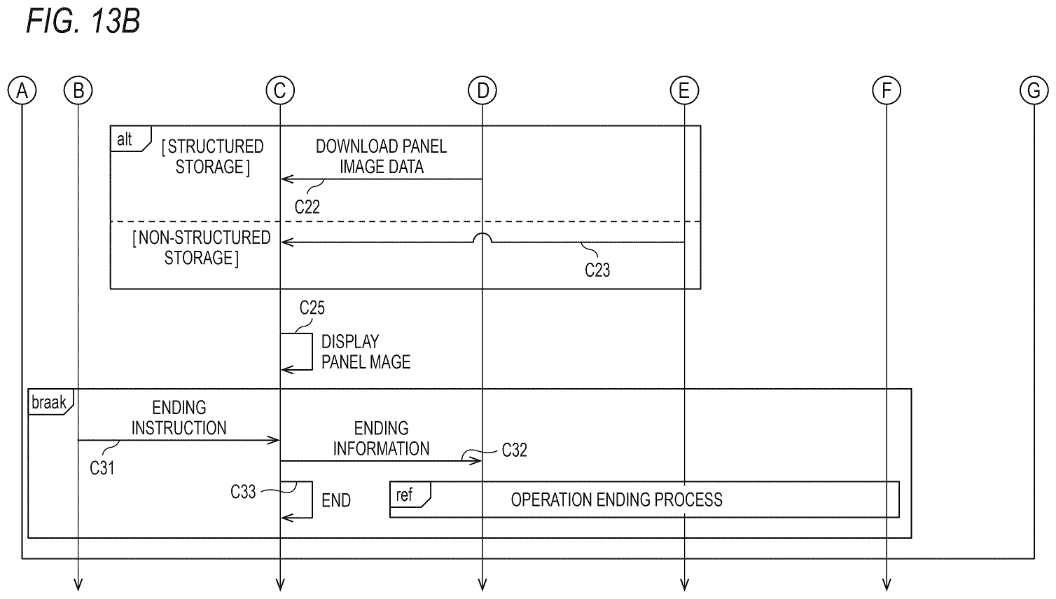

Next, a remote operation procedure which is an operation procedure after the cloud remote operation is started will be described with reference to a sequence diagram of FIGS. 13A and 13B. The remote operation procedure is executed in cooperation with the PC 5 and the MFP 1 after an image for virtually reproducing the user IF 13 of the MFP 1 is displayed on the user IF 53 of the PC 5, as illustrated in FIG. 12, based on B37 and B38 in FIG. 8B. In the PC 5, the browser 62 executes a browser image changing process based on the description of the browser P262 (see FIG. 9) included in the execution file 26 downloaded in B31 of FIG. 8A. Further, the MFP 1 executes a device image changing process based on the remote operation program 23.

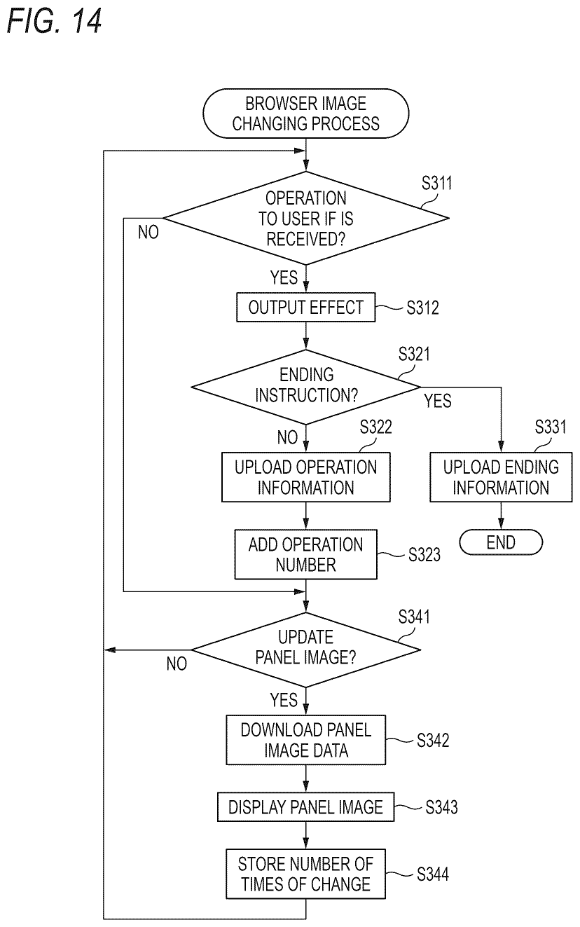

First, the procedure of the browser image changing process executed by the browser 62 will be described with reference to the flowchart of FIG. 14 and, if necessary, with reference to the sequence diagram of FIGS. 13A and 13B. During execution of the browser image changing process, the browser 62 periodically accesses the structured storage 202 (C03 in FIG. 13A), checks the record R22 (see FIG. 11A) in which the image information is stored, and repeats determination as to whether the number of times of change included in the parameter 2025 is updated from the number of times of change stored in the browser 62.

In the browser image changing process, the browser 62 determines whether an operation on one of the currently displayed panel image 531, the key images 532, and the ending button 533 on the user IF 53 is received (S311). If it is determined that the operation to the user IF 53 is received (S311: YES, C11 in FIG. 13A), the browser 62 outputs an effect (S312). Specifically, the browser 62 outputs an effect indicating that the operation has been received, by, for example, displaying a small animation or a still image indicated by a mark such as “O” indicating the operated position at an operation point for a short time, changing a display color of the operation point, and outputting an effect sound. By outputting the effect for the operation, the user who executes the operation to the user IF 53 can easily realize the operation.

When the browser 62 receives an operation on any one of a range of the panel image 531, a range indicating any one of the key images 532, and a range indicating the ending button 533 in the user IF 53 displaying the panel image 531 illustrated in FIG. 12, the browser 62 determines YES in S311. For example, when an operation to another position is received, the browser 62 may ignore the operation or may execute another process included in the browser 62.

The browser 62 determines whether the received instruction is an operation on the ending button 533, that is, an ending instruction of the cloud remote operation (S321). If it is determined that the received instruction is not the ending instruction of the cloud remote operation (S321: NO), the browser 62 uploads the operation information indicating the received operation to the structured storage 202 so as to be stored in a record indicating an operation content to be described later (S322, C12 in FIG. 13A). The browser 62 can upload the record in which the operation information is stored to the structured storage 202 using the structured access information 263 (see FIG. 9) included in the execution file 26 downloaded in B31 of FIG. 8A. S322 and C12 in FIG. 13A are examples of an operation upload process.

Further, the browser 62 adds the stored operation number (S323). The operation number is information indicating the operation order. The browser 62 stores the operation number as 1 at the start of the browser image changing process, that is, at the start of the remote operation procedure.

The operation information is information indicating the operation content of the operation received by the PC 5. For example, as illustrated in FIGS. 11A and 11B, the browser 62 uploads one of a plurality of types of records according to the operation. For example, as in records R31 to R34 and R41 illustrated in FIGS. 11A and 11B, information indicating operation information of the cloud remote operation is stored in the first key 2021 of the record in which the operation information is stored, and information indicating the operation number is stored in the second key 2022. For example, the browser 62 uploads the operation information to the structured storage 202 so that the operation information is stored in the record in which information corresponding to the stored operation number is stored in the second key.

For example, when the stored operation number is 1 and a click on an icon displayed at a position A of the panel image 531 is received, the browser 62 first uploads operation information corresponding to a pressing operation at a time when an operation of pressing a button or the like of a mouse of the click is received (S322). Specifically, the browser 62 uploads the operation information such that the device ID of the MFP 1 is stored in the device ID 2024 and information indicating an operation position and information indicating a downward operation (pressing operation) are stored in the parameter 2025 in the record R31 including information indicating the remote operation in the first key 2021 and the operation number 1 in the second key. The browser 62 adds 1 to the stored operation number and sets the operation number to 2 (S323). The parameters 2025 in the records R31 to R34 and R41 are examples of the first operation data indicating the operation content.

Next, at a time when an operation of releasing a finger from a button or the like of the click is received, information corresponding to the release operation is uploaded (S322). Specifically, the browser 62 uploads the operation information such that the device ID of the MFP 1 is stored in the device ID 2024 and information indicating the same operation position as the record R31 and information indicating an upward operation (release operation) are stored in the parameter 2025 in the record R32 including information indicating the remote operation in the first key 2021 and the operation number 2 in the second key. The browser 62 adds 1 to the stored operation number and sets the operation number to 3 (S323).

As described above, in the records R31 and R32, information indicating that the pressing operation and the release operation of the click are performed at the same operation position, a time stamp for the pressing operation, and a time stamp for the release operation are respectively stored. As described later, the MFP 1 downloads the operation information uploaded by the PC 5 and executes a process according to the downloaded operation information. At this time, for example, the MFP 1 can distinguish between the short press and the long press of the icon by comparing the time stamps 2023 stored in the records R31 and R32. The information indicating the operation position may be information indicating coordinates in the panel image 531 or the touch panel 131 of the corresponding MFP 1, or may be information for identifying the operated button or icon.

For example, when an operation on a key image indicating a return key which is one of the key images 532 is received as an operation when the stored operation number is 7, the browser 62 uploads the operation information such that the device ID of the MFP 1 is stored in the device ID 2024 and information indicating the return key is stored in the parameter 2025 in the record R41 including information indicating a remote operation in the first key 2021 and the operation number 7 in the second key (S322). The browser 62 adds 1 to the stored operation number and sets the operation number to 8 (S323).

In the case of the operation on the key image, the browser 62 uploads the operation information such that not the information indicating the operation direction but the information indicating the operated key is stored in the parameter 2025. The information indicating the key may be information for specifying one of the hard keys 132 of the MFP 1 corresponding to the key images 532 having received the operations, or information indicating the coordinates of the corresponding hard keys 132. In order to make it possible to distinguish between the short press and the long press in the operation on the hard key 132 of the MFP 1, the browser 62 may upload a plurality of pieces of operation information including the information indicating the operation direction in relation to the operation on the key image 532.

After S323 or if it is determined that the operation to the user IF 53 is not received (S311: NO), the browser 62 determines whether to update the currently displayed panel image 531 on the user IF 53 (S341). As described above, the browser 62 periodically accesses the structured storage 202 (C03 in FIG. 13A), and determines to update the panel image 531 when the number of times of change stored in the image information increases from the number of times of change stored in the browser 62.

Although details will be described later, a currently displayed image on the touch panel 131 of the MFP 1 may be changed according to a cloud remote operation from the PC 5 or a user operation to the MFP 1. When the currently displayed image on the touch panel 131 is changed, the MFP 1 uploads the image information to the structured storage 202 such that the updated image information is stored in the record R22 of FIG. 11A or a record of another pair of image information. The updated image information includes information on the number of times of change added by the MFP 1.

The number of times of change stored in the browser 62 is the number of times of change included in the image information used for displaying the currently displayed panel image 531 on the browser 62. That is, when the number of times of change that is increased from the stored number of times of change is stored in the image information, the panel image data corresponding to the image information is newer data than the panel image data used for displaying the currently displayed panel image 531 on the browser 62. The browser 62 stores the number of times of change as 1 at the start of the browser image changing process, that is, at the start of the remote operation procedure.

If it is determined that the panel image 531 is to be updated (S341: YES), the browser 62 acquires the panel image data (S342). Specifically, as illustrated in C21 to C23 in FIGS. 13A and 13B, the browser 62 first downloads the image information from the record R22 or a record of another pair of image information (C21), and downloads the panel image data from a record of the structured storage 202 or from the folder 2011 of the non-structured storage 201, based on the parameter of the image information (C22 or C23). C21 to C23 in FIGS. 13A and 13B are the same processes as B33 to B35 in FIG. 8B.

When there are three or more record pairs for storing information related to the panel image data, the browser 62 may download information related to the panel image data stored in a record in which the stored number of times of change is the largest. Alternatively, the browser 62 may download information related to the panel image data stored in a record in which the stored time stamp is the newest.

Further, the browser 62 displays the updated panel image 531 on the user IF 53, based on the downloaded panel image data (S343, C25 in FIG. 13B). When the content of the currently displayed screen on the touch panel 131 of the MFP 1 is changed, the panel image 531 displayed on the user IF 53 of the PC 5 is also changed in the same manner. Therefore, the screen of the MFP 1 and the screen of the PC 5 can be synchronized. An image to be changed is only the range of the panel image 531, and the browser 62 does not change the displayed key images 532 and the ending button 533. Further, the browser 62 stores the number of times of change included in the image information (S344).

That is, when an event occurs that changes the content of the currently displayed screen on the touch panel 131, the MFP 1 uploads the panel image data and updates the image information. When the image information is updated, the browser 62 downloads the panel image data and updates the panel image 531. Accordingly, an image displayed on the touch panel 131 of the MFP 1 can be synchronized with an image displayed on the user IF 53 of the PC 5.

When the display of the panel image 531 based on the information downloaded in C21 to C23 fails, the browser 62 maintains the display of the panel image 531 originally displayed. At this time, if it is necessary to maintain the display, the browser 62 may download the information downloaded at the previous B33 to B35 or C21 to C23 again.

After S344 or if it is determined that the panel image 531 is not to be updated (S341: NO), the browser 62 proceeds to S311, repeats the determination of whether an operation to the user IF 53 is received (S311) and the determination of whether the panel image 531 is to be updated (S341) (loop of FIGS. 13A and 13B).

On the other hand, if it is determined that the received instruction is the ending instruction of the cloud remote operation (S321: YES), that is, when an operation on the ending button 533 illustrated in FIG. 12 is received (C31 in FIG. 13B), the browser 62 uploads ending information to the structured storage 202 (S331, C32 in FIG. 13B). Specifically, for example, as illustrated in FIGS. 11A and 11B, the browser 62 uploads the ending information such that information indicating that the ending instruction of the cloud remote operation of the MFP 1 is received is stored in the parameter 2025 of a record R51 in which information indicating the operation information of the cloud remote operation is stored in the first key 2021 and information indicating the ending instruction is stored in the second key 2022. The ending information may be information indicating an operation on the ending button 533. S331 is an example of the operation upload process. Thereafter, the PC 5 ends the browser image changing process and ends the cloud remote operation of the MFP 1 (C33 in FIG. 13B, break).

After the cloud remote operation is ended, the MFP 1 does not upload the panel image data. The PC 5 may end the browser 62, may end the execution of the process according to the browser P262 and display another Web page, or may display a blank screen. The downloaded execution file 26 may be deleted when the browser 62 is ended or may be spontaneously deleted in response to the end of execution.

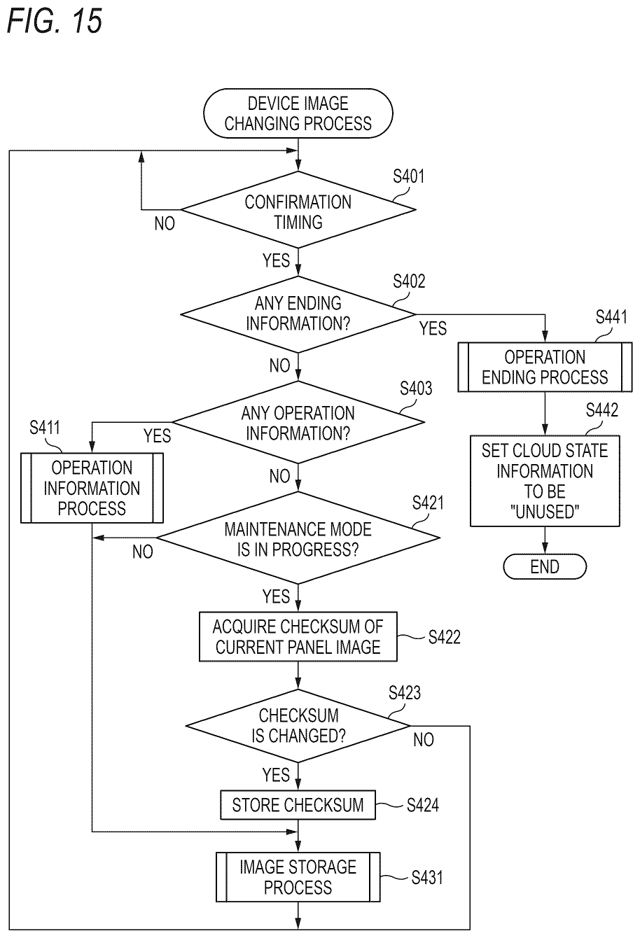

Next, a procedure of the device image changing process executed by the MFP 1 when the cloud remote operation is started will be described with reference to a flowchart of FIG. 15 and, if necessary, the sequence diagram of FIGS. 13A and 13B. As described above, the device image changing process is executed by the CPU 11 of the MFP 1 after uploading the execution file 26 and the image data and uploading the response data indicating “success” to the structured storage 202 (B11 to B17 in FIG. 8A).

In the device image changing process, the CPU 11 determines whether a periodic confirmation timing has come (S401). During execution of the cloud remote operation, the MFP 1 periodically accesses the structured storage 202 as with the browser 62 (C04 in FIG. 13A). If the periodic confirmation timing has not come (S401: NO), the CPU 11 repeats the determination in S401. A confirmation timing by the MFP 1 and a confirmation timing by the browser 62 may not be the same.

If it is determined that the periodic confirmation timing has come (S401: YES), the CPU 11 confirms whether the ending information including its own device ID is uploaded to the structured storage 202 (S402). If it is determined that the ending information is not uploaded (S402: NO), the CPU 11 determines whether the operation information including its own device ID is uploaded to the structured storage 202 (S403). When an operation by the user of the PC 5 is received, the operation information is uploaded to the structured storage 202 in the browser image changing process (S322 in FIG. 14, C12 in FIG. 13A) according to the above-described procedure.

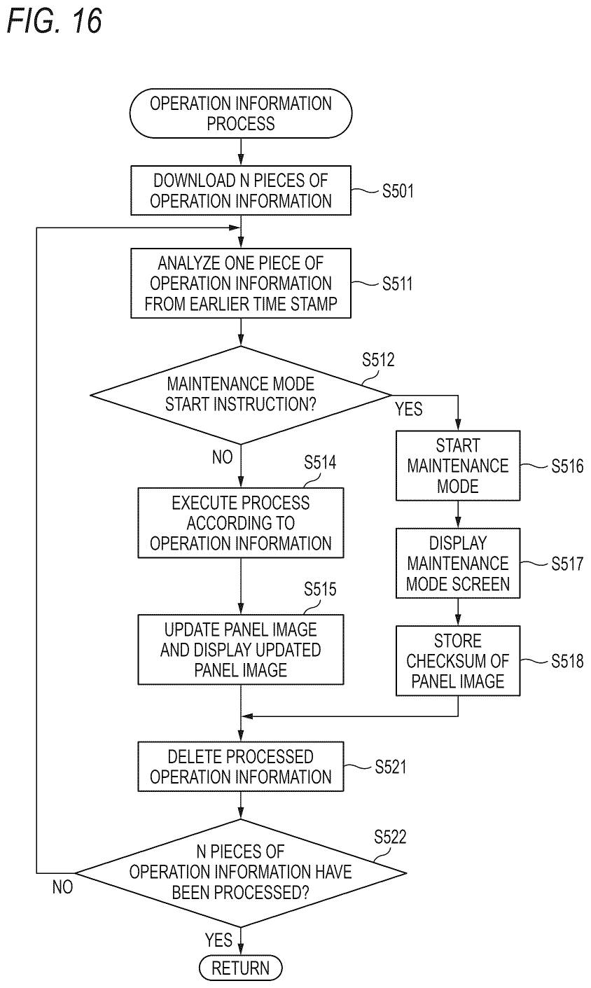

If it is determined that the operation information is uploaded to the structured storage 202 (S403: YES), the CPU 11 executes an operation information process (S411). A procedure of the operation information process will be described with reference to a flowchart of FIG. 16 and, if necessary, the sequence diagram of FIGS. 13A and 13B.

In the operation information process, the CPU 11 acquires up to N pieces of operation information uploaded to the structured storage 202 by downloading the N pieces of operation information (S501, C31 in FIG. 13B). N is an integer of, for example, 2 to 20, and is set in advance in the MFP 1. When the number of uploaded operation information is less than N, the CPU 11 acquires all the uploaded operation information. As described above, when a plurality of operations are received, the browser 62 stores one piece of operation information for each operation. For example, when a click on an icon is received, two consecutive pieces of operation information are stored. Since the MFP 1 collectively acquires a certain number of pieces of operation information, the number of accesses to the cloud storage service 200 does not increase.

The CPU 11 processes the downloaded operation information in chronological order, based on the operation number or the time stamp. The CPU 11 first analyzes the first operation information (S511), and determines whether the operation is a start instruction of a maintenance mode (S512). If it is determined that the operation is not the start instruction of the maintenance mode (S512: NO), the CPU 11 executes a process according to the operation information (S514, C32 in FIG. 13B). By processing the downloaded operation information in chronological order, the MFP 1 can execute a process in accordance with a procedure operated by the PC 5.

As described above, the MFP 1 can display a screen including one or more icon images on the touch panel 131. When the MFP 1 receives an operation in an area of a currently displayed icon image, the MFP 1 can execute a process indicated by the icon image. For example, if the operated icon image is an icon indicating an execution instruction of an image process, the MFP 1 executes the instructed image process. The panel image 531 for virtually reproducing the touch panel 131 is displayed on the user IF 53 of the PC 5. When the downloaded operation information is information indicating an operation on the panel image 531, the CPU 11 executes a process corresponding to the operation as in a case where an operation on the touch panel 131 is received.

For example, when the operation information is information indicating an operation on the copy icon included in the panel image 531 obtained by virtualization of a standby screen of the MFP 1, the CPU 11 acquires information for displaying the setting screen of the copy process. When the operation information is information indicating an operation related to a setting change on the panel image 531 obtained by virtualization of the setting screen of the copy process, the CPU 11 changes the setting of the copy process. When the operation information is information indicating an operation on an icon indicating an instruction to execute the image forming process, the CPU 11 starts execution of the image forming process as a process corresponding to the operation. For example, when the operation information is information indicating an operation on an icon for instructing execution of the copy process on the panel image 531 obtained by virtualization of the setting screen of the copy process, execution of the copy process is started.

When the operation information is information indicating a key operation, the CPU 11 executes a process corresponding to the operation as in the case of receiving an operation on the hard keys 132. In response to the execution of the process, the CPU 11 changes the panel image and displays the changed panel image on the touch panel 131 (S515).

For example, when the information for displaying the setting screen of the copy process is acquired, the CPU 11 displays a setting screen including an icon for instructing a setting change, an input field of a setting value to be changed, an icon for instructing execution of the copy process, and the like. After the setting of the copy process is changed, the CPU 11 displays a setting screen of the copy process updated to indicate the changed setting. After the setting of the copy process is changed, the CPU 11 may display the standby screen. After the execution of the image forming process is started, the CPU 11 displays an execution screen of the image forming process, for example, an execution screen of the copy process.

On the other hand, if it is determined that the operation is the start instruction of the maintenance mode (S512: YES), the CPU 11 starts the maintenance mode (S516). The maintenance mode is, for example, a mode performed by a maintenance person for maintenance of the MFP 1, and is, for example, a mode in which a print instruction of a report or an operation status confirmation instruction can be received. The MFP 1 can receive the start instruction of the maintenance mode by, for example, a combination of specific operations on a specific key.

Upon receiving the start instruction of the maintenance mode, the MFP 1 displays a dedicated maintenance mode screen, which is a screen for receiving an instruction executable in the maintenance mode, on the touch panel 131 (S517). The CPU 11 calculates a checksum of the displayed maintenance mode screen and stores the checksum in the memory 12 (S518).

In the maintenance mode, the MFP 1 displays a maintenance mode screen, and can receive only an execution instruction of the maintenance mode in which the type of the maintenance mode is specified by a number. In the maintenance mode, the MFP 1 does not receive a print instruction from an external device, for example. The screen data of the maintenance mode screen is, for example, bitmap data, and the screen ID is not set. Therefore, the CPU 11 uses a checksum for determining whether the screen is changed.

The screen ID may also be set on the maintenance mode screen. In this case, instead of calculating the checksum, the MFP 1 may store the screen ID in S518. In addition to the maintenance mode screen, a screen whose screen ID is not set may be provided. In this case, when a screen whose screen ID is not set is displayed, the MFP 1 may also calculate and store a checksum.

After S515 or S518, the CPU 11 deletes the processed operation information from the structured storage 202 (S521). Then, the CPU 11 determines whether the N pieces of operation information acquired in S511 have been processed (S522). If it is determined that the N pieces of operation information has not been processed (S522: NO), the CPU 11 proceeds to S511 and processes the next one piece of operation information. If it is determined that all of the N pieces of operation information have been processed (S522: YES), the CPU 11 ends the operation information process and returns to the device image changing process in FIG. 15. Instead of deleting the N pieces of operation information one by one in S521, the CPU 11 may collectively delete the N pieces of operation information after the N pieces of operation information have been processed (YES in S522).

Returning to the description of the device image changing process in FIG. 15. After the operation information process of S411, the CPU 11 executes the image storage process (S431). The image storage process is a process illustrated in FIG. 10, and is a process of uploading panel image data indicating the current panel image to the cloud storage service 200.

Accordingly, as illustrated in C33 to C35 in FIG. 13B, the panel image data is uploaded to the structured storage 202 and the non-structured storage 201, and the image information is uploaded to the structured storage 202. C33 to C35 in FIG. 13B are the same processes as B13 to B15 in FIG. 8A. The information uploaded in C33 to C35 is downloaded by the browser 62 in C21 to C23 as described above, and is processed by the browser 62.

For example, when the process is executed based on the acquired operation information, the MFP 1 may change the currently displayed screen on the touch panel 131. In the operation information process in S411, for example, when the panel image displayed on the touch panel 131 is updated (S515) or when the maintenance mode is started and the maintenance mode screen is displayed (S517), the MFP 1 uploads the panel image data and the image information by executing the image storage process.

As a result, after uploading the operation information indicating the operation on the panel image 531, the browser 62 can download new panel image data and update and display the panel image 531 in response to the MFP 1 that has executed a process according to the operation information updating the image information. Accordingly, when the screen displayed on the touch panel 131 of the MFP 1 is changed, an image indicating the changed screen is displayed on the user IF 53 of the PC 5. Thus, the screen of the MFP 1 and the screen of the PC 5 can be synchronized. After the image storage process of S431, the CPU 11 returns to S401 and determines whether the next confirmation timing has come.

On the other hand, if it is determined that the operation information is not stored (S403: NO), the CPU 11 determines whether the maintenance mode is in progress (S421). If it is determined that the maintenance mode is not in progress (S421: NO), the CPU 11 executes the image storage process (S431). The MFP 1 may change the currently displayed screen on the touch panel 131 in addition to a case where the process is executed based on the acquired operation information, such as a case where an operation on the user IF 13 is received. When the cloud remote operation is performed, if the maintenance mode is not in progress, the MFP 1 uploads the panel image data and the image information by executing the image storage process.

That is, the MFP 1 repeatedly uploads the panel image data indicating the currently displayed screen on the touch panel 131. When the currently displayed screen is changed, the changed panel image data and image information are uploaded in the image storage process immediately thereafter. As a result, even if the currently displayed screen on the touch panel 131 is changed without being triggered by an operation on the panel image 531, for example, by the operation on the user IF 13 of the MFP 1, the browser 62 can download new panel image data and update and display the panel image 531 in response to the MFP 1 updating the image information. Thus, the screen of the MFP 1 and the screen of the PC 5 can be synchronized. After the image storage process of S431, the CPU 11 returns to S401 and determines whether the next confirmation timing has come.

On the other hand, if it is determined that the maintenance mode is in progress (S421: YES), the CPU 11 acquires a checksum of the currently displayed panel image (S422). When a start instruction of the maintenance mode is received and the maintenance mode is started (S516 in FIG. 16), the MFP 1 is in the maintenance mode. The CPU 11 compares the acquired checksum with the stored checksum to determine whether the checksum is changed (S423). For example, the CPU 11 compares the checksum stored in S518 of the operation information process (FIG. 16) when the maintenance mode is started, and determines whether the check sum is changed. If it is determined that the checksum is changed (S423: YES), the CPU 11 stores the checksum of the current panel image (S424), and executes the image storage process (S431). In the image storage process, the changed panel image data and the image information are uploaded. In next S423, the CPU 11 compares the checksum stored in S424 and the checksum of the currently displayed panel image. After the image storage process of S431, the CPU 11 returns to S401 and determines whether the next confirmation timing has come.

In the maintenance mode, if it is determined that the checksum is not changed (S423: NO), the CPU 11 returns to S401 and determines whether the next confirmation timing has come. In the maintenance mode, when the checksum is not changed, the CPU 11 does not execute the image storage process.

As described above, the MFP 1 determines whether the currently displayed screen is changed in the maintenance mode. Since the panel image data is not uploaded when the screen is not changed, an amount of communication traffic is reduced. The MFP 1 may determine whether the currently displayed screen is changed even when the maintenance mode is not in progress, and may not upload the panel image data when the screen is not changed. For example, the MFP 1 may determine whether the screen is changed based on the screen ID of the currently displayed screen. If the panel image data is not uploaded when the screen is not changed, a communication load is small.

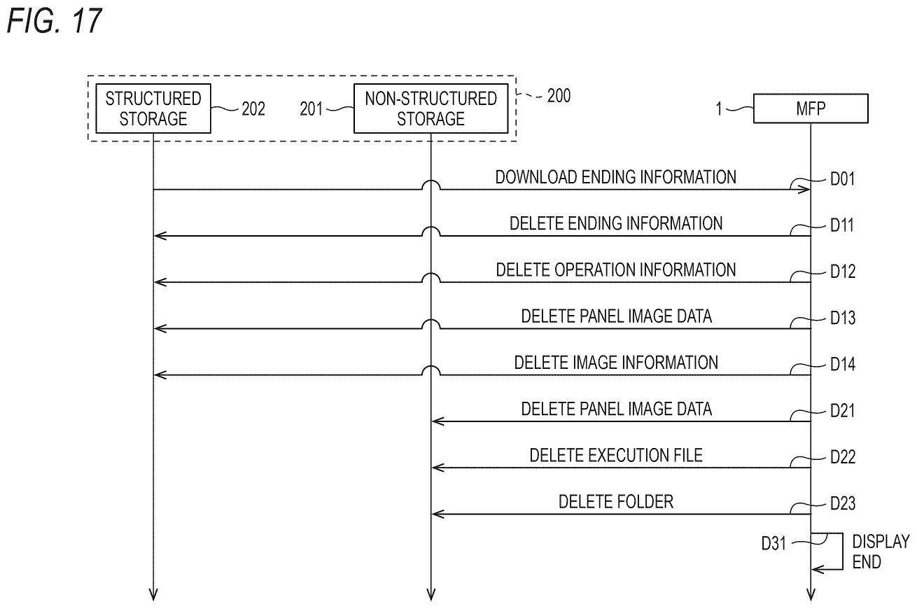

If it is determined that the ending information is uploaded (S402: YES), the CPU 11 executes an operation ending process (S441). Further, the CPU 11 changes the cloud state information 81 (see FIG. 3) to the information indicating “unused” (S442). S402 is an example of an ending condition of the first remote operation, and when the ending information is stored (YES in S402), the CPU 11 determines that the ending condition of the first remote operation is satisfied. When the ending information is uploaded, the CPU 11 does not download the operation information even if the operation information not downloaded is uploaded. A procedure of the operation ending process will be described with reference to a sequence diagram of FIG. 17.

The MFP 1 downloads the ending information from the structured storage 202 (D01). As described above, the ending information is information stored in the structured storage 202 by the browser 62 in C32 of FIG. 13B. The ending information includes, for example, as illustrated in the record R51 of FIG. 11B, information indicating that the ending instruction is received in C31 of FIG. 13B.

By downloading the ending information, the MFP 1 deletes the various kinds of information uploaded to the structured storage 202 or the non-structured storage 201. Specifically, the MFP 1 instructs the structured storage 202 to delete the stored ending information of the current cloud remote operation (D11). The MFP 1 instructs the structured storage 202 to delete the operation information of the current cloud remote operation stored (D12). Upon receiving the ending instruction, the MFP 1 deletes all the unprocessed operation information.

Further, the MFP 1 instructs the structured storage 202 to delete the uploaded panel image data and the image information (D13 and D14). If there is panel image data uploaded to the non-structured storage 201, the MFP 1 instructs deletion of the panel image data (D21). When the ending instruction is received by the PC 5, various kinds of data uploaded to the structured storage 202 or the non-structured storage 201 are deleted. Therefore, a load on the memory of the structured storage 202 or the non-structured storage 201 can be reduced.

Further, the MFP 1 instructs deletion of the execution file 26 uploaded to the non-structured storage 201 at the start of the cloud remote operation (D22). Further, the MFP 1 instructs deletion of the folder created in A32 of FIG. 4A (D23). The order of deleting the data is not limited to the above order, and may be any order.

When all the data is deleted, the MFP 1 displays the end of the cloud remote operation on the touch panel 131 (D31), and ends the cloud remote operation. When the local remote operation is received in parallel with the cloud remote operation, the MFP 1 follows the local remote operation if the local remote operation is not ended. When the local remote operation is not received, the MFP 1 displays a standby screen on the touch panel 131, for example, and can receive a user operation.

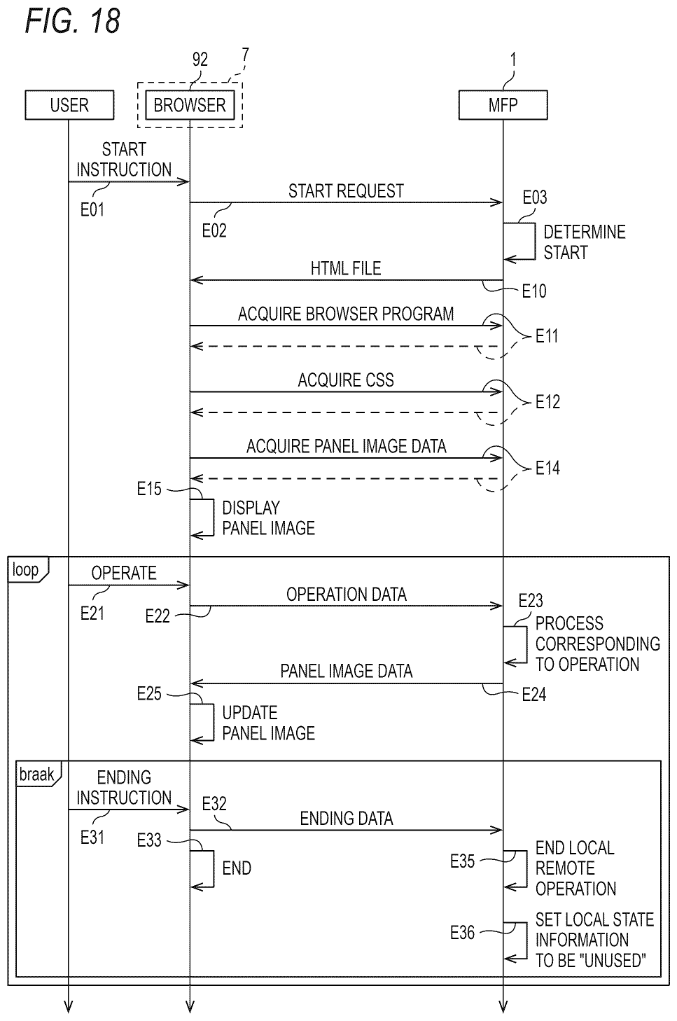

Next, a local operation procedure which is a process when a start request for the local remote operation is received will be described with reference to a sequence diagram of FIG. 18. The user of the PC 7 capable of local communication with the MFP 1 activates the browser 92 in the PC 7, specifies address information indicating the EWS 80 of the MFP 1, and issues a start instruction of the local remote operation (E01). The browser 92 accesses the MFP 1 according to the local communication based on the specified address information, and transmits a start request for the local remote operation (E02).

When the MFP 1 receives the start request for the local remote operation, the MFP 1 executes the same process as the start determination process illustrated in FIGS. 6A and 6B (for convenience, a process referred to as the local start determination process) (E03), and determines whether to start the local remote operation. In a case where both remote operations are simultaneously performed, the MFP 1 may display on each PC or the touch panel 131 that remote operations by other PCs are being simultaneously provided. When it is determined not to start the local remote operation, the MFP 1 returns information indicating that the local remote control cannot be started, and ends the procedure in FIG. 18.

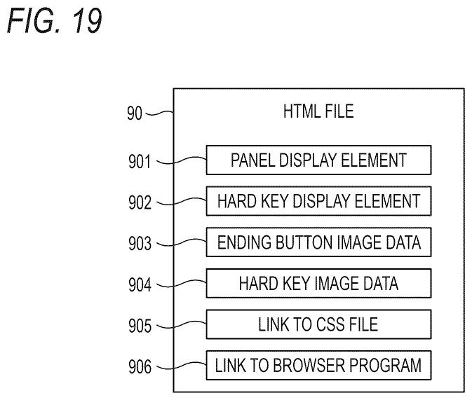

When it is determined to start the local remote operation, the MFP 1 transmits an HTML file indicating a Web page for the local remote operation to the PC 7 in response to the start request for the local remote operation received in E02 (E10). As illustrated in FIG. 19, the HTML file includes, for example, a panel display element 901, a hard key display element 902, ending button image data 903, hard key image data 904, a link 905 to a CSS file, and a link 906 to a browser program 84 (see FIG. 3). A HTML file 90 is stored in, for example, the memory 12 (see FIG. 1). The MFP 1 may dynamically generate the HTML file 90.

The panel display element 901, the hard key display element 902, and the hard key image data 904 are the same information as the panel display element 266, the hard key display element 267, and the hard key image data 264 (see FIG. 9) included in the execution file 26 used in the cloud remote operation. The data may be exactly the same as or partially different from the information included in the execution file 26.

As described above, when it is determined to start the local remote control in response to the start request for the local remote operation, the MFP 1 sets the local state information 82 as information indicating “in use”. In the local remote operation, the MFP 1 can transfer various kinds of information to the browser 92 of the PC 7 via local communication not via the cloud storage service 200.

The browser 92 acquires the browser program 84 and the CSS file from the MFP 1 based on the link described in the acquired HTML file 90 (E11 to E12). The browser program 84 is a program that can be operated by the browser 92, and is a program that is similar to the browser P262 (see FIG. 9) of the cloud remote operation, and is partially different program. Differences will be described in detail later. The browser program 84 is an example of a second remote operation program. E11 is an example of a program reply process.

The CSS file is the same information as the CSS 261 (see FIG. 9) included in the execution file 26 (see FIG. 9) used in the cloud remote operation. The CSS may be exactly the same as or partially different from the CSS 261 included in the execution file 26. For example, the CSS of the local remote operation may indicate a display content in which a display color, a frame shape, and the like of the CSS of the local remote operation are slightly different from those of the CSS of the cloud remote operation.

The HTML file 90 may include a link to the hard key image data instead of the hard key image data 904. In this case, similarly to the browser program 84 and the CSS file (E11 to E12), the browser 92 may acquire the hard key image data 904 from the MFP 1 based on the link.

Instead of the HTML file 90 illustrated in FIG. 19, the MFP 1 may pass the HTML file in which the CSS and the browser program 84 are embedded, to the browser 92, as in the execution file 26 (see FIG. 9) used in the cloud remote operation. Further, the hard key image data may be incorporated into the browser program 84. For the ending button image data, the HTML file may include an ending button display element, and the ending button image data may be incorporated into the browser program 84.

The browser 92 acquires panel image data from the MFP 1 (E14), and displays the panel image on the user IF 93 of the PC 7 based on the acquired panel image data (E15). The panel image data acquired from the MFP 1 at E14 is data for virtually reproducing the currently displayed screen on the touch panel 131 of the MFP 1. For example, bitmap data and PNG data obtained by compressing bitmap data. E14 is an example of an image transmission process, and panel image data transmitted by the MFP 1 in E14 is an example of second image data. E15 is an example of a local screen display process, and the panel image displayed on the PC 7 in E15 is an example of a second remote operation screen.

Accordingly, a panel image for virtually reproducing the user IF 13 of the MFP 1 is displayed on the user IF 93 of the PC 7 as in the example illustrated in FIG. 12. The panel image displayed on the user IF 93 of the PC 7 includes an ending button similarly to the panel image 531 displayed on the user IF 53 of the PC 5. As in the case of the cloud remote operation, the MFP 1 may transmit panel image data not including a moving image or an animation.

For example, when it is determined to start the local remote operation while the cloud remote operation is being provided, the MFP 1 provides both the local remote operation by the PC 7 and the cloud remote operation by the PC 5. Also in this case, in the procedure of E11 to E14, the panel image data transmitted to the PC 7 performing the local remote operation is image data indicating a screen that virtually reproduces the currently displayed screen on the touch panel 131 of the MFP 1.

On the other hand, as described above, for example, in B33 to B37 in FIG. 8B and C21 to C25 in FIGS. 13A and 13B, a screen in which the currently displayed screen on the touch panel 131 of the MFP 1 is virtually reproduced is also displayed on the user IF 53 of the PC 5 who performs the cloud remote operation. That is, a screen displayed on the user IF 93 of the PC 7 is equivalent to a screen displayed on the user IF 53 of the PC 5. The panel image data transmitted from the MFP 1 to the PC 7 in E14 is an example of image data for reproducing a screen configuration equivalent to that of the panel image displayed on the PC 5. Accordingly, the user of the PC 5 and the user of the PC 7 can view the same screen, and the convenience is high. An effect may not be output to the screen displayed on the user IF 93 of the PC 7.

The user who uses the PC 7 can perform an operation on the user IF 93 on which the panel image is displayed (E21). When the browser 92 receives an operation on the panel image being displayed, if the user operation is not an operation on the ending button, the browser 92 transmits operation data indicating the operation content to the MFP 1 via the local communication (E22). The operation data transmitted in E22 is an example of second operation data, and E22 is an example of an operation transmission process.

The MFP 1 executes a process corresponding to the operation content based on the received operation data (E23). When the currently displayed screen on the touch panel 131 is updated by the process of E23, the MFP 1 transmits panel image data indicating the updated screen to the PC 7 (E24). E24 is an example of the image transmission process. The browser 92 of the PC 7 updates the panel image based on the received panel image data (E25). The browser 92 repeats E21 to E25 each time the user operation is received (loop).

In a state where the MFP 1 simultaneously provides the local remote operation to the PC 7 and the cloud remote operation to the PC 5, the MFP 1 can acquire both the operation data transmitted from the PC 7 and the operation information uploaded by the PC 5. Further, the MFP 1 executes a process corresponding to the operation content for information received by any remote operation. For example, when the panel image is updated based on the operation information uploaded by the PC 5 in C12 of FIG. 13A, or when the panel image is updated based on the operation data received from the PC 7 in E22, the MFP 1 passes the updated panel image data to the PC 5 and the PC 7. That is, the MFP 1 uploads the updated panel image data in C33 to C35 of FIG. 13B and transmits the panel image data to the PC 7 in E24. Accordingly, the user of the PC 5 and the user of the PC 7 can confirm the operation of the MFP 1.

When an operation on the ending button is received (E31), the browser 92 stops the repetition of E21 to E25 (break), and transmits ending data indicating the ending instruction to the MFP 1 (E32). The PC 7 ends the local remote operation (E33). The PC 7 may end the browser 92.

Upon receiving the ending data, the MFP 1 ends the provision of the local remote operation (E35). The MFP 1 may display, for example, the end of the local remote operation. Upon receiving the ending data of the local remote operation from the PC that is providing the local remote operation, the MFP 1 determines that the ending condition of the second remote operation is satisfied. The MFP 1 ends the local remote operation and changes the local state information 82 to the information indicating “unused” (E36).

As described above, the MFP 1 can simultaneously receive the local remote operation and the cloud remote operation. For example, when the start instruction of the local remote operation is received from the PC 7 in a state where the cloud remote operation by the PC 5 is received, the MFP 1 executes E03. The cloud remote operation via the cloud storage service 200 is assumed to be used from a remote place, for example, in order for a supporter who is familiar with an operation of the MFP 1 to teach the operation to a user who is unfamiliar with the operation of the MFP 1. Since the MFP 1 can simultaneously receive both remote operations, the MFP 1 can cope with various usage modes.

As described above in detail, according to the remote operation system 100, the MFP 1 can simultaneously provide a cloud remote operation using the cloud storage service 200 and a local remote operation using the local communication. That is, when a start instruction of the other remote operation is received in a state where the one remote operation is provided, the MFP 1 can provide the other remote operation. The cloud remote operation and the local remote operation are different in function, and it is assumed that positions of persons who perform the cloud remote operation and the local remote operation are different. Since the cloud remote operation and the local remote operation can be performed simultaneously, remote operation of the MFP 1 can be performed simultaneously by the PC 5 and the PC 7, and convenience of the MFP 1 is improved.

In many cases, communication between different networks has a problem in safety, and communication is often restricted. Therefore, the PC 5 may not directly transfer data necessary for remote operation to the MFP 1 which is not in the same network. As in the present invention, by transferring data between the PC 5 and the MFP 1 using the cloud storage service 200 on the Internet, the communication is less likely to be restricted, and there is a higher possibility that the remote operation for the MFP 1 not in the same network can be realized.

The present embodiment is merely an example, and does not limit the present invention. Therefore, various improvements and modifications can be naturally made to the technique disclosed in the present specification without departing from the gist of the present invention. For example, a device to be subjected to the local remote operation or the cloud remote operation may be a device having a communication IF and connectable to the Internet and having an image processing function. The device is not limited to an MFP, and may also be a single-function printer, a copy device, a scanner, a FAX device, or a machine tool capable of executing a machining process based on an image. The device that performs the local remote operation or the cloud remote operation is not limited to a PC, and may be a mobile terminal such as a smartphone or a tablet computer. Furthermore, the remote operation system 100 may include one or more devices that perform remote operation and one or more devices that are subjected to the remote operation, and the number and arrangement of these devices are not limited to the illustrated example.

A configuration of the user IF 13 of the MFP 1 is not limited to a configuration illustrated in the embodiment. For example, the MFP 1 may have a screen having only a display function instead of the touch panel 131, and may be configured to receive an operation input by a cursor operation or the like. The number of hard keys 132 is not limited to three, or may be zero.

For example, the MFP 1 may be capable of receiving a local remote operation from a PC that performs a cloud remote operation and the same PC. For example, a PC capable of communicating with the MFP 1 via the LAN may receive a start instruction of the cloud remote operation by the start application 63, and may further perform a local remote operation via the EWS 80. In this case, one browser of the PC may display a plurality of web pages to perform both remote operations, or the browsers may be activated in different processes to perform remote operations on the browsers. In this case, the PC is an example of the first information processing device or an example of the second information processing device.

In the embodiment, the MFP 1 does not receive a cloud remote operation by two or more PCs and a local remote operation by two or more PCs. Alternatively, the MFP 1 may receive the cloud remote operation by two or more PCs and the local remote operation by two or more PCs.

For example, in the embodiment, when the start request for the remote operation is received, the use permission confirmation screen 71 is displayed and the approval of the user is obtained. This procedure may be omitted. For example, in a state where one of the cloud remote operation and the local remote operation is being used, the other of the cloud remote operation and the local remote operation is started without obtaining the approval of the user. In this case, the approval of the user may be obtained.

For example, when the selection state information 83 is information indicating “rejected”, the MFP 1 may or may not automatically change the selection state information 83 to “approval” after a predetermined period. For example, the MFP 1 may continue storing the information indicating “rejected” until the power is turned off, or may delete the information according to the user operation. A deletion procedure may be different between a case where the cloud remote operation is rejected and a case where the local remote operation is rejected.

In the embodiment, the PC 5 uploads the record including the instruction data to the structured storage 202, and the MFP 1 acquires the instruction data by downloading the instruction data, but the present invention is not limited thereto. For example, the PC 5 may directly transmit the instruction data to the MFP 1. The MFP 1 may directly transmit the response data to the PC 5.

In the embodiment, the MFP 1 uploads the response data including the host folder access information 243 to the structured storage 202, thereby passing the URL to the PC 5. However, the present invention is not limited thereto. For example, the start application 63 of the PC 5 may hold in advance a URL indicating a folder used by the MFP to be subjected to the cloud remote operation.

Further, in the embodiment, the MFP 1 determines that the image information includes information indicating the structured storage 202 or the non-structured storage 201 as information indicating the storage location of the panel image data, but the present disclosure is not limited thereto. For example, the information indicating the storage location may be information included only when the panel image data is uploaded to the structured storage 202, or may be information included only when the panel image data is uploaded to the non-structured storage 201.

Further, in the embodiment, although it has been described that an operation on the ending button 533 (see FIG. 12) displayed on the PC or the like is received as a trigger to end the local remote operation or the cloud remote operation, the present disclosure is not limited thereto. For example, when the PC 5 or the PC 7 is executing the remote operation and does not receive the operation to the browser 62 for a predetermined period, the PC 5 or the PC 7 may upload or transmit the ending information and end the remote operation as in the case of receiving the ending instruction. For example, when the MFP 1 receives a specific operation, for example, when the MFP 1 receives a long press of a cancel button, the remote operation may be ended. Further, when new operation information is not uploaded for a predetermined time, the MFP 1 may determine that the ending instruction is received. In this case, the MFP 1 may upload the information indicating the ending instruction to the structured storage 202.

In the embodiment, although an example has been described in which one token is acquired for each of the non-structured storage 201 and the structured storage 202, a plurality of tokens may be acquired for one area. In this case, for example, a plurality of tokens may be stored as the access information 24 of the MFP 1, and one of tokens may be used by itself and the other may be passed to the PC 5. For example, different tokens may be used for uploading and downloading. Different tokens may be used for MFPs.

In any flowchart or sequence diagram disclosed in the embodiment, an execution order of a plurality of processes in any plurality of steps can be freely changed or can be executed in parallel within a range in which no contradiction occurs in a processing content.

The processes disclosed in the embodiment may be executed by hardware such as a single CPU, a plurality of CPUs, and an ASIC, or a combination thereof. In addition, the processes disclosed in the embodiment can be implemented in various modes such as a recording medium in which a program for executing the processes is recorded, or a method.

A binary storage 201 is an example of a first cloud storage, and is an example of a non-structured data storage cloud storage. The structured storage 202 is an example of a second cloud storage, and is an example of a structured data storage cloud storage in which a structured data storage area is provided. B11 is an example of a program upload process. The currently displayed screen on the touch panel 131 is an example of a main body operation screen and an example of a main body panel screen. Among the image information, the information indicating the storage location of panel image data, such as information indicating the binary storage 201, is an example of location data. The divided panel image data is an example of divided data. The access information included in the response data is an example of the first access information. B31 is an example of a program download process. The “ending” button 533 is an example of an ending button. S312 is an example of an effect output process. The records R31 to R34 and R41 are examples of operation records, and the parameter 2025 of each operation record is an example of operation data. S331 is an example of the operation upload process. D12 to D14 and D21 are examples of a deletion process.

The start application 63 is an example of a start program. The non-structured storage 201 is an example of a first cloud storage, and is an example of a non-structured data storage cloud storage. The structured storage 202 is an example of a second cloud storage, and is an example of a structured data storage cloud storage in which a structured data storage area is provided. The password 252 is an example of a first password. The password input in A01 is an example of a second password. A11 is an example of an instruction transmission process. The access information 631 is an example of the second access information. The record R1 illustrated in FIG. 4A is an example of an instruction record. B11 is an example of a program upload process. The structured access information 263 is an example of the second access information. The currently displayed screen on the touch panel 131 is an example of a main body operation screen and is an example of a main body panel screen.

The record R21 is an example of an image record. The record R1 illustrated in FIG. 5C is an example of a response record. For convenience, the data included in the response record may be an example of instruction data. The access information stored in the additional information 2027 of the response data is an example of the first access information. B22 is an example of a browser activation process. B31 is an example of a program download process. The record R1 illustrated in FIG. 5D is an example of a response record. The records R31 to R34 and R41 are examples of operation records. The parameters 2025 in the records R31 to R34 and R41 are examples of operation data.

The structured access information 263 is an example of the second access information. The currently displayed screen on the touch panel 131 is an example of a main body operation screen, and is an example of a main body panel screen. A screen excluding a moving image from the currently displayed screen is an example of a no-moving-image main body operation screen, and the panel image data not including a moving image is an example of no-moving-image image data. The parameters 2025 in the records R31 to R34 and R41 are examples of operation data. The maintenance mode is an example of a special mode, and is an example of a mode for maintenance. The maintenance mode screen is an example of a main body operation screen corresponding to the special mode. The checksum is an example of a check numerical value. S518 is an example of a calculation process.

The binary storage 201 is an example of a first cloud storage, and the structured storage 202 is an example of a second cloud storage. In the binary storage 201, a folder whose folder name includes its own device ID is an example of a storage area for the image forming device. The CSS 261 is an example of layout information. B11 is an example of a file upload process. The structured access information 263 is an example of the second access information. The hard key image data 264 is an example of the key image data. The currently displayed screen on the touch panel 131 is an example of a main body operation screen, and is an example of a main body panel screen. Among the image information, the information indicating the storage location of panel image data, such as information indicating the binary storage 201, is an example of location data. The access information included in the response data is an example of the first access information. B31 is an example of a file download process. The parameters 2025 in the records R31 to R34 and R41 are examples of operation data.

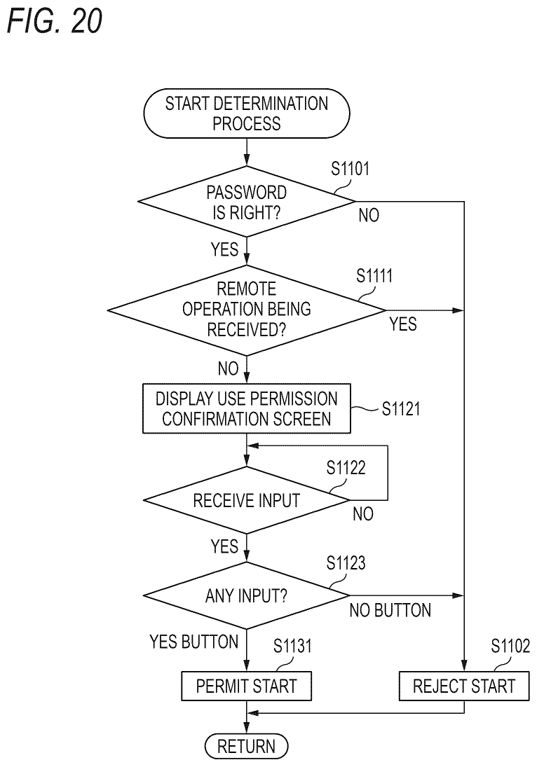

A modification of the start determination process will be described with reference to a flowchart of FIG. 20. This start determination process is executed by the CPU 11 of the MFP 1 based on the remote operation program 23 when the information indicating the start instruction of the cloud remote operation is acquired.

In the start determination process, the CPU 11 collates a password stored in the downloaded record R1 with the password 252 of the identification information 25 stored in the memory 12, and determines whether the password is correct, for example, whether two passwords correspond to each other (step S1101 of FIG. 20). S1101 of FIG. 20 corresponds to S101 of FIG. 6A. The expression “two passwords correspond to each other” may specifically mean that the two passwords match. If it is determined that the password is not correct (step S1101 of FIG. 20: NO), the CPU 11 determines not to start the start instruction of the current cloud remote operation (S1102 of FIG. 20). S1102 of FIG. 20 corresponds to S116, S117, and S102 of FIG. 6B.

The password 252 may be a password necessary for local operation of the MFP 1. For example, when the user of the branch office needs to log in to the MFP 1 in order to operate the MFP 1, the password 252 may be a password that needs to be input via the user IF 13 in order to log in to the MFP 1. The password 252 may be a password for starting the cloud remote operation and may be different from the password used when the MFP 1 is used.

With respect to the password necessary for local operation of the MFP 1, the MFP 1 may enter an account-locked state when the local log-in authentication involving the password input fails a predetermined number of times or more. When the MFP 1 enters an account-locked state, the CPU 11 may determine NO in S1101 of FIG. 20 without collating the password stored in the record R1 with the password 252. When the determination in S1101 of FIG. 20 that the password is not correct is repeated a predetermined number of times or more, the CPU 11 may set the MFP 1 in the account-locked state. The MFP 1 may automatically cancel the account-locked state with a predetermined trigger after a predetermined time elapses or the like.

As described above, in the remote operation system 100, the password 252 for providing the cloud remote operation is stored in the MFP 1, and the MFP 1 performs authentication using the password 252. Therefore, the safety of the cloud remote operation is high.

If it is determined that the password is correct (S1101 of FIG. 20: YES), the CPU 11 determines whether a cloud remote operation from another PC or the like is received (S1111 of FIG. 20). S1111 of FIG. 20 corresponds to S106 of FIG. 6A. The MFP 1 does not simultaneously receive cloud remote operations from a plurality of PCs. If a start instruction of the cloud remote operation from another PC has already been received and the cloud remote operation is in a providing state of being received by the PC (S1111 of FIG. 20: YES), the CPU 11 determines not to start the operation in response to the start instruction of the current cloud remote operation (S1102 of FIG. 20). If cloud remote operations from a plurality of external devices are simultaneously received, confusion may be caused. In a providing state where a cloud remote operation from another device has already been received, the MFP 1 does not start a further cloud remote operation, and thus the operation is unlikely to be confused. The determination in S1101 of FIG. 20 and the determination in S1111 of FIG. 20 may be reversed.

If the cloud remote operation is not being executed (S1111 of FIG. 20: NO), the CPU 11 displays a use permission confirmation screen on the touch panel 131 of the user IF 13 (S1121 of FIG. 20). S1121 of FIG. 20 corresponds to S114 of FIG. 6A. For example, as illustrated in FIG. 20, the CPU 11 causes the touch panel 131 to display the use permission confirmation screen 71 including a message inquiring whether to approve the reception of the cloud remote operation, the “Yes” button 711 indicating that the cloud remote operation is approved, and the “No” button 712 indicating that the cloud remote operation is rejected, and receives an input indicating a selection operation of the user (S1122 of FIG. 20).

The CPU 11 waits until the user input is received (S1122 of FIG. 20: NO), and if the user input is received (S1122 of FIG. 20: YES), the CPU 11 determines whether the received button is the “Yes” button 711 or the “No” button 712 (S1123 of FIG. 20). When it is determined that the operation on the “Yes” button 711 is received (S1123 of FIG. 20: Yes button), the CPU 11 permits the start of the cloud remote operation (S1131 of FIG. 20). S1121 and S1123 of FIG. 20 correspond to S115 of FIG. 6A. S1131 of FIG. 20 corresponds to S118 to S119 of FIG. 6B. The operation on the “Yes” button 711 of FIG. 20 corresponds to “APPROVE” of FIG. 6A

The cloud remote operation in a state where there is no user in front of the MFP 1 may reduce the safety. The MFP 1 according to the present embodiment starts the cloud remote operation when an operation on the “Yes” button 711 of the use permission confirmation screen 71 is received, and thus the safety of the cloud remote operation is high. When the user input is not received even after a predetermined time has elapsed after the use permission confirmation screen 71 is displayed, the MFP 1 may not start the cloud remote operation. For example, the MFP 1 may omit the reception of the operation on the use permission confirmation screen 71. The MFP 1 may be configured to start the cloud remote operation when the user input is not received even after the predetermined time has elapsed.

On the other hand, if it is determined that an operation on the “No” button 712 is received (S1123 of FIG. 20: No button), the CPU 11 rejects the start of the cloud remote operation (S1102 of FIG. 20). The operation on the “No” button 712 corresponds to “REJECT” of FIG. 6A during execution of the cloud remote operation, the user of the PC 5 virtually browses the display on the touch panel 131, and the MFP 1 is operated. By displaying the use permission confirmation screen 71, a user who is using the MFP 1 can wait for the start of the cloud remote operation by operating the “No” button 712, for example, when a screen that is not desired to be viewed is displayed. After S1131 of FIG. 20 or S1102 of FIG. 20, the CPU 11 returns the display of the touch panel 131 to a state before the use permission confirmation screen 71 is displayed in S1121 of FIG. 20, ends the start determination process, and returns to the start instruction procedure in FIGS. 4A and 4B.

The configurations listed below are also a part of the present disclosure.

(1): A system including an image forming device and an information processing device, the information processing device and the image forming device being configured to be connected to the Internet, in which
the information processing device is configured to install a start program and a browser,
the start program includes instructions that causes the information processing device to receive a start instruction of a remote operation specifying the image forming device via a user interface of the information processing device, and in a case where the start instruction is received, the instructions included in the start program causes the information processing device to execute an instruction transmission process of transmitting instruction data indicating the start of the remote operation to the specified image forming device,
upon receiving the instruction data, the image forming device executes a program upload process of uploading a remote operation program configured to operate in the browser to a cloud storage connected to the Internet,
the image forming device is further configured to execute, after receiving the instruction data, an image upload process of uploading, to the cloud storage, image data indicating a remote operation screen for receiving an operation in the remote operation,
in a case where the remote operation program is uploaded to the cloud storage after the execution of the instruction transmission process, the instructions included in the start program causes the information processing device to execute a browser activation process of activating the browser and of passing first access information necessary for downloading the remote operation program from the cloud storage to the browser,
in a case where the browser is activated by the start program, the browser causes the information processing device to execute a program download process of downloading the remote operation program from the cloud storage using the first access information passed from the start program,
the remote operation program includes instructions that cause, in a case where the remote operation program is downloaded by the browser, the information processing device to execute a screen display process of downloading the image data from the cloud storage and of displaying, on the user interface using the browser, the remote operation screen indicated by the image data,
in a case where an operation on the remote operation screen is received via the user interface, the instructions included in the remote operation program further cause the information processing device to execute an operation upload process of uploading operation data indicating an operation content to the cloud storage,
in a case where the operation data is uploaded to the cloud storage, the image forming device downloads the operation data from the cloud storage and executes a process corresponding to an operation indicated by the operation data, and in a case where the operation indicated by the operation data is an operation related to image formation, the image forming device executes an image forming process as a process corresponding to the operation,
in a case where an event occurs that changes the content of the remote operation screen displayed by the information processing device according to the remote operation program, the image forming device further uploads the image data indicating the changed remote operation screen to the cloud storage by executing the image upload process,
in a case where the image data indicating the changed remote operation screen is uploaded to the cloud storage, the instructions included in the remote operation program cause the information processing device to execute the screen display process, and in the screen display process, the information processing device downloads the image data indicating the changed remote operation screen from the cloud storage and displays the changed remote operation screen on the user interface using the browser.

(2): The system according to (1), in which
the image forming device includes a display and displays a main body operation screen, and in the image upload process, the image forming device uploads image data for virtually reproducing the main body operation screen displayed on the display to the cloud storage as the image data indicating the remote operation screen, and
the instructions included in the remote operation program cause the information processing device to execute the screen display process, and in the screen display process, the information processing device displays, on the user interface using the browser, the remote operation screen for virtually reproducing the main body operation screen based on the image data downloaded from the cloud storage.

(3): The system according to (2), in which
the image forming device executes the image upload process in a case where an event occurs that changes the content of the main body operation screen displayed on the display, and in the image upload process, the image forming device uploads the image data for virtually reproducing the changed main body operation screen to the cloud storage,
the instructions included in the remote operation program cause the information processing device to execute the screen display process in a case where the image data for virtually reproducing the changed main body operation screen is uploaded to the cloud storage, and in the screen display process, the information processing device downloads the image data for virtually reproducing the changed main body operation screen from the cloud storage, and displays, on the user interface using the browser, the remote operation screen for virtually reproducing the changed main body operation screen.

(4): The system according to (3), in which
the image forming device is configured to change the content of the main body operation screen along with the execution of a process corresponding to an operation indicated by the operation data uploaded to the cloud storage, and in a case where the content of the main body operation screen is changed along with the execution of the process corresponding to the operation indicated by the operation data, the image forming device uploads, to the cloud storage, the image data for virtually reproducing the changed main body operation screen along with the process corresponding to the operation indicated by the operation data by executing the image upload process, and
the instructions included in the remote operation program cause the information processing device to execute the screen display process in a case where the image data for virtually reproducing the changed main body operation screen along with the process corresponding to the operation indicated by the operation data is uploaded to the cloud storage, and in the screen display process, the information processing device downloads the image data for virtually reproducing the changed main body operation screen along with the process corresponding to an operation indicated by the operation data from the cloud storage and displays, on the user interface using the browser, the remote operation screen for virtually reproducing the changed main body operation screen along with the process corresponding to the operation indicated by the operation data.

(5): The system according to (1), in which
the image forming device includes a touch panel, and displays a main body panel screen including the plurality of operators on the touch panel, and upon receiving an operation on one of the plurality of operators, the image forming device executes a process based on the operator having received the operation;
the instructions included in the remote operation program cause the information processing device to execute the screen display process, and in the screen display process, the instructions included in the remote operation program cause the information processing device to display, on the user interface using the browser, the remote operation screen for virtually reproducing the main body panel screen based on the image data downloaded from the cloud storage, and
the instructions included in the remote operation program further cause the information processing device to execute the operation upload process upon receiving an operation on one of the plurality of operators displayed on the remote operation screen via the user interface, and in the operation upload process, the information processing device uploads, to the cloud storage, information for specifying the operator having received the operation as the operation data, and
in a case where the operation data is uploaded to the cloud storage, the image forming device downloads the operation data from the cloud storage and executes a process based on the operator specified by the operation data.

(6): The system according to (5), in which
the image forming device includes an operation panel including the touch panel, the operation panel also includes a plurality of hardware keys, and upon receiving an operation on one of the plurality of hardware keys, the image forming device executes a process based on the hardware key having received the operation,
the instructions included in the remote operation program cause the information processing device to execute the screen display process, and in the screen display process, the instructions included in the remote operation program cause the information processing device to display, on the user interface using the browser, the remote operation screen for virtually reproducing the operation panel based on the image data downloaded from the cloud storage,
the instructions included in the remote operation program further cause the information processing device to execute the operation upload process upon receiving an operation on one of the plurality of hardware keys displayed on the remote operation screen via the user interface, and in the operation upload process, the information processing device uploads, to the cloud storage as the operation data, information for specifying the hardware key having received the operation, and
in a case where the operation data is uploaded to the cloud storage, the image forming device downloads the operation data from the cloud storage and executes a process based on the hardware key specified by the operation data.

(7): The system according to (1), in which
the image forming device enters a state where the remote operation is being provided after executing the program upload process, and
in a case where the instruction data is received, the image forming device executes the program upload process in a case where the remote operation is not being provided, and does not execute the program upload process in a case where the remote operation is being provided.

(8): The system according to (1), in which
the image forming device stores a first password,
the instructions included in the start program cause the information processing device to receive a second password via the user interface, and in the instruction transmission process, the information processing device transmits the instruction data and the received second password to the specified image forming device, and
in a case where the image forming device receives the instruction data and the second password, the image forming device executes the program upload process in a case where the received second password matches the first password, and does not execute the program upload process in a case where the received second password does not match the first password.

(9): The system according to (1), in which
in a case where the instruction data is received, the image forming device receives a selection operation as to whether to approve the remote operation, executes the program upload process in a case where the selection operation to approve the remote operation is received, and does not execute the program upload process in a case where the selection operation to approve the remote operation is not received.

(10): The system according to (1), in which
after executing the program upload process, the image forming device transmits, to the information processing device that transmits the instruction data, response data indicating that the upload of the remote operation program is completed, and the response data includes the first access information,
in a case where the response data is received after the execution of the instruction transmission process, the instructions included in the start program cause the information processing device to execute the browser activation process, and passes the first access information included in the response data to the browser in the browser activation process,
in a case where the browser is activated by the start program, the browser causes the information processing device to execute the program download process, and in the program download process, the information processing device downloads the remote operation program from the cloud storage using the first access information included in the response data.

(11): The system according to (1), in which
the instructions included in the start program cause the information processing device to execute the instruction transmission process in a case where the start instruction is received while second access information necessary for transferring the instruction data via the cloud storage is held in the information processing device, and in the instruction transmission process, the information processing device uploads the instruction data specified by the image forming device to the cloud storage using the second access information, and
the image forming device executes the program upload process upon receiving the instruction data by downloading the instruction data from the cloud storage using the second access information while holding the second access information.

(12): The system according to (11), in which
after executing the program upload process, the image forming device uploads response data indicating that the upload of the remote operation program is completed to the cloud storage as a response to the instruction data, and the response data includes the first access information,
in a case where the response data is received by downloading the response data from the cloud storage after the execution of the instruction transmission process, the instructions included in the start program cause the information processing device to execute the browser activation process, and in the browser activation process, the information processing device passes the first access information included in the response data downloaded from the cloud storage to the browser, and
in a case where the browser is activated from the start program, the browser causes the information processing device to execute the program download process, and in the program download process, the information processing device downloads the remote operation program from the cloud storage using the first access information included in the response data downloaded from the cloud storage.

(13): The system according to (12), in which
in a case where the instruction data is received, the image forming device executes the program upload process, in the program upload process, the image forming device uploads the second access information to the cloud storage together with the remote operation program, and the second access information is information necessary for transferring the operation data via the cloud storage,
in a case where the browser is activated from the start program, the browser causes the information processing device to execute the program download process, and in the program download process, the information processing device downloads the remote operation program and the second access information from the cloud storage using the first access information, and
in a case where an operation on the remote operation screen is received via the user interface, the instructions included in the remote operation program cause the information processing device to execute the operation upload process, and in the operation upload process, the information processing device uploads the operation data to the cloud storage using the second access information downloaded from the cloud storage.

(14): The system according to (13), in which
the cloud storage includes a first cloud storage which is a non-structured data storage cloud storage, and a second cloud storage which is a structured data storage cloud storage,
the first access information is information necessary for accessing the first cloud storage,
the second access information is information necessary for accessing the second cloud storage,
the second cloud storage is provided with a structured data storage area, the structured data storage area is configured to include a plurality of records, and the plurality of records provided in the structured data storage area include an instruction record for storing the instruction data to the image forming device, a response record for storing the response data from the image forming device, an image record for storing the image data from the image forming device, and an operation record for storing the operation data to the image forming device,
the instructions included in the start program cause the information processing device to execute the instruction transmission process in a case where the start instruction is received while the second access information is held, and in the instruction transmission process, the information processing device uploads the instruction data in which the image forming device is specified to the structured data storage area provided in the second cloud storage to be stored in the instruction record using the second access information,
in a case where the instruction data stored in the instruction record is downloaded and received from the structured data storage area provided in the second cloud storage using the second access information while the second access information is held, the image forming device executes the program upload process, and in the program upload process, the image forming device uploads the second access information to the first cloud storage together with the remote operation program,
the image forming device further uploads the response data to the structured data storage area provided in the second cloud storage to be stored in the response record after executing the program upload process, and the response data includes the first access information,
the image forming device is further configured to execute the image upload process after receiving the instruction data, and in the image upload process, the image forming device uploads the image data to the structured data storage area provided in the second cloud storage to be stored in the image record,
in a case where the response data stored in the response record is downloaded from the structured data storage area provided in the second cloud storage after the execution of the instruction transmission process, the instructions included in the start program cause the information processing device to execute the browser activation process, and in the browser activation process, the information processing device passes the first access information included in the response data downloaded from the second cloud storage to the browser,
in a case where the browser is activated from the start program, the browser causes the information processing device to execute the program download process, and in the program download process, the information processing device downloads the remote operation program and the second access information from the first cloud storage using the first access information,
in a case where the remote operation program is downloaded by the browser, the instructions included in the remote operation program cause the information processing device to execute the screen display process, and in the screen display process, the information processing device downloads the image data stored in the image record from the structured data storage area provided in the second cloud storage, and displays, on the user interface using the browser, the remote operation screen indicated by the downloaded image data,
in a case where an operation on the remote operation screen is received via the user interface, the instructions included in the remote operation program cause the information processing device to execute the operation upload process, and in the operation upload process, the information processing device uploads the operation data to the structured data storage area provided in the second cloud storage to be stored in the operation record using the second access information downloaded from the first cloud storage, and
in a case where the operation data is uploaded to the structured data storage area provided in the second cloud storage, the image forming device downloads the operation data stored in the operation record from the structured data storage area provided in the second cloud storage, and executes a process corresponding to an operation indicated by the downloaded operation data.

(15): An image forming device, in which
the image forming device is configured to be connected to the Internet,
the image forming device is configured to receive instruction data, and the instruction data is transmitted to the image forming device in a case where a start instruction of a remote operation in which the image forming device is specified is received by a start program installed in an information processing device connected to the Internet,
in a case where the instruction data is received, the image forming device executes a program upload process of uploading a remote operation program configured to operate in a browser to a cloud storage connected to the Internet, and the remote operation program uploaded to the cloud storage is downloaded to the information processing device from the start program by the browser that is activated by the start program and to which first access information necessary for downloading the remote operation program from the cloud storage is passed, using the first access information,
the image forming device is configured to execute, after receiving the instruction data, an image upload process of uploading, to the cloud storage, image data indicating a remote operation screen for receiving an operation in the remote operation, the image data is downloaded to the information processing device by the remote operation program, and the remote operation screen indicated by the image data is displayed on a user interface of the information processing device using the browser,
in a case where the operation data is uploaded to the cloud storage, the image forming device downloads the operation data from the cloud storage, and executes a process corresponding to an operation indicated by the operation data, in a case where the operation indicated by the operation data is an operation related to image formation, the image forming device executes an image forming process as a process corresponding to the operation, the operation data is data indicating an operation content on the remote operation screen, and in a case where the information processing device receives an operation on the remote operation screen, the operation data is uploaded to the cloud storage according to the remote operation program, and
in a case where an event occurs that changes the content of the remote operation screen displayed on the information processing device, the image forming device uploads the image data indicating the changed remote operation screen to the cloud storage by executing the image upload process, and in a case where the image data indicating the changed remote operation screen is uploaded to the cloud storage, the image data indicating the changed remote operation screen is downloaded from the cloud storage to the information processing device according to the remote operation program, and the changed remote operation screen is displayed on the user interface using the browser.

(16): The image forming device according to (15), in which
the image forming device includes a display and displays a main body operation screen on the display, and in the image upload process, the image forming device uploads image data for virtually reproducing the main body operation screen displayed on the display to the cloud storage as the image data indicating the remote operation screen, the image data is downloaded to the information processing device according to the remote operation program, and the remote operation screen for virtually reproducing the main body operation screen based on the image data downloaded from the cloud storage is displayed on the user interface using the browser.

(17): The image forming device according to (15), in which
the image forming device includes a touch panel, displays a main body panel screen including the plurality of operators on the touch panel, upon receiving an operation on one of the plurality of operators, the image forming device executes a process based on the operator having received the operation, in the image upload process, the image forming device uploads the image data for virtually reproducing the main body panel screen displayed on the touch panel to the cloud storage as the image data indicating the remote operation screen, the image data is downloaded to the information processing device according to the remote operation program, and in a case where the remote operation screen for virtually reproducing the main body panel screen based on the image data downloaded from the cloud storage is displayed on the user interface using the browser and an operation on one of the plurality of operators displayed on the remote operation screen is received, the operation data is uploaded to the cloud storage according to the remote operation program, and the operation data to be uploaded is information for specifying the operator having received operation among the plurality of operators displayed on the remote operation screen, and
in a case where the operation data is uploaded to the cloud storage, the image forming device downloads the operation data from the cloud storage and executes a process based on the operator specified by the operation data.

(18): The image forming device according to (15),
after executing the program upload process, the image forming device transmits response data indicating that the upload of the remote operation program has been completed to the information processing device that transmits the instruction data, the response data includes the first access information, in a case where the first access information included in the response data is received by the information processing device that transmits the instruction data, the first access information is passed to the browser activated by the start program, and the remote operation program uploaded to the cloud storage is downloaded to the information processing device using the first access information included in the response data using the browser.

(19): The image forming device according to (15), in which
the image forming device executes the program upload process in a case where the instruction data in which the image forming device is specified is received by downloading the instruction data from the cloud storage using the second access information while second access information necessary for transferring the instruction data via the cloud storage is held, and the instruction data in which the image forming device is specified is uploaded to the cloud storage using the second access information according to the start program in a case where the start instruction is received according to the start program while the second access information is held.

(20): A system including an image forming device and an information processing device, the information processing device and the image forming device being connected to the Internet, in which
the image forming device includes a display and is configured to display a main body operation screen on the display,
the information processing device is configured to install a browser,
the browser causes the information processing device to acquire a remote operation program configured to operate in the browser,
the image forming device is configured to execute an image upload process of uploading image data for virtually reproducing the main body operation screen displayed on the display to a cloud storage connected to the Internet,
the remote operation program includes instructions that cause the information processing device to execute a screen display process of downloading the image data from the cloud storage and displaying, on a user interface of the information processing device using the browser, a remote operation screen for virtually reproducing the main body operation screen based on the image data,
in a case where an operation on the remote operation screen is received via the user interface, the instructions included in the remote operation program further cause the information processing device to execute an operation upload process of uploading operation data indicating an operation content to the cloud storage,
in a case where the operation data is uploaded to the cloud storage, the image forming device downloads the operation data from the cloud storage and executes a process corresponding to an operation indicated by the operation data, and in a case where the operation indicated by the operation data is an operation related to image formation, the image forming device executes an image forming process as a process corresponding to the operation,
the image forming device further uploads the image data for virtually reproducing the changed main body operation screen to the cloud storage by executing the image upload process in a case where an event occurs that changes the content of the main body operation screen, and
the instructions included in the remote operation program cause the information processing device to execute the screen display process in a case where the image data for virtually reproducing the changed main body operation screen is uploaded to the cloud storage, and in the screen display process, the information processing device downloads the image data for virtually reproducing the changed main body operation screen from the cloud storage and displays, on the user interface using the browser, the changed remote operation screen for virtually reproducing the changed main body operation screen based on the downloaded image data.

(21): The system according to (20), in which
the image forming device is configured to change the content of the main body operation screen along with the execution of a process corresponding to an operation indicated by the operation data uploaded to the cloud storage, and in a case where the content of the main body operation screen is changed along with the execution of the process corresponding to the operation indicated by the operation data, the image forming device uploads, to the cloud storage, the image data for virtually reproducing the changed main body operation screen along with the process corresponding to the operation indicated by the operation data by executing the image upload process, and
the instructions included in the remote operation program cause the information processing device to execute the screen display process in a case where the image data for virtually reproducing the changed main body operation screen along with the process corresponding to the operation indicated by the operation data is uploaded to the cloud storage, and in the screen display process, the information processing device downloads the image data for virtually reproducing the changed main body operation screen along with the process corresponding to an operation indicated by the operation data from the cloud storage and displays, on the user interface using the browser, the remote operation screen for virtually reproducing the changed main body operation screen along with the process corresponding to the operation indicated by the operation data.

(22): The system according to (20), in which
the image forming device includes a touch panel, and displays a main body panel screen including the plurality of operators on the touch panel, and upon receiving an operation on one of the plurality of operators, the image forming device executes a process based on the operator having received the operation;
the instructions included in the remote operation program cause the information processing device to execute the screen display process, and in the screen display process, the information processing device displays, on the user interface using the browser, the remote operation screen for virtually reproducing the main body panel screen based on the image data downloaded from the cloud storage, and
the instructions included in the remote operation program further cause the information processing device to execute the operation upload process upon receiving an operation on one of the plurality of operators displayed on the remote operation screen via the user interface, and in the operation upload process, the information processing device uploads, to the cloud storage, information for specifying the operator having received the operation as the operation data, and
in a case where the operation data is uploaded to the cloud storage, the image forming device downloads the operation data from the cloud storage and executes a process based on the operator specified by the operation data.

(23): The system according to (22), in which
the image forming device includes an operation panel including the touch panel, the operation panel also includes a plurality of hardware keys, and upon receiving an operation on one of the plurality of hardware keys, the image forming device executes a process based on the hardware key having received the operation,
the instructions included in the remote operation program cause the information processing device to execute the screen display process, and in the screen display process, the information processing device displays, on the user interface using the browser, the remote operation screen for virtually reproducing the operation panel based on the image data downloaded from the cloud storage,
the instructions included in the remote operation program further cause the information processing device to execute the operation upload process upon receiving an operation on one of the plurality of hardware keys displayed on the remote operation screen via the user interface, and in the operation upload process, the information processing device uploads, to the cloud storage as the operation data, information for specifying the hardware key having received the operation, and
in a case where the operation data is uploaded to the cloud storage, the image forming device downloads the operation data from the cloud storage and executes a process based on the hardware key specified by the operation data.

(24): The system according to (20), in which
the image forming device repeatedly executes the image upload process, and uploads the image data for virtually reproducing the changed main body operation screen to the cloud storage by the image upload process executed immediately after an event occurs that changes the content of the main body operation screen.

(25): The system according to (24), in which
in a case where the operation data is uploaded to the cloud storage, the image forming device downloads the operation data from the cloud storage, executes a process corresponding to the operation indicated by the operation data, and executes the image upload process even in a case where the content of the main body operation screen is changed or is not changed by executing the process corresponding to the operation indicated by the operation data.

(26): The system according to (24), in which
the image forming device is configured to display the main body operation screen corresponding to a special mode on the display,
the image forming device, while displaying the main body operation screen corresponding to the special mode on the display, repeatedly executes a calculation process of calculating a check numerical value using image data indicating the main body operation screen corresponding to the displayed special mode without repeatedly executing the image upload process, and in a case where the check numerical value calculated in the previous calculation process is different from the check numerical value calculated in the current calculation process, the image forming device uploads, to the cloud storage, the image data for virtually reproducing the main body operation screen corresponding to the check numerical value calculated in the current calculation process by executing the image upload process.

(27): The system according to (26), in which
the special mode is a maintenance mode of the image forming device, and
in a case where the operation indicated by the operation data downloaded from the cloud storage is an operation indicating the start of maintenance, the image forming device displays the main body operation screen corresponding to the special mode on the display.

(28): The system according to (20), in which
the main body operation screen is provided with an identifier for each screen,
in a case where an event occurs that changes an identifier of the main body operation screen displayed on the display, the image forming device uploads, to the cloud storage, the image data for virtually reproducing the main body operation screen corresponding to the changed identifier by executing the image upload process,
the instructions included in the remote operation program cause the information processing device to execute the screen display process in a case where the image data for virtually reproducing the main body operation screen corresponding to the changed identifier is uploaded to the cloud storage, and in the screen display process, the information processing device downloads the image data for virtually reproducing main body operation screen corresponding to the changed identifier from the cloud storage, and displays, on the user interface using the browser, the remote operation screen for virtually reproducing the main body operation screen corresponding to the changed identifier based on the downloaded image data.

(29): The system according to (20), in which
the image forming device is configured to display the main body operation screen including a moving image on the display,
the image forming device further uploads, to the cloud storage, no-moving-image image data for virtually reproducing a no-moving-image main body operation screen, which is the main body operation screen excluding the moving image, instead of the image data for virtually reproducing the main body operation screen while the main body operation screen including the moving image is being displayed on the display, by the image upload process, and
the instructions included in the remote operation program cause the image forming device to execute the screen display process even in a case where the no-moving-image image data is downloaded from the cloud storage, and in the screen display process, the image forming device displays, on the user interface using the browser, the remote operation screen for virtually reproducing the no-moving-image main body operation screen based on the downloaded no-moving-image image data.

(30): An image forming device, in which
the image forming device is configured to be connected to the Internet,
the image forming device includes a display and is configured to display a main body operation screen on the display,
the image forming device is configured to execute an image upload process of uploading, to a cloud storage connected to the Internet, image data for virtually reproducing the main body operation screen displayed on the display, the image data is downloaded to an information processing device connected to the Internet by a remote operation program configured to operate in a browser, a remote operation screen for virtually reproducing the main body operation screen based on the image data is displayed on a user interface of the information processing device using the browser,
in a case where the operation data is uploaded to the cloud storage, the image forming device downloads the operation data from the cloud storage and executes a process corresponding to an operation indicated by the operation data, in a case where the operation indicated by the operation data is an operation related to image formation, the image forming device executes an image forming process as a process corresponding to the operation, the operation data is data indicating the content of an operation on the remote operation screen, and in a case where the information processing device receives the operation on the remote operation screen, the operation data is uploaded to the cloud storage according to the remote operation program,
in a case where an event occurs that changes the content of the remote operation screen displayed on the information processing device, the image forming device executes the image upload process to upload, to the cloud storage, the image data for virtually reproducing the changed main body operation screen, in a case where the image data indicating the changed remote operation screen is uploaded to the cloud storage, the image data for virtually reproducing the changed main body operation screen is downloaded from the cloud storage to the information processing device according to the remote operation program, and the remote operation screen for virtually reproducing the changed main body operation screen based on the downloaded image data is displayed on the user interface using the browser.

(31): The system according to (30), in which
the image forming device is configured to change the content of the main body operation screen along with the execution of a process corresponding to an operation indicated by the operation data uploaded to the cloud storage, in a case where the content of the main body operation screen is changed along with the execution of the process corresponding to the operation indicated by the operation data, the image forming device uploads, to the cloud storage, the image data for virtually reproducing the changed main body operation screen along with the process corresponding to the operation indicated by the operation data by executing the image upload process, the image data is downloaded to the information processing device according to the remote operation program, and the remote operation screen for virtually reproducing the changed main body operation screen along with the process corresponding to the operation indicated by the operation data based on the image data downloaded from the cloud storage is displayed on the user interface using the browser.

(32): The image forming device according to (30), in which
the image forming device includes a touch panel, displays a main body panel screen including the plurality of operators on the touch panel, upon receiving an operation on one of the plurality of operators, the image forming device executes a process based on the operator having received the operation, in the image upload process, the image forming device uploads the image data for virtually reproducing the main body panel screen displayed on the display to the cloud storage as the image data indicating the remote operation screen, the image data is downloaded to the information processing device according to the remote operation program, and in a case where the remote operation screen for virtually reproducing the main body panel screen based on the image data downloaded from the cloud storage is displayed on the user interface using the browser and an operation on one of the plurality of operators displayed on the remote operation screen is received, the operation data is uploaded to the cloud storage according to the remote operation program, and the operation data to be uploaded includes information for specifying the operator having received operation among the plurality of operators displayed on the remote operation screen, and
in a case where the operation data is uploaded to the cloud storage, the image forming device downloads the operation data from the cloud storage and executes a process based on the operator specified by the operation data.

(33): The image forming device according to (30), in which
the image forming device repeatedly executes the image upload process, and uploads the image data for virtually reproducing the changed main body operation screen to the cloud storage by the image upload process executed immediately after an event occurs that changes the content of the main body operation screen.

(34): A system including an image forming device, a first information processing device, and a second information processing device, the first information processing device, the second information processing device, and the image forming device being connected to the Internet, in which
the first information processing device and the second information processing device are configured to install a browser,
upon receiving a start instruction of a first remote operation from the first information processing device via a cloud storage connected to the Internet, the image forming device executes a program upload process of uploading a first remote operation program configured to operate in the browser to the cloud storage, and in a case where the first remote operation program is uploaded to the cloud storage, the browser installed on the first information processing device causes the first information processing device to download the first remote operation program from the cloud storage,
the image forming device is further configured to execute an image upload process of uploading first image data indicating a first remote operation screen to the cloud storage after receiving the start instruction of the first remote operation,
the first remote operation program includes instructions that cause the first information processing device to execute a screen display process of downloading the first image data from the cloud storage and displaying the first remote operation screen indicated in the first image data on the user interface of the first information processing device using the browser,
in a case where an operation on the first remote operation screen is received via the user interface of the first information processing device, the instructions included in the first remote operation program further cause the first information processing device to execute an operation upload process of uploading first operation data indicating an operation content to the cloud storage;
in a case where the first operation data is uploaded to the cloud storage, the image forming device downloads the first operation data from the cloud storage and executes a process corresponding to an operation indicated by the first operation data, and in a case where the operation indicated by the downloaded first operation data is an operation related to image formation, the image forming device executes an image forming process as a process corresponding to the operation,
upon receiving a start instruction of a second remote operation from the second information processing device through local communication not via the cloud storage, the image forming device executes a program reply process of returning a second remote operation program configured to operate in the browser to the second information processing device not via the cloud storage, and the browser installed on the second information processing device acquires the second remote operation program returned from the image forming device,
the image forming device is further configured to execute an image transmission process of transmitting second image data indicating a second remote operation screen to the second information processing device not via the cloud storage after receiving the start instruction of the second remote operation,
the second remote operation program includes instructions that cause, in a case where the second information processing device receives the second image data, the second information processing device to execute a local screen display process of displaying, on the user interface of the second information processing device using the browser, the second remote operation screen indicated by the received second image data,
in a case where an operation on the second remote operation screen is received via the user interface of the second information processing device, the instructions included in the second remote operation program further cause the second information processing device to execute an operation transmission process of transmitting second operation data indicating an operation content to the image forming device not via the cloud storage,
upon receiving the second operation data from the second information processing device, the image forming device executes a process corresponding to an operation indicated by the received second operation data, and in a case where the operation indicated by the received second operation data is an operation related to image formation, the image forming device executes an image forming process as a process corresponding to the operation;
in a case where the image forming device starts providing the first remote operation by executing the program upload process after receiving the start instruction of the first remote operation, the image forming device enters a first remote operation providing state until an ending condition of the first remote operation is satisfied,
in a case where the image forming device starts providing the second remote operation by executing the program reply process after receiving the start instruction of the second remote operation, the image forming device enters a second remote operation providing state until an ending condition of the second remote operation is satisfied,
the image forming device is configured to start providing the second remote operation even in a case where the image forming device receives the start instruction of the second remote operation from the second information processing device in the first remote operation providing state, and
the image forming device is configured to start providing the first remote operation even in a case where the image forming device receives the start instruction of the first remote operation from the first information processing device in the second remote operation providing state.

(35): The system according to (34), in which
the image forming device includes a display and displays a main body operation screen on the display, and in the image upload process, the image forming device uploads image data for virtually reproducing the main body operation screen displayed on the display to the cloud storage as the first image data indicating the first remote operation screen, and
the instructions included in the first remote operation program cause the first information processing device to execute the screen display process in a case where the first image data is uploaded to the cloud storage, in the screen display process, the first information processing device displays, on the user interface using the browser, the first remote operation screen for virtually reproducing the main body operation screen based on the first image data downloaded from the cloud storage.

(36): The system according to (35), in which
in a case where the image forming device receives the start instruction of the second remote operation from the second information processing device and starts providing the second remote operation in the first remote operation providing state, in the image transmission process, the image forming device transmits image data for reproducing a screen configuration equivalent to that of the first remote operation screen as the second image data indicating the second remote operation screen to the second information processing device, and
the instructions included in the second remote operation program cause the second information processing device to execute the local screen display process in a case where the second information processing device receives the second image data, and in the local screen display process, the second information processing device displays, on the user interface of the second information processing device using the browser, the second remote operation screen for reproducing a screen configuration equivalent to that of the first remote operation screen based on the received second image data.

(37): The system according to (35), in which
the image forming device executes the image upload process in a case where an event occurs that changes the content of the main body operation screen displayed on the display, and in the image upload process, the image forming device uploads the first image data for virtually reproducing the changed main body operation screen to the cloud storage,
the instructions included in the first remote operation program cause the first information processing device to execute the screen display process in a case where the first image data for virtually reproducing the changed main body operation screen is uploaded to the cloud storage, and in the screen display process, the first information processing device downloads the first image data for virtually reproducing the changed main body operation screen from the cloud storage, and displays, on the user interface of the first information processing device using the browser, the first remote operation screen for virtually reproducing the changed main body operation screen.

(38): The system according to (37), in which
the image forming device executes the image upload process and the image transmission process in a case where an event occurs that changes the content of the main body operation screen displayed on the display after the start instruction of the second remote operation is received from the second information processing device and the provision of the second remote operation is started in the first remote operation providing state, in the image upload process, the image forming device uploads the first image data for virtually reproducing the changed main body operation screen to the cloud storage, and in the image transmission process, the image forming device transmits image data for reproducing a screen configuration equivalent to that of the changed first remote operation screen as the second image data indicating the second remote operation screen to the second information processing device,
the instructions included in the first remote operation program cause the first information processing device to execute the screen display process in a case where the first image data for virtually reproducing the changed main body operation screen is uploaded to the cloud storage, and in the screen display process, the first information processing device downloads the first image data for virtually reproducing the changed main body operation screen from the cloud storage, and displays, on the user interface of the first information processing device using the browser, the first remote operation screen for virtually reproducing the changed main body operation screen, and
the instructions included in the second remote operation program cause the second information processing device to execute the local screen display process in a case where the second information processing device receives the second image data, and in the local screen display process, the second information processing device displays, on the user interface of the second information processing device using the browser, the second remote operation screen for reproducing a screen configuration equivalent to that of the changed first remote operation screen based on the received second image data.

(39): The system according to (35), in which
the image forming device is configured to change the content of the main body operation screen along with the execution of a process corresponding to an operation indicated by the first operation data uploaded to the cloud storage, and in a case where the content of the main body operation screen is changed along with the execution of the process corresponding to the operation indicated by the first operation data, the image forming device uploads, to the cloud storage, the first image data for virtually reproducing the changed main body operation screen along with the process corresponding to the operation indicated by the first operation data by executing the image upload process, and
the instructions included in the first remote operation program cause the first information processing device to execute the screen display process in a case where the image data for virtually reproducing the changed main body operation screen along with the process corresponding to the operation indicated by the first operation data is uploaded to the cloud storage, and in the screen display process, the first information processing device downloads the image data for virtually reproducing the changed main body operation screen along with the process corresponding to the operation indicated by the first operation data from the cloud storage and displays, on the user interface of the first information processing device using the browser, the first remote operation screen for virtually reproducing the changed main body operation screen along with the process corresponding to the operation indicated by the first operation data.

(40): The system according to (39), in which
the image forming device uploads the first image data for virtually reproducing the changed main body operation screen along with the process corresponding to the operation indicated by the first operation data to the cloud storage by executing the image upload process in a case where the content of the main body operation screen is changed along with the execution of the process corresponding to the operation indicated by the first operation data uploaded to the cloud storage after the start instruction of the second remote operation is received from the second information processing device and the provision of the second remote operation is started in the first remote operation providing state, and the image forming device executes the image transmission process to transmit, to the second information processing device, image data for reproducing a screen configuration equivalent to that of the changed first remote operation screen as the second image data indicating the second remote operation screen,
the instructions included in the first remote operation program cause the first information processing device to execute the screen display process in a case where the first image data for virtually reproducing the changed main body operation screen along with the process corresponding to the operation indicated by the first operation data is uploaded to the cloud storage, and in the screen display process, the first information processing device downloads the first image data for virtually reproducing the changed main body operation screen along with the process corresponding to the operation indicated by the first operation data from the cloud storage, and displays, on the user interface of the first information processing device using the browser, the first remote operation screen for virtually reproducing the changed main body operation screen along with the process corresponding to the operation indicated by the first operation data, and
the instructions included in the second remote operation program cause the second information processing device to execute the local screen display process in a case where the second information processing device receives the second image data, and in the local screen display process, the second information processing device displays, on the user interface of the second information processing device using the browser, the second remote operation screen for reproducing a screen configuration equivalent to that of the changed first remote operation screen based on the received second image data.

(41): The system according to (34), in which
the image forming device includes a touch panel, and displays a main body panel screen including the plurality of operators on the touch panel, and upon receiving an operation on one of the plurality of operators, the image forming device executes a process based on the operator having received the operation,
the instructions included in the first remote operation program cause the first information processing device to execute the screen display process, and in the screen display process, the first information processing device displays, on the user interface of the first information processing device using the browser, the first remote operation screen for virtually reproducing the main body panel screen based on the first image data downloaded from the cloud storage, and
the instructions included in the first remote operation program further cause the first information processing device to execute the operation upload process upon receiving an operation on one of the plurality of operators displayed on the first remote operation screen via the user interface of the first information processing device, and in the operation upload process, the first information processing device uploads, to the cloud storage, information for specifying the operator having received the operation as the first operation data, and
in a case where the first operation data is uploaded to the cloud storage, the image forming device downloads the first operation data from the cloud storage and executes a process based on the operator specified by the first operation data.

(42): The system according to (41), in which
the image forming device includes an operation panel including the touch panel, the operation panel also includes a plurality of hardware keys, and upon receiving an operation on one of the plurality of hardware keys, the image forming device executes a process based on the hardware key having received the operation,
the instructions included in the first remote operation program cause the first information processing device to execute the screen display process, and in the screen display process, the first information processing device displays, on the user interface of the first information processing device using the browser, the first remote operation screen for virtually reproducing the operation panel based on the first image data downloaded from the cloud storage,
the instructions included in the first remote operation program further cause the first information processing device to execute the operation upload process upon receiving an operation on one of the plurality of hardware keys displayed on the first remote operation screen via the user interface of the first information processing device, and in the operation upload process, the first information processing device uploads, to the cloud storage as the operation data, information for specifying the hardware key having received the operation, and
in a case where the first operation data is uploaded to the cloud storage, the image forming device downloads the first operation data from the cloud storage and executes a process based on the hardware key specified by the first operation data.

(43): The system according to (34), in which
the image forming device is configured not to start providing the first remote operation even in a case where the image forming device receives the start instruction of the first remote operation from an information processing device different from the first information processing device in the first remote operation providing state.

(44): The system according to (43), in which
the image forming device is configured not to start providing the second remote operation even in a case where the image forming device receives the start instruction of the second remote operation from an information processing device different from the second information processing device in the second remote operation providing state.

(45): The system according to (34), in which
the image forming device is configured to, upon receiving the start instruction of the first remote operation from the first information processing device via the cloud storage while not in the second remote operation providing state, receive a first operation indicating whether to approve provision of the first remote operation via the user interface of the image forming device, start providing the first remote operation in a case where the first operation of approving provision of the first remote operation is received, and not to start providing the first remote operation in a case where the first operation of not approving provision of the first remote operation is received,
the image forming device is configured to, upon receiving the start instruction of the second remote operation from the second information processing device through the local communication while not in the first remote operation providing state, receive a second operation indicating whether to approve the provision of the second remote operation via the user interface of the image forming device, start providing the second remote operation in a case where the second operation of approving the provision of the second remote operation is received, and not to start providing the second remote operation in a case where the second operation of not approving the provision of the second remote operation is received, and
the image forming device is configured to, upon receiving the start instruction of the first remote operation from the first information processing device via the cloud storage in the second remote operation providing state, start providing the first remote operation without receiving the first operation.

(46): The system according to (45), in which
the image forming device is configured to store rejection information in a memory of the image forming device without starting providing the second remote operation in a case where the image forming device receives the second operation of not approving provision of the second remote operation via the user interface of the image forming device after receiving the start instruction of the second remote operation from the second information processing device through the local communication while not in the first remote operation providing state,
the image forming device is configured to, upon receiving the start instruction of the first remote operation from the first information processing device via the cloud storage while not in the second remote operation providing state, receive the first operation via the user interface of the image forming device in a case where the rejection information is not stored in the memory, start providing the first remote operation in a case where the first operation of approving provision of the first remote operation is received, not to start providing the first remote operation in a case where the first operation of not approving provision of the first remote operation is received, and not to start providing the first remote operation without receiving the first operation in a case where the rejection information is stored in the memory.

(47): The system according to (46), in which
the image forming device deletes the rejection information from the memory in a case where a predetermined period has elapsed after the rejection information is stored in the memory.

(48): The system according to (46), in which
the image forming device is configured to, upon receiving the start instruction of the first remote operation from the first information processing device via the cloud storage in a state not in the second remote operation providing state and waiting for the second operation after receiving the start instruction of the second remote operation, wait for the second operation without receiving the first operation, and then start providing the first remote operation in a case where receiving the second operation of approving provision of the second remote operation, and not to start providing the first remote operation in a case where receiving the second operation of not approving provision of the second remote operation.

(49): An image forming device, in which
the image forming device is configured to be connected to the Internet,
upon receiving a start instruction of a first remote operation from a first information processing device via a cloud storage connected to the Internet, the image forming device executes a program upload process of uploading a first remote operation program configured to operate in a browser to the cloud storage, and in a case where the first remote operation program is uploaded to the cloud storage, the browser installed on the first information processing device causes the first information processing device to download the first remote operation program from the cloud storage,
the image forming device is further configured to execute an image upload process of uploading first image data indicating a first remote operation screen to the cloud storage after receiving the start instruction of the first remote operation, the first image data is downloaded to the first information processing device according to the first remote operation program, and the first remote operation screen indicated by the first image data is displayed on a user interface of the first information processing device using the browser,
in a case where the first operation data is uploaded to the cloud storage, the image forming device further downloads the first operation data from the cloud storage and executes a process corresponding to an operation indicated by the first operation data, in a case where the operation indicated by the first operation data is an operation related to image formation, the image forming device executes an image forming process as a process corresponding to the operation, the first operation data is data indicating an operation content on the first remote operation screen, and in a case where the first information processing device receives an operation on the first remote operation screen, the first operation data is uploaded to the cloud storage according to the first remote operation program,
upon receiving a start instruction of a second remote operation from a second information processing device through local communication not via the cloud storage, the image forming device executes a program reply process of returning a second remote operation program configured to operate in the browser to the second information processing device not via the cloud storage, the browser installed on the second information processing device acquires the second remote operation program returned from the image forming device,
the image forming device is further configured to execute an image transmission process of transmitting second image data indicating a second remote operation screen to the second information processing device not via the cloud storage after receiving the start instruction of the second remote operation, the second image data is downloaded to the second information processing device according to the second remote operation program, and the second remote operation screen indicated in the second image data is displayed on the user interface of the second information processing device using the browser,
upon receiving second operation data from the second information processing device, the image forming device further executes a process corresponding to an operation indicated by the received second operation data, and in a case where the operation indicated by the received second operation data is an operation related to image formation, the image forming device executes an image forming process as a process corresponding to the operation, the second operation data is data indicating an operation content to the second remote operation screen, and in a case where the second information processing device receives an operation on the second remote operation screen, the operation is transmitted to the image forming device according to the second remote operation program,
in a case where the image forming device starts providing the first remote operation by executing the program upload process after receiving the start instruction of the first remote operation, the image forming device enters a first remote operation providing state until an ending condition of the first remote operation is satisfied,
in a case where the image forming device starts providing the second remote operation by executing the program reply process after receiving the start instruction of the second remote operation, the image forming device enters a second remote operation providing state until an ending condition of the second remote operation is satisfied,
the image forming device is configured to start providing the second remote operation even in a case where the image forming device receives the start instruction of the second remote operation from the second information processing device in the first remote operation providing state, and
the image forming device is configured to start providing the first remote operation even in a case where the image forming device receives the start instruction of the first remote operation from the first information processing device in the second remote operation providing state.

(50): The image forming device according to (49), in which
the image forming device includes a display and displays a main body operation screen on the display, and in the image upload process, the image forming device uploads image data for virtually reproducing the main body operation screen displayed on the display to the cloud storage as the first image data indicating the first remote operation screen, the image data is downloaded to the first information processing device according to the first remote operation program, and the first remote operation screen for virtually reproducing the main body operation screen based on the first image data downloaded from the cloud storage is displayed on the user interface of the first information processing device using the browser.

(51): The image forming device according to (49), in which
the image forming device includes a touch panel and displays a main body panel screen including the plurality of operators on the touch panel, upon receiving an operation on one of the plurality of operators, the image forming device executes a process based on the operator having received the operation, in the image upload process, the image forming device uploads the first image data for virtually reproducing the main body panel screen displayed on the touch panel to the cloud storage as the first image data indicating the first remote operation screen, the first image data is downloaded to the first information processing device by the first remote operation program, and in a case where the first remote operation screen for virtually reproducing the main body panel screen based on the first image data downloaded from the cloud storage is displayed on the user interface of the first information processing device using the browser and an operation on one of the plurality of operators displayed on the first remote operation screen is received, the first operation data is uploaded to the cloud storage by the first remote operation program, and the first operation data to be uploaded is information for specifying the operator having received operation among the plurality of operators displayed on the first remote operation screen, and
in a case where the first operation data is uploaded to the cloud storage, the image forming device downloads the first operation data from the cloud storage and executes a process based on the operator specified by the first operation data.

(52): The image forming device according to (49), in which
the image forming device does not start providing the first remote operation even in a case where the start instruction of the first remote operation is received from an information processing device different from the first information processing device in the first remote operation providing state.

(53): The image forming device according to (49), in which
the image forming device is configured to, upon receiving the start instruction of the first remote operation from the first information processing device via the cloud storage while not in the second remote operation providing state, receive a first operation indicating whether to approve provision of the first remote operation via the user interface of the image forming device, start providing the first remote operation in a case where the first operation of approving provision of the first remote operation is received, and not to start providing the first remote operation in a case where the first operation of not approving provision of the first remote operation is received,
the image forming device is configured to, upon receiving the start instruction of the second remote operation from the second information processing device through the local communication while not in the first remote operation providing state, receive a second operation indicating whether to approve the provision of the second remote operation via the user interface of the image forming device, start providing the second remote operation in a case where the second operation of approving the provision of the second remote operation is received, and not to start providing the second remote operation in a case where the second operation of not approving the provision of the second remote operation is received, and
the image forming device is configured to, upon receiving the start instruction of the first remote operation from the first information processing device via the cloud storage in the second remote operation providing state, start providing the first remote operation without receiving the first operation.

What is claimed is:

1. A system comprising:
an image forming device; and
an information processing device,
wherein the image forming device and the information processing device are configured to be connected to the Internet,
the information processing device is configured to install a browser,
the browser is configured to cause the information processing device to acquire a remote operation program configured to operate in the browser,
the image forming device is configured to execute an image upload process of uploading image data indicating a remote operation screen including a plurality of operators to a cloud storage connected to the Internet,
the remote operation program includes instructions that cause the information processing device to execute a screen display process of downloading the image data from the cloud storage and of displaying, using the browser, the remote operation screen including the plurality of operators indicated by the image data on a user interface of the information processing device,
upon receiving an operation on one of the plurality of operators included in the remote operation screen via the user interface, the instructions included in the remote operation program further cause the information processing device to execute an operation upload process of uploading operation data for specifying the operated operator to the cloud storage,
in a case where the operation data is uploaded to the cloud storage, the image forming device downloads the operation data from the cloud storage, executes a process based on the operator specified by the operation data, and executes an image forming process as a process corresponding to the operator in a case where the operator specified by the operation data is an operator related to image formation,
in a case where an event that changes the content of the remote operation screen displayed on the information processing device according to the remote operation program occurs, the image forming device executes the image upload process to upload the image data indicating the remote operation screen after a change caused by the event to the cloud storage, and
in a case where the image data indicating the remote operation screen after the change is uploaded to the cloud storage, the instructions included in the remote operation program cause the information processing device to execute the screen display process, and in the screen display process, the information processing device downloads the image data indicating the remote operation screen after the change from the cloud storage and displays the remote operation screen after the change on the user interface using the browser.

2. The system according to claim 1,
wherein the image forming device includes a display,
the image forming device is configured to cause the display to display a main body operation screen including the plurality of operators, and in the image upload process, the image forming device uploads image data for virtually reproducing the main body operation screen displayed on the display to the cloud storage, as the image data indicating the remote operation screen, and
the instructions included in the remote operation program cause the information processing device to execute the screen display process, and
in the screen display process, the information processing device displays, on the user interface using the browser, the remote operation screen for virtually reproducing the main body operation screen based on the image data downloaded from the cloud storage.

3. The system according to claim 2,
wherein in a case where an event that changes the content of the main body operation screen displayed on the display occurs, the image forming device executes the image upload process, and in the image upload process, the image forming device uploads the image data for virtually reproducing the changed main body operation screen to the cloud storage,
in a case where the image data for virtually reproducing the content of the main body operation screen after a change caused by the event is uploaded to the cloud storage, the instructions included in the remote operation program cause the information processing device to execute the screen display process, and
in the screen display process, the information processing device downloads the image data for virtually reproducing the content of the main body operation screen after the change from the cloud storage, and displays, on the user interface using the browser, the remote operation screen for virtually reproducing the content of the main body operation screen after the change.

4. The system according to claim 3,
wherein the image forming device is configured to change the content of the main body operation screen according to the execution of a process based on the operator specified by the operation data uploaded to the cloud storage, and in a case where the content of the main body operation screen is changed according to the execution of the process based on the operator specified by the operation data, the image forming device executes the image upload process to upload the image data for virtually reproducing the main body operation screen after a change according to the process based on the operator specified based on the operation data to the cloud storage, and
in a case where the image data for virtually reproducing the changed main body operation screen along with the process based on the operator specified by the operation data is uploaded to the cloud storage, the instructions included in the remote operation program cause the information processing device to execute the screen display process, and
in the screen display process, the information processing device downloads the image data for virtually reproducing the main body operation screen after the change according to the process based on the operator specified by the operation data from the cloud storage and displays, on the user interface using the browser, the remote operation screen for virtually reproducing the main body operation screen after the change according to the process based on the operator specified by the operation data.

5. The system according to claim 1,
wherein the image forming device includes a touch panel,
the image forming device is configured to cause the touch panel to display a main body panel screen including the plurality of operators, and upon receiving an operation on one of the plurality of operators, the image forming device executes a process based on the operator having received the operation,
the instructions included in the remote operation program cause the information processing device to execute the screen display process, and in the screen display process, the information processing device displays, on the user interface using the browser, the remote operation screen for virtually reproducing the main body panel screen based on the image data downloaded from the cloud storage,
upon receiving an operation on one of the plurality of operators displayed on the remote operation screen via the user interface, the instructions included in the remote operation program cause the information processing device to execute the operation upload process, and in the operation upload process, the information processing device uploads, to the cloud storage, information for specifying the operator having received the operation as the operation data, and
in a case where the operation data is uploaded to the cloud storage, the image forming device downloads the operation data from the cloud storage and executes a process based on the operator specified by the operation data.

6. The system according to claim 5,
wherein the image forming device includes an operation panel including the touch panel, the operation panel includes a plurality of hardware keys, and upon receiving an operation on one of the plurality of hardware keys, the image forming device executes a process based on the hardware key having received the operation,
the instructions included in the remote operation program cause the information processing device to execute the screen display process, and in the screen display process, the remote operation program causes the information processing device to display, on the user interface using the browser, the remote operation screen for virtually reproducing the operation panel based on the image data downloaded from the cloud storage,
upon receiving an operation on one of the plurality of hardware keys displayed on the remote operation screen via the user interface, the instructions included in the remote operation program cause the information processing device to execute the operation upload process, and in the operation upload process, the remote operation program uploads, to the cloud storage as the operation data, information for specifying the hardware key having received the operation, and
in a case where the operation data is uploaded to the cloud storage, the image forming device downloads the operation data from the cloud storage and executes a process based on the hardware key specified by the operation data.

7. The system according to claim 5,
wherein the remote operation screen includes an ending button that is an operator not included in the main body panel screen,
upon receiving an operation of the ending button via the user interface, the instructions included in the remote operation program cause the image forming device to execute the operation upload process of uploading information for specifying the ending button, as the operation data, to the cloud storage, and
the image forming device is configured not to execute the image upload process after downloading the operation data for specifying the ending button.

8. The system according to claim 5,
wherein upon receiving an operation on one of the plurality of operators included in the remote operation screen via the user interface, the instructions included in the remote operation program cause the information processing device to execute the operation upload process and an effect output process of causing the user interface to output an effect for the operator having received the operation.

9. The system according to claim 1,
wherein the cloud storage is provided with a structured data storage area, the structured data storage area includes a plurality of operation records, and each of the operation records is a record for storing the operation data,
the instructions included in the remote operation program cause the information processing device to execute the operation upload process each time an operation on one of the plurality of operators included in the remote operation screen is received via the user interface, and in the operation upload process, the information processing device uploads the operation data for specifying the operated operator to the structured data storage area provided in the cloud storage to be stored in the operation record,
in a case where the operation data is uploaded to the structured data storage area provided in the cloud storage, the image forming device downloads the operation data stored in the operation record from the structured data storage area provided in the cloud storage, and executes the process based on the operator specified by the downloaded operation data, and
the image forming device further executes a process based on the operator specified by the operation data in chronological order of occurrence of an operation among the operation data in which the process based on the operator is not executed, among the operation data uploaded to the structured data storage area provided in the cloud storage.

10. The system according to claim 9,
wherein the structured data storage area provided in the cloud storage includes a plurality of image records, and each of the image records is a record for storing the image data,
the image forming device executes the image upload process each time an event occurs that changes the content of the remote operation screen displayed on the information processing device according to the remote operation program, and in the image upload process, the image forming device uploads the image data indicating the remote operation screen after a change to the structured data storage area provided in the cloud storage to be stored in a image record,
in a case where the image data indicating the remote operation screen after the change is uploaded to the structured data storage area provided in the cloud storage, the instructions included in the remote operation program cause the information processing device to execute the screen display process, and in the screen display process, the information processing device downloads the image data indicating the remote operation screen after the change stored in the image record from the structured data storage area provided in the cloud storage, and displays the remote operation screen after the change based on the downloaded image data on the user interface using the browser, and
in a case where an image record storing the image data in which the remote operation screen is not displayed is stored in the structured data storage area provided in the cloud storage as an image record different from the image record storing the image data in which the remote operation screen is displayed, the instructions included in the remote operation program cause the information processing device to execute the screen display process, and in the screen display process, the information processing device downloads an other image data from the structured data storage area, and displays the remote operation screen based on the downloaded image data on the user interface using the browser.

11. The system according to claim 10,
wherein the remote operation screen includes an ending button,
upon receiving an operation of the ending button via the user interface, the instructions included in the remote operation program cause the image forming device to execute the operation upload process of uploading the operation data for specifying the ending button to the structured data storage area provided in the cloud storage to be stored in the operation record, and
in a case where the operation data for specifying the ending button is downloaded, the image forming device executes a deletion process of deleting, from the structured data storage area, the operation data uploaded from the remote operation program and the image data uploaded from the image forming device.

12. The system according to claim 11,
wherein, upon receiving instruction data transmitted from the information processing device, the instruction data indicating the start of a remote operation to the image forming device, the image forming device executes the deletion process and a program upload process of uploading the remote operation program to the cloud storage,
the image forming device further transmits response data indicating that the upload of the remote operation program is completed to the information processing device that has transmitted the instruction data after executing the program upload process, and the response data includes first access information necessary for downloading the remote operation program from the cloud storage, and
the browser causes the information processing device to execute a program download process of downloading the remote operation program from the cloud storage using the first access information included in the response data transmitted from the image forming device.

13. The system according to claim 10,
wherein the cloud storage includes a first cloud storage that is a non-structured data storage cloud storage, and a second cloud storage that is a structured data storage cloud storage,
the second cloud storage is provided with the structured data storage area,
upon receiving instruction data transmitted from the information processing device, the instruction data indicating the start of a remote operation to the image forming device, the image forming device executes a program upload process of uploading the remote operation program to the first cloud storage,
the image forming device is further configured to executing the image upload process after receiving the instruction data,
in the image upload process, the image forming device is configured to:
in a case where the image data to be uploaded has a data size that is stored in the image record, upload the image data to the structured data storage area provided in the second cloud storage to be stored in the image record; and
in a case where the image data to be uploaded does not have a data size that is stored in the image record, upload the image data to the first cloud storage and upload location data indicating that the image data to be uploaded has been uploaded to the first cloud storage to the structured data storage area provided in the second cloud storage to be stored in the image record,
in a case where the browser is started in response to uploading the remote operation program to the first cloud storage, the browser causes the information processing device to execute a program download process of downloading the remote operation program from the first cloud storage,
in a case where the remote operation program is downloaded by the browser, the remote operation program causes the information processing device to execute the screen display process,
in the screen display process, the information processing device is configured to:
in a case where the image data is stored in the image record in the structured data storage area provided in the second cloud storage, download the image data from the structured data storage area and display, using the browser, the remote operation screen indicated by the downloaded image data on the user interface; and
in a case where the image data is not stored in the image record in the structured data storage area provided in the second cloud storage and the location data is stored in the structured data storage area, download the image data from the first cloud storage based on the location data and display, using the browser, the remote operation screen indicated by the downloaded image data from the first cloud storage on the user interface,
in a case where an operation on the remote operation screen is received via the user interface, the instructions included in the remote operation program cause the information processing device to execute the operation upload process, and in the operation upload process, the information processing device uploads the operation data to the structured data storage area provided in the second cloud storage to be stored in the operation record, and
in a case where the operation data is uploaded to the structured data storage area provided in the second cloud storage, the image forming device downloads the operation data stored in the operation record from the structured data storage area provided in the second cloud storage, and executes a process corresponding to an operation indicated by the downloaded operation data.

14. The system according to claim 10,
wherein the cloud storage includes a first cloud storage that is a non-structured data storage cloud storage, and a second cloud storage that is a structured data storage cloud storage,
the second cloud storage is provided with the structured data storage area,
upon receiving instruction data transmitted from the information processing device, the instruction data indicating the start of a remote operation to the image forming device, the image forming device executes a program upload process of uploading the remote operation program to the first cloud storage,
the image forming device is further configured to execute the image upload process after receiving the instruction data,
in the image upload process, the image forming device is configured to:
in a case where the image data to be uploaded has a data size that is stored in one of the image records, upload the image data to the structured data storage area provided in the second cloud storage to be stored in the image record; and
in a case where the image data to be uploaded does not have a data size that is stored in the image record, divide the image data into a size that is stored in the image record, and upload divided data that is each of the divided image data to be stored in one of the image records,
in a case where the browser is started in response to uploading the remote operation program to the first cloud storage, the browser causes the information processing device to execute a program download process of downloading the remote operation program from the first cloud storage,
in a case where the remote operation program is downloaded by the browser, the instructions included in the remote operation program cause the information processing device to execute the screen display process,
in the screen display process, the information processing device is configured to:
in a case where the image data is stored in one of the image records in the structured data storage area provided in the second cloud storage, download the image data stored in one of the image records from the structured data storage area from the structured data storage area, and display, on the user interface using the browser, the remote operation screen indicated by the downloaded one of the image data; and
in a case where the image data is stored separately in the plurality of image records in the structured data storage area provided in the second cloud storage, download the divided data stored in the plurality of image records from the structured data storage area from the structured data storage area, and display, on the user interface using the browser, the remote operation screen being indicated by the image data divided into the plurality of divided data,
in a case where an operation on the remote operation screen is received via the user interface, the instructions included in the remote operation program cause the information processing device to execute the operation upload process,
in the operation upload process, the information processing device uploads the operation data to the structured data storage area provided in the second cloud storage to be stored in the operation record, and
in a case where the operation data is uploaded to the structured data storage area provided in the second cloud storage, the image forming device downloads the operation data stored in the operation record from the structured data storage area provided in the second cloud storage, and executes a process corresponding to an operation indicated by the downloaded operation data.

15. An image forming device,
wherein the image forming device is configured to be connected to the Internet and configured to execute an image upload processing of uploading image data indicating a remote operation screen including a plurality of operators to a cloud storage connected to the Internet, the image data is downloaded to an information processing device connected to the Internet by a remote operation program configured to operate in a browser, the remote operation screen including the plurality of operators indicated in the image data is displayed on a user interface of the information processing device using the browser,
in a case where operation data is uploaded to the cloud storage, the image forming device downloads the operation data from the cloud storage and executes a process based on the operator specified by the operation data,
in a case where the operator specified by the operation data is an operator related to image formation, the image forming device executes an image forming process as a process corresponding to the operator, and the operation data is data for specifying an operated operator among the plurality of operators included in the remote operation screen, and upon receiving an operation on one of the plurality of operators included in the remote operation screen, the information processing device uploads the operation data to the cloud storage according to the remote operation program,
in a case where an event that changes the content of the remote operation screen displayed on the information processing device occurs, the image forming device executes the image upload process to upload the image data indicating the remote operation screen after a change caused by the event to the cloud storage, and
in a case where the image data indicating the remote operation screen after the change is uploaded to the cloud storage, the image data indicating the remote operation screen after the change is downloaded from the cloud storage to the information processing device according to the remote operation program, and the remote operation screen after the change is displayed on the user interface using the browser.

16. The image forming device according to claim 15,
wherein the image forming device includes a display and is configured to cause the display to display a main body operation screen including the plurality of operators, and
in the image upload process, the image forming device uploads image data for virtually reproducing the main body operation screen displayed on the display to the cloud storage as the image data indicating the remote operation screen, the image data is downloaded to the information processing device according to the remote operation program, and the remote operation screen for virtually reproducing the main body operation screen based on the image data downloaded from the cloud storage is displayed on the user interface using the browser.

17. The image forming device according to claim 15,
wherein the image forming device includes a touch panel, is configured to cause the touch panel to display a main body panel screen including the plurality of operators,
upon receiving an operation on one of the plurality of operators, the image forming device executes a process based on the operator having received the operation,
in the image upload process, the image forming device uploads the image data for virtually reproducing the main body panel screen displayed on the touch panel to the cloud storage as the image data indicating the remote operation screen, the image data is downloaded to the information processing device according to the remote operation program,
in a case where the remote operation screen for virtually reproducing the main body panel screen based on the image data downloaded from the cloud storage is displayed on the user interface using the browser and an operation on one of the plurality of operators displayed on the remote operation screen is received, the operation data is uploaded to the cloud storage according to the remote operation program, and the operation data to be uploaded is information for specifying the operator having received operation among the plurality of operators displayed on the remote operation screen, and
in a case where the operation data is uploaded to the cloud storage, the image forming device downloads the operation data from the cloud storage and executes a process based on the operator specified by the operation data.

18. The image forming device according to claim 15,
wherein the cloud storage is provided with a structured data storage area, the structured data storage area is structured with the plurality of operation records, and each of the operation records is a record for storing the operation data,
in a case where the operation data is uploaded to the structured data storage area provided in the cloud storage, the image forming device downloads the operation data stored in the operation record from the structured data storage area provided in the cloud storage, and executes the process based on the operator specified by the downloaded operation data, and the operation data is uploaded according to the remote operation program to the structured data storage area provided in the cloud storage to be stored in the operation record each time an operation on one of the plurality of operators included in the remote operation screen is received via the user interface, and
the image forming device is further configured to execute a process based on the operator specified by the operation data in chronological order of occurrence of an operation among the operation data in which the process based on the operator is not executed among the operation data uploaded to the structured data storage area provided in the cloud storage.

19. A system comprising an image forming device, a first information processing device, and a second information processing device,
wherein the first information processing device, the second information processing device, and the image forming device are connected to the Internet,
the first information processing device and the second information processing device are configured to install a browser,
upon receiving a start instruction of a first remote operation from the first information processing device via a cloud storage connected to the Internet, the image forming device executes a program upload process of uploading a first remote operation program configured to operate in the browser to the cloud storage, and in a case where the first remote operation program is uploaded to the cloud storage, the browser installed on the first information processing device causes the first information processing device to download the first remote operation program from the cloud storage,
the image forming device is further configured to execute an image upload process of uploading first image data indicating a first remote operation screen to the cloud storage, after receiving the start instruction of the first remote operation,
the instructions included in the first remote operation program cause the first information processing device to execute a screen display process of downloading the first image data from the cloud storage and of displaying the first remote operation screen indicated in the first image data on the user interface of the first information processing device using the browser,
in a case where an operation on the first remote operation screen is received via the user interface of the first information processing device, the instructions included in the first remote operation program cause the first information processing device to execute an operation upload process of uploading first operation data indicating an operation content to the cloud storage,
in a case where the first operation data is uploaded to the cloud storage, the image forming device downloads the first operation data from the cloud storage and executes a process corresponding to an operation indicated by the first operation data, and in a case where the operation indicated by the downloaded first operation data is an operation related to image formation, the image forming device executes an image forming process as a process corresponding to the operation,
upon receiving a start instruction of a second remote operation from the second information processing device through local communication, not via the cloud storage, the image forming device executes a program reply process of returning a second remote operation program configured to operate in the browser to the second information processing device, not via the cloud storage, and the browser installed on the second information processing device acquires the second remote operation program returned from the image forming device,
the image forming device is further configured to execute an image transmission process of transmitting second image data indicating a second remote operation screen to the second information processing device, not via the cloud storage, after receiving the start instruction of the second remote operation,
in a case where the second information processing device receives the second image data, the instructions included in the second remote operation program cause the second information processing device to execute a local screen display process of displaying the second remote operation screen indicated by the received second image data on the user interface of the second information processing device using the browser,
in a case where an operation on the second remote operation screen is received via the user interface of the second information processing device, the instructions included in the second remote operation program further cause the second information processing device to execute an operation transmission process of transmitting second operation data indicating an operation content to the image forming device, not via the cloud storage,
upon receiving the second operation data from the second information processing device, the image forming device executes a process corresponding to an operation indicated by the received second operation data, and in a case where the operation indicated by the received second operation data is an operation related to image formation, the image forming device executes an image forming process as a process corresponding to the operation,
in a case where the image forming device starts providing the first remote operation by executing the program upload process after receiving the start instruction of the first remote operation, the image forming device enters a first remote operation providing state until an ending condition of the first remote operation is satisfied,
in a case where the image forming device starts providing the second remote operation by executing the program reply process after receiving the start instruction of the second remote operation, the image forming device enters a second remote operation providing state until an ending condition of the second remote operation is satisfied,
the image forming device is configured to start providing the second remote operation in a case where the image forming device receives the start instruction of the second remote operation from the second information processing device in the first remote operation providing state, and
the image forming device is configured to start providing the first remote operation in a case where the image forming device receives the start instruction of the first remote operation from the first information processing device in the second remote operation providing state.

20. An image forming device,
wherein the image forming device is configured to be connected to the Internet,
upon receiving a start instruction of a first remote operation from a first information processing device via a cloud storage connected to the Internet, the image forming device executes a program upload process of uploading a first remote operation program configured to operate in a browser to the cloud storage, and in a case where the first remote operation program is uploaded to the cloud storage, the browser installed on the first information processing device causes the first information processing device to download the first remote operation program from the cloud storage,
the image forming device is further configured to execute an image upload process of uploading first image data indicating a first remote operation screen to the cloud storage after receiving the start instruction of the first remote operation, the first image data is downloaded to the first information processing device according to the first remote operation program, and the first remote operation screen indicated by the first image data is displayed on a user interface of the first information processing device using the browser,
in a case where the first operation data is uploaded to the cloud storage, the image forming device further downloads the first operation data from the cloud storage and executes a process corresponding to an operation indicated by the first operation data,
in a case where the operation indicated by the first operation data is an operation related to image formation, the image forming device executes an image forming process as a process corresponding to the operation, the first operation data is data indicating an operation content on the first remote operation screen, and in a case where the first information processing device receives an operation on the first remote operation screen, the first operation data is uploaded to the cloud storage according to the first remote operation program,
upon receiving a start instruction of a second remote operation from a second information processing device through local communication not via the cloud storage, the image forming device executes a program reply process of returning a second remote operation program configured to operate in the browser to the second information processing device not via the cloud storage, the browser being installed on the second information processing device acquires the second remote operation program returned from the image forming device,
the image forming device is further configured to execute an image transmission process of transmitting second image data indicating a second remote operation screen to the second information processing device not via the cloud storage after receiving the start instruction of the second remote operation, the second image data is downloaded to the second information processing device according to the second remote operation program, and the second remote operation screen indicated in the second image data is displayed on the user interface of the second information processing device using the browser,
upon receiving second operation data from the second information processing device, the image forming device further executes a process corresponding to an operation indicated by the received second operation data, and in a case where the operation indicated by the received second operation data is an operation related to image formation, the image forming device executes an image forming process as a process corresponding to the operation, the second operation data is data indicating an operation content to the second remote operation screen, and in a case where the second information processing device receives an operation on the second remote operation screen, the operation is transmitted to the image forming device according to the second remote operation program,
in a case where the image forming device starts providing the first remote operation by executing the program upload process after receiving the start instruction of the first remote operation, the image forming device enters a first remote operation providing state until an ending condition of the first remote operation is satisfied,
in a case where the image forming device starts providing the second remote operation by executing the program reply process after receiving the start instruction of the second remote operation, the image forming device enters a second remote operation providing state until an ending condition of the second remote operation is satisfied,
the image forming device is configured to start providing the second remote operation in a case where the image forming device receives the start instruction of the second remote operation from the second information processing device in the first remote operation providing state, and
the image forming device is configured to start providing the first remote operation in a case where the image forming device receives the start instruction of the first remote operation from the first information processing device in the second remote operation providing state.

21. The system according to claim 1,
wherein the start program includes instructions that cause the information processing device to receive a start instruction of a remote operation specifying the image forming device via a user interface of the information processing device, and in a case where the start instruction is received, the instructions included in the start program cause the information processing device to execute an instruction transmission process of transmitting instruction data indicating the start of the remote operation to the specified image forming device,
upon receiving the instruction data, the image forming device executes a program upload process of uploading a remote operation program configured to operate in the browser to a cloud storage connected to the Internet,
in a case where the remote operation program is uploaded to the cloud storage after the execution of the instruction transmission process, the instructions included in the start program cause the information processing device to execute a browser activation process of activating the browser and passing first access information necessary for downloading the remote operation program from the cloud storage to the browser, and
in a case where the browser is activated by the start program, the browser causes the information processing device to execute a program download process of downloading the remote operation program from the cloud storage using the first access information passed from the start program.

22. The system according to claim 1,
wherein the image forming device includes a display and is configured to cause the display to display a main body operation screen,
the image forming device is configured to execute an image upload process of uploading image data for virtually reproducing the main body operation screen displayed on the display to a cloud storage connected to the Internet,
the instruction included in the remote operation program causes the information processing device to execute a screen display process of downloading the image data from the cloud storage and of displaying, on a user interface of the information processing device using the browser, a remote operation screen for virtually reproducing the main body operation screen based on the image data,
in a case where an event that changes the contents of the main body operation screen occurs, the image forming device further uploads the image data for virtually reproducing the changed main body operation screen to the cloud storage by executing the image upload process,
the instructions included in the remote operation program cause the information processing device to execute the screen display process in a case where the image data for virtually reproducing the changed main body operation screen is uploaded to the cloud storage, and
in the screen display process, the information processing device downloads the image data for virtually reproducing the changed main body operation screen from the cloud storage and displays, on the user interface using the browser, the remote operation screen, which is a virtual reproduction of the changed main body operation screen based on the downloaded image data.

23. The system according to claim 21,
wherein the image forming device and the information processing device are configured to access a cloud storage connected to the Internet, the cloud storage being configured to prohibit anonymous access,
upon receiving a start instruction of a remote operation from the information processing device, the image forming device executes a file upload process of uploading one file including a remote operation program configured to operate in the browser and layout information indicating a layout of a remote operation screen for receiving an operation in the remote operation to the cloud storage while anonymous access is prohibited,
in a case where the file is uploaded to the cloud storage, the browser causes the information processing device to execute a file download process of accessing the cloud storage in a non-anonymous manner using first access information necessary for accessing the cloud storage in a non-anonymous manner and of downloading the file from the cloud storage, and of downloading the file from the cloud storage, and by causing the information processing device to execute the file download process, the remote operation program and the layout information included in the downloaded file are acquired,
the instructions included in the remote operation program cause the information processing device to execute a screen display process of downloading the image data from the cloud storage and displaying the remote operation screen indicated by the image data on a user interface of the information processing device using the browser in a layout based on the layout information,
the instructions included in the remote operation program cause the information processing device to execute the screen display process in a case where the image data indicating the changed remote operation screen is uploaded to the cloud storage, and
in the screen display process, the information processing device downloads the image data indicating the changed remote operation screen from the cloud storage and displays the changed remote operation screen on the user interface using the browser in a layout based on the layout information.
